(19) United States
(12) Patent Application Publication
(10) Pub. No.: US 2024/0118749 A1
(43) Pub. Date: Apr. 11, 2024

(54) SYSTEMS FOR CALIBRATING NEUROMUSCULAR SIGNALS SENSED BY A PLURALITY OF NEUROMUSCULAR-SIGNAL SENSORS, AND METHODS OF USE THEREOF

(71) Applicant: Meta Platforms Technologies, LLC, Menlo Park, CA (US)

(72) Inventors: Bradley Holinski, Jersey City, NJ (US); Brett Schleicher, San Francisco, CA (US)

(21) Appl. No.: 18/480,406

(22) Filed: Oct. 3, 2023

Related U.S. Application Data
(60) Provisional application No. 63/413,944, filed on Oct. 6, 2022.

(51) Int. Cl. G06F 3/01; G06F 3/038

(52) U.S. Cl. CPC G06F 3/015; G06F 3/017; G06F 3/038

(57) ABSTRACT

Methods for calibrating neuromuscular signals sensed by a plurality of neuromuscular-signal sensors are provided. One example method includes, in response to a triggering event, receiving a pulse sensed by a neuromuscular-signal sensor of a plurality of neuromuscular-signal sensors of a wrist-wearable device. The method also includes, in accordance with a determination that the pulse indicates that at least one neuromuscular-signal sensor of the plurality of neuromuscular-signal sensors of the wrist-wearable device is offset from a respective predetermined default position, determining a worn position of the wrist-wearable device on the user's wrist, and adjusting analysis of neuromuscular signals of the plurality of neuromuscular-signal sensors based on an offset between the worn position of the wrist-wearable device and a predetermined default position of the wrist-wearable device.

### CROSS-REFERENCE TO RELATED APPLICATIONS

This application claims priority to U.S. Prov. App. No. 63/413,944, filed on Oct. 6, 2022, and entitled “Systems For Calibrating Neuromuscular Signals Sensed By A Plurality Of Neuromuscular-Signal Sensors, And Methods Of Use Thereof,” which is incorporated herein by reference.

### TECHNICAL FIELD

This application relates generally to wearable devices (e.g., wrist-wearable devices), and more particularly, to automatically calibrating neuromuscular-signal sensors of a wrist-wearable device when the wrist-wearable device and/or one or more neuromuscular-signal sensors of the wrist-wearable device are offset from a default position.

### BACKGROUND

Wearable devices commonly use algorithms that require a specific or known orientation of the wearable device on the user's body. If the device is not oriented properly, the wearable device will not perform optimally. Currently, when the wearable device is rotated, the algorithms apply a shift and trial-and-error to attempt to improve model performance. However, such a solution does not account for other incorrect placements of the wearable device. To address situations where the wearable device is flipped (side that faces the elbow is flipped with the side that faces the palm) or severely rotated (e.g., electronics are positioned at the inside of the wrist), a user has to physically re-orient the device to a proper orientation.

As such, a solution which requires little to no user intervention is needed in order for the wearable device to perform optimally without user intervention.

### SUMMARY

The systems and methods disclosed herein reduce or eliminate the need for placing the wrist-wearable device at a specific or known orientation on the user's body. In some embodiments, the wrist-wearable device, upon determining that it is worn improperly or incorrectly, performs an autocalibration process to identify its current worn position with respect to a default position (e.g., an known orientation on the user's body that the wrist-wearable device should be worn). In particular, systems and methods use sensor data sensed by one or more neuromuscular-signal sensors to determine the location of the wrist-wearable device on the user's wrist. The wrist-wearable device further determines an offset between its current position and the default position, and uses the determined offset to adjust sensor data captured by its one or more sensors. More specifically, the wrist-wearable device adjusts analysis of neuromuscular signals sensed by one or more neuromuscular-signal sensors based on an offset between its worn position and the default position (which improve the accuracy of the different models of the wrist-wearable device). The autocalibration processes reduces the amount of user intervention required to accurately detect neuromuscular signals. In other words, the systems and methods disclosed herein can adjust the neuromuscular signals detected from the user's body to account for the incorrect placement of a wearable device on the user's body. The systems and methods disclosed herein account for the incorrect placement of the wearable device on the user's body without forcing the user to manually reorient or reposition the wrist-wearable device.

As one example method for calibrating neuromuscular signals sensed by a plurality of neuromuscular-signal sensors of a wrist-wearable device, a method includes, in response to a triggering event, receiving a pulse (or other biometric data) sensed by a neuromuscular-signal sensor of the plurality of neuromuscular-signal sensors of a wrist-wearable device. The example method further includes in accordance with a determination that the pulse indicates that at least one neuromuscular-signal sensor of the plurality of neuromuscular-signal sensors of the wrist-wearable device is offset from a respective predetermined default position, determining a worn position of the wrist-wearable device on the user's wrist. The example method further includes adjusting analysis of neuromuscular signals of the plurality of neuromuscular-signal sensors based on an offset between the worn position of the wrist-wearable device and a predetermined default position of the wrist-wearable device.

Adjusting the analysis of neuromuscular signals can include reindexing the one or more neuromuscular-signal sensors of the plurality of neuromuscular-signal sensors, swapping neuromuscular signals of two or more neuromuscular-signal sensors, and/or adjusting signal values of one or more neuromuscular signals. In some embodiments, adjusting the analysis of neuromuscular signals can include simulating one or more neuromuscular signals. In some embodiments, if the adjusted analysis of the neuromuscular signals does not satisfy predetermined performance criteria, feedback is provided to the user that instructs the user on how to best improve the performance of the wrist-wearable device.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates a default user worn position of a wrist-wearable device, in accordance with some embodiments

FIG. 2 illustrates automatic calibration of a wrist-wearable device worn in a non-predetermined default position, in accordance with some embodiments.

FIG. 3 illustrates automatic calibration of a wrist-wearable device to individually reassign neuromuscular signals sensed by the neuromuscular-signal sensors, in accordance with some embodiments.

FIG. 4 illustrates positional calibration of neuromuscular-signal sensors of a wrist-wearable device and/or simulated neuromuscular-signal sensors, in accordance with some embodiments.

FIG. 5 illustrates angular calibration of neuromuscular-signal sensors of a wrist-wearable device, in accordance with some embodiments.

FIGS. 6A-6D illustrate the wrist-wearable device reindexing one or more neuromuscular-signal sensors based different user worn positions, in accordance with some embodiments.

FIGS. 7A-7D illustrate adjustments to neuromuscular signals sensed by neuromuscular-signal sensors with longitudinal and/or widthwise offsets, in accordance with some embodiments.

FIGS. 8A and 8B illustrate adjustments to neuromuscular signals sensed by neuromuscular-signal sensors with angular offsets, in accordance with some embodiments.

FIGS. 9A-9C illustrate the wrist-wearable device simulating one or more neuromuscular-signal sensors based different user worn positions, in accordance with some embodiments.

FIG. 10 illustrates a flow diagram of a method for calibrating neuromuscular signals sensed by a plurality of neuromuscular-signal sensors, in accordance with some embodiments.

FIG. 11 illustrates a detailed flow diagram of a method for calibrating neuromuscular signals sensed by a plurality of neuromuscular-signal sensors, in accordance with some embodiments.

FIG. 12 illustrates an example artificial-reality systems, in accordance with some embodiments.

FIGS. 13A and 13B illustrate an example wrist-wearable device 1300, in accordance with some embodiments.

FIGS. 14A-14C illustrate example head-wearable devices, in accordance with some embodiments.

FIGS. 15A and 15B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to embodiments, examples of which are illustrated in the accompanying drawings. In the following detailed description, numerous specific details are set forth to provide a thorough understanding of the various described embodiments. It will be apparent to one of ordinary skill in the art that the various described embodiments may be practiced without some of these specific details in certain circumstances. In some instances, well-known methods, procedures, components, circuits, and networks have not been described in detail so as not to unnecessarily obscure aspects of the embodiments.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As will become apparent to a person of skill in this art upon reading this disclosure, the various embodiments provide systems and methods of providing intuitive ways for automatically calibrating a wrist-wearable device to ensure that the sensed neuromuscular signals are accurate. The systems and methods for automatically calibrating a wrist-wearable device can also account for user error (e.g., incorrectly and/or improperly wearing the wrist-wearable device), incorrectly and/or improperly contact by one or more neuromuscular-signal sensors, and/or inconsistent and/or abnormal readings by the one or more neuromuscular-signal sensors.

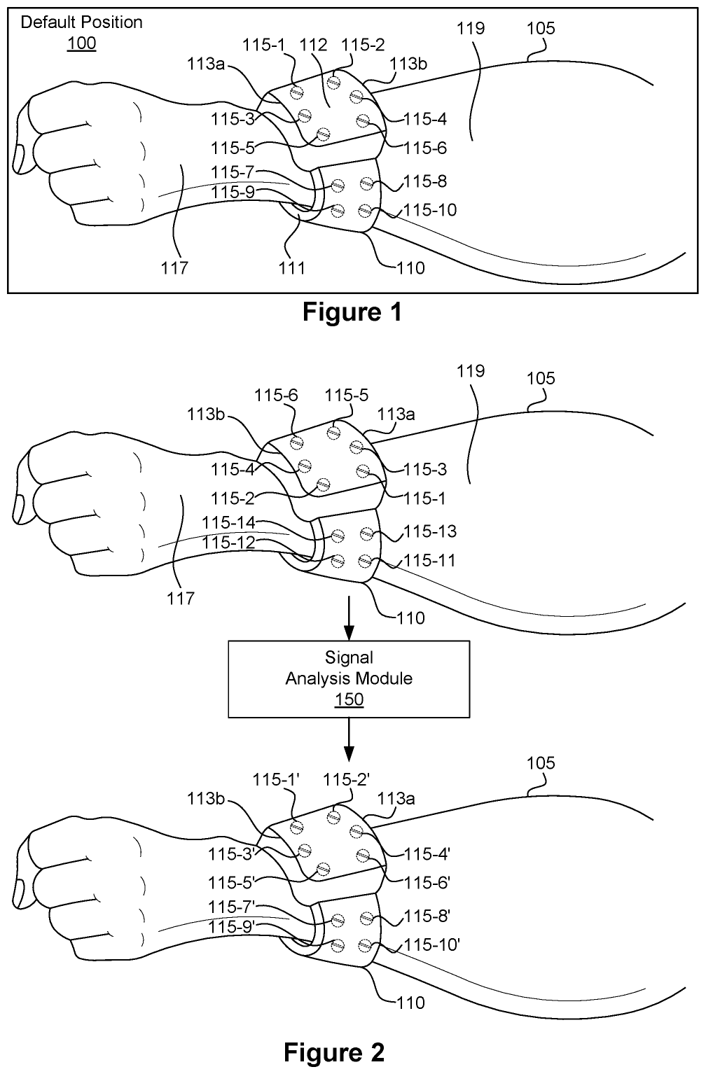

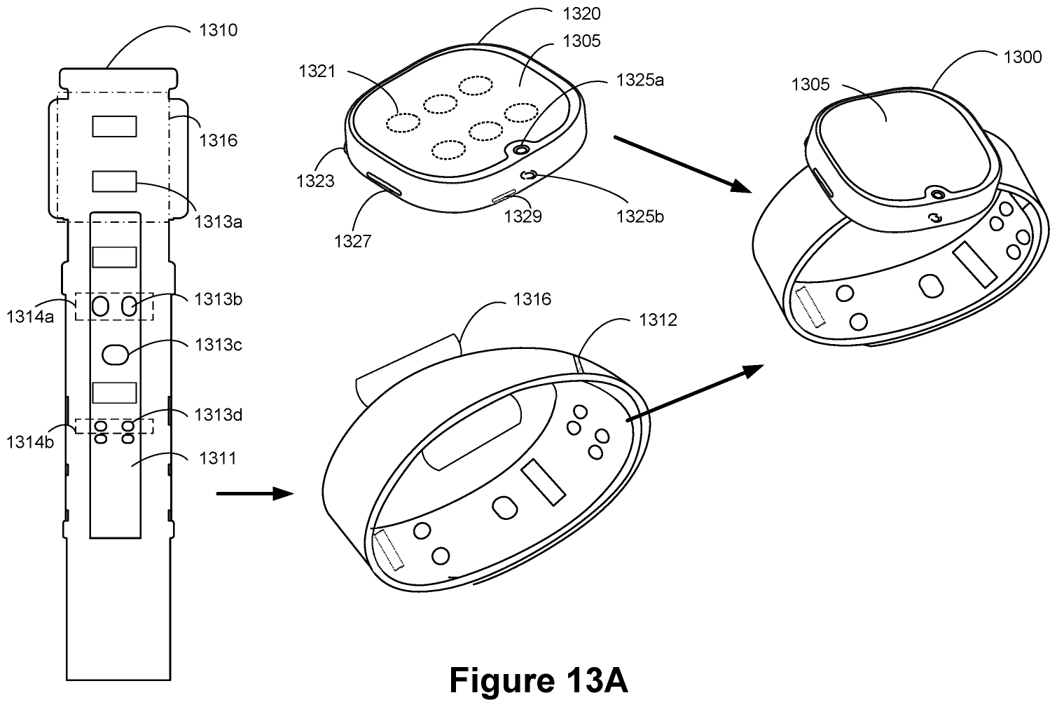

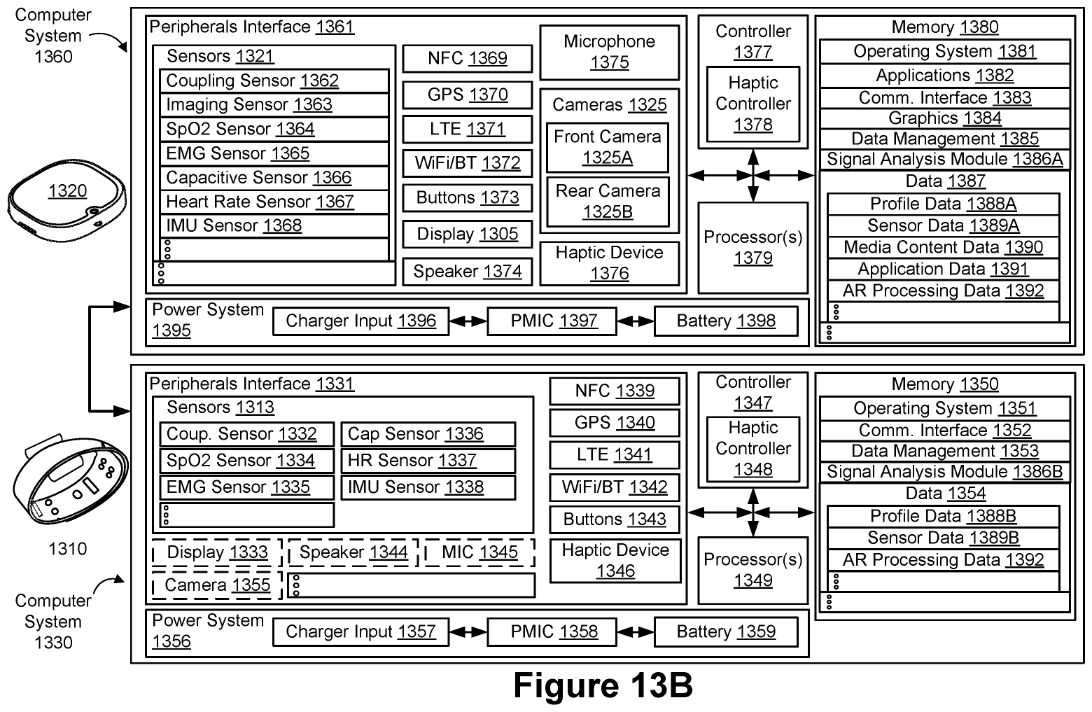

FIG. 1 illustrates a default user worn position of a wrist-wearable device, in accordance with some embodiments. The wrist-wearable device 110 can include one or more imaging devices or imaging sensors 1336, microphones 1375, speakers 1374, displays 1305 (e.g., a touchscreen, which can also be configured to receive one or more user inputs), one or more neuromuscular-signal sensors 115 (as well as other sensors described below in reference to FIGS. 13A and 13B), memory 1380 (e.g., storage and RAM)), and/or one or more processors (e.g., central processing unit (CPU) 1379 and/or microcontroller unit), as well as other components described below in reference to FIGS. 13A and 13B. In some embodiments, the wrist-wearable device 110 is a smartwatch, wrist band, a fitness band, wristwatch, etc. In some embodiments, the one or more components of the wrist-wearable device 110 described above are coupled with a wrist-wearable structure 111 (e.g., a band portion) of the wrist-wearable device 110, housed within a capsule portion 112 of the wrist-wearable device 110, or a combination of the wrist-wearable structure 111 and the capsule portion 112. The wrist-wearable device 110 can include a first edge 113a that is configured to be worn adjacent to the user's hand 117 (e.g., adjacent to a dorsal surface and/or a palmar surface of the user's hand 117) and a second edge 113b that is configured to be worn adjacent to the user' forearm 119. The first edge 113a of the wrist-wearable device 110 can include a first portion of the band portion and a first portion of the capsule portion 112, and second edge 113b of the wrist-wearable device 110 can include a second portion of the band portion and a second portion of the capsule portion 112. As the skilled artisan will appreciate upon reading the descriptions provided herein, the wrist-wearable device 110 can have any number of neuromuscular-signal sensors 115, different neuromuscular-signal sensor 115 placements along the wrist-wearable structure, and/or different neuromuscular-signal sensor 115 configurations (e.g., neuromuscular-signal sensors with different dimensions, shapes, etc.) while still being able to utilize the autocalibration techniques disclosed herein.

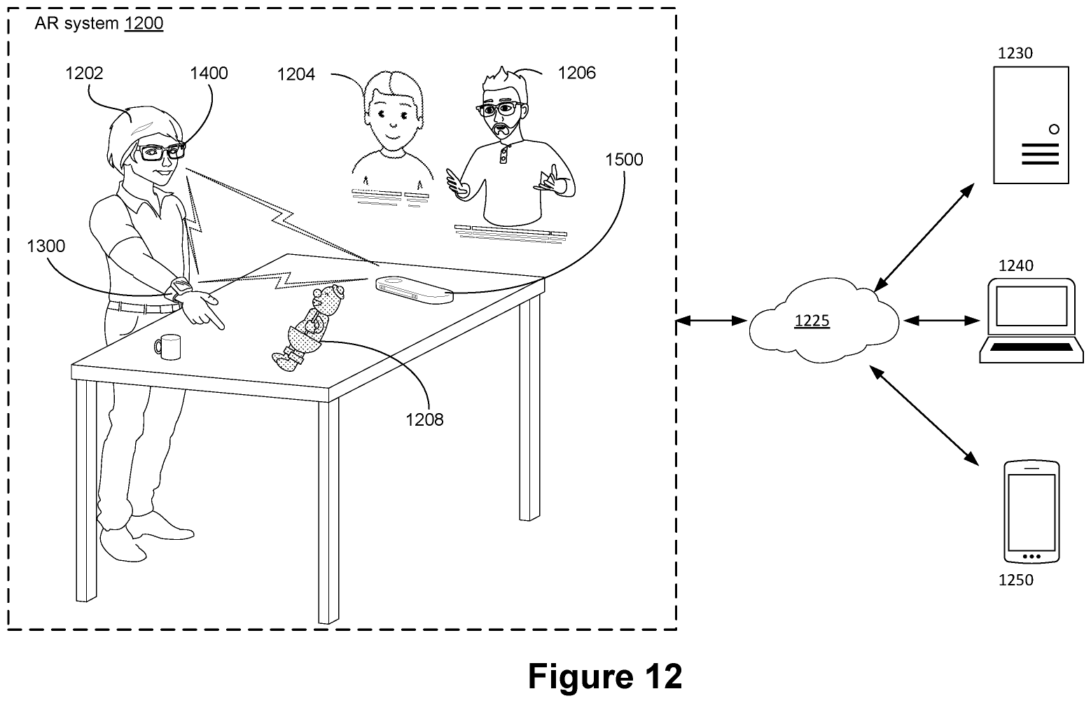

In some embodiments, the wrist-wearable device 110 is communicatively coupled with one or more intermediary devices (e.g., a server 1230, a computer 1240, a mobile device 1250, and/or other devices described below in reference to FIG. 12) that are configured to provide data and/or instructions to and between the wrist-wearable device 110 and another device. The data and/or instructions are configured to cause performance of one or more operations in conjunction to the operations performed by the wrist-wearable device 110. In some embodiments, the wrist-wearable device 110 is communicatively coupled with other user devices (e.g., by way of a Bluetooth connection between the two devices, and/or the two devices can also both be connected to an intermediary device that provides instructions and data to and between the devices). For example, the wrist-wearable device 110 can be communicatively coupled with a head-wearable device, which is configured to cause performance of one or more operations in conjunction to the operations performed by the wrist-wearable device 110.

The wrist-wearable device 110 is configured to be worn by a user 105 and sense neuromuscular signals (e.g., surface electromyography signals), which are used by the wrist-wearable device 110 (and/or other communicatively coupled device) to predict a motor action that the user 105 intends to perform. The wrist-wearable device 110 (and/or other communicatively coupled device) can determine a hand gesture performed (or intended to be performed) by the user 105 based on the neuromuscular signals sensed by the wrist-wearable device 110 and cause performance of an action at the wrist-wearable device (and/or other communicatively coupled device) based on the hand gesture. Wearable devices that are configured to sense neuromuscular signals can require that users wear the wearable device in a fixed operating position, which is a worn position at which neuromuscular-signal sensors of the wearable device are known to accurately detect neuromuscular signals. When a wearable device is worn incorrectly and/or improperly (e.g., not at the fixed operating position), the neuromuscular-signal sensors of the wearable device can inaccurately sense or fail to sense neuromuscular signals. To provide users with greater flexibility, the wrist-wearable device 110 disclosed herein uses a predetermined default position 100 (a worn position of the wrist-wearable device 110 at which the neuromuscular-signal sensors 115 are known to accurately detect neuromuscular signals) as a reference point for adjusting the sensed neuromuscular signals as discussed below.

In FIG. 1, the wrist-wearable device 110 is shown worn at a predetermined default position 100 on the user 105's wrist. The wrist-wearable device 110 can be associated with a predetermined default position 100 that includes respective predetermined default positions of the neuromuscular-signal sensors 115 on the user's body. For example, as shown in FIG. 1, the predetermined default position 100 can include odd numbered neuromuscular-signal sensors 115-1, 115-3, 115-5, 115-7, and 115-9 that have respective predetermined default positions adjacent to the user's hand 117 and even numbered neuromuscular-signal sensors 115-2, 115-4, 115-6, 115-8, and 115-10 that have respective predetermined default positions adjacent to the user's forearm 119. In some embodiments, predetermined default position 100 of the wrist-wearable device 110 can include positioning the capsule portion 112 of the wrist-wearable device 110 on the dorsal surface of the user's hand 117. The predetermined default position of the wrist-wearable device 110 and/or the respective predetermined default positions of the neuromuscular-signal sensors 115 are determined by locations on the user 105's wrist that allow for the accurate detection of neuromuscular signals by the neuromuscular-signal sensors 115. The locations on the user 105's wrist that allow for the accurate detection of neuromuscular signals can be based on the configuration of the wrist-wearable device 110 (e.g., the number of neuromuscular-signal sensors 115, position the neuromuscular-signal sensors 115 on the wrist-wearable device 110, size and/or shape of the neuromuscular-signal sensors 115, etc.), the user 105's anatomy (e.g., bones, muscles, tissue arteries, etc.), the user 105's physiology (e.g., heart rate, blood pressure, skin moisture, etc.), and/or other factors (e.g., body fat, hair density, demographic factors, such as age and gender).

In some embodiments, the respective predetermined default positions of the neuromuscular-signal sensors 115 are associated with a biometric threshold (e.g., a predetermined pulse strength threshold). In some embodiments, the predetermined default position 100 of the wrist-wearable device 110 and/or the respective predetermined default positions of the neuromuscular-signal sensors 115 are identifiable from a particular point (also referred to as a “reference point”) on the user 105's wrist. The reference point is a position at the user 105's wrist that has the highest pulse strength (e.g., at or near the user 105's artery, such as the radial artery). As described below, the reference point can be associated with a particular neuromuscular-signal sensor 115 and used to determine the wrist-wearable device 110's current position with respect to the predetermined default position 100, determine respective positions of the neuromuscular-signal sensors 115 on the user 105's wrist with respect to the reference point, and/or adjust analysis of neuromuscular signals sensed by the neuromuscular-signal sensors 115.

FIG. 2 illustrates automatic calibration of a wrist-wearable device worn in a non-predetermined default position, in accordance with some embodiments. In particular, the user 105 wears the wrist-wearable device 110 in an opposite orientation to the predetermined default position 100 (e.g., the first edge 113a is worn adjacent to the user' forearm 119 instead of adjacent to the dorsal surface (and/or a palmar surface) of the user's hand 117, the second edge 113b is worn adjacent to the dorsal surface (and/or a palmar surface) of the user's hand 117 instead of adjacent to the user' forearm 119, and the capsule portion 112 of the wrist-wearable device 110 positioned on the dorsal surface of the user's hand 117). The wrist-wearable device 110 accounts for the incorrect and/or improper placement of the wrist-wearable device 110 on the user's body without forcing the user 105 to manually reorient or reposition the wrist-wearable device 110. Specifically, the wrist-wearable device 110 uses a signal analysis module 150 to determine a worn position of the wrist-wearable device 110, determine respective positions of the neuromuscular-signal sensors 115 on the user 105's wrist, analyze neuromuscular signals sensed by the neuromuscular-signal sensors 115, and/or adjust analysis of the neuromuscular signals sensed by the neuromuscular-signal sensors 115. Further, the wrist-wearable device 110 can determine a hand gesture performed by the user based on the analysis or adjusted analysis of the neuromuscular signals. The signal analysis module 150 can instructions stored in memory of the wrist-wearable device 110 that, when executed by one or more processors of the wrist-wearable device 110, cause the wrist-wearable device 110 to calibrate the neuromuscular signals sensed by the neuromuscular-signal sensors 115. In some embodiments the signal analysis module 150 is part of one or more programs or applications stored on the wrist-wearable device 110.

The wrist-wearable device 110, in response to a triggering event, receives biometric data (e.g., a heart rate or pulse) sensed by a neuromuscular-signal sensor of the one or more neuromuscular-signal sensors 115. The triggering event can be a determination that the wrist-wearable device 110 is placed on the user 105's wrist; the wrist-wearable device 110 or a portion thereof (e.g., a band portion or a capsule portion) moves, twists, and/or is pulled; periodic autocalibration performed at predetermined intervals (e.g., every minute, every 30 minutes, every hour, every 3 hours, etc.); inconsistent and/or abnormal neuromuscular signals sensed by the neuromuscular-signal sensors 115 (e.g., increased number of false negative and false positives, neuromuscular signals values greater than a maximum predetermined threshold value, neuromuscular signals values less than minimum predetermined threshold value, etc.); respective sensor noise above a predetermined noise value; etc. In some embodiments, a triggering event is a determination that neuromuscular signals sensed by a neuromuscular-signal sensor 115 is sensed at a location inconsistent with the neuromuscular-signal sensor 115's respective predetermined default position. In some embodiments, the wrist-wearable device can periodically receive biometric data sensed by a neuromuscular-signal sensor and use the biometric data to determine the presence of a triggering event (e.g., a pulse rate strength detected by a particular neuromuscular-signal sensor 115 is below the neuromuscular-signal sensor 115's associated predetermined pulse rate strength threshold). Additionally or alternatively, sensor data obtained by other sensors (e.g., capacitive proximity sensor, a magnetic proximity sensor, an ultrasonic proximity sensor or other sensors described below in reference to FIGS. 13A and 13B) of the wrist-wearable device 110 can be used to determine the presence of a triggering event.

The wrist-wearable device 110 can determine whether the biometric data indicates that at least one neuromuscular-signal sensor 115 of the wrist-wearable device is offset from a respective predetermined default position. For example, a pulse sensed by a neuromuscular-signal sensor 115 can be used to determine an offset between the neuromuscular-signal sensor 115's current position and its respective predetermined default position. In some embodiments, the determination that the biometric data indicates that at least one neuromuscular-signal sensor 115 of the wrist-wearable device 110 is offset from the respective predetermined default position is based on the biometric data of at least one neuromuscular-signal sensor 115 being below the predetermined biometric threshold. For example, each predetermined default position of the neuromuscular-signal sensors 115 can be associated with a respective predetermined pulse strength threshold, the biometric data sensed by the neuromuscular-signal sensors 115 can include pulse strengths, and a determination that at least one neuromuscular-signal sensor 115 of the wrist-wearable device 110 is offset from the respective predetermined default position is based on the pulse strength of the at least one neuromuscular-signal sensor 115 being below a predetermined pulse strength threshold. More specifically, a neuromuscular-signal sensor 115 can be associated with a respective position on the user 105's wrist (when the wrist-wearable device 110 is worn) as well as an expected pulse strength for the respective position on the user 105's wrist, and the wrist-wearable device 110 can determine the neuromuscular-signal sensor 115's offset based on the neuromuscular-signal sensor 115's sensed pulse strength at its current position and the expected pulse strength at the respective position on the user 105's wrist.

Additionally or alternatively, in some embodiments, the wrist-wearable device 110 determines, based on a comparison of respective biometric data sensed by the neuromuscular-signal sensors 115, a neuromuscular-signal sensor 115 whose biometric data has the greatest respective values, and determines a respective offset between the neuromuscular-signal sensor 115's current position (location at which the biometric data with the greatest values was sensed) and its respective predetermined default position. As described above, each respective predetermined default position of the neuromuscular-signal sensors 115 of the wrist-wearable device 110 can be associated with a predetermined pulse strength threshold (with one neuromuscular-signal sensor 115 being associated with the reference point and the highest pulse strength), the wrist-wearable device 110 can determine, based on a comparison of respective pulse strengths of pulses sensed by neuromuscular-signal sensors 115, a neuromuscular-signal sensor 115 with a highest pulse strength, and determine an offset between the current position of the neuromuscular-signal sensor 115 with the highest pulse strength and its respective predetermined default position, which is associated with a distinct predefined pulse strength. In other words, the pulse strength of each neuromuscular-signal sensor 115 can be compared to identify the neuromuscular-signal sensor 115 with the highest pulse strength. The neuromuscular-signal sensor 115 identified as having the highest pulse strength is determined to be at the reference point (e.g., position at the user 105's wrist that has the highest pulse strength) and compared with its respective predetermined default position to determine the neuromuscular-signal sensor 115's offset.

The wrist-wearable device 110, in accordance with a determination that the biometric data indicates that at least one neuromuscular-signal sensor 115 of the wrist-wearable device is offset from a respective predetermined default position, determines a worn position of the wrist-wearable device 110 on the user 105's wrist. More specifically, the wrist-wearable device 110 determines its current worn position based on a neuromuscular-signal sensor 115's offset. The wrist-wearable device 110 can also determine a respective offset between its current position and the predetermined default position 100 (e.g., the wrist-wearable device is worn in an opposite orientation, worn backwards, rotated by a predetermined amount, etc.). The determined offset of a neuromuscular-signal sensor 115 can also be used to determine a neuromuscular-signal sensor 115's position relative to another neuromuscular-signal sensor 115, positions of other neuromuscular-signal sensors 115, and where the neuromuscular-signal sensor 115 should be positioned (e.g., its respective predetermined default position) and/or how far it is from its respective predetermined default position.

For example, as shown in FIG. 2, a twelfth neuromuscular-signal sensor 115-12 is positioned at the user 105's ulnar side (e.g., small finger side) of the wrist adjacent to the user's hand 117; however, the twelfth neuromuscular-signal sensor 115-12 is associated with a predetermined pulse rate strength threshold for a different respective predetermined default position (which is on the user 105's wrist adjacent to the user's forearm 119; e.g., as described above in reference to FIG. 1, even numbered neuromuscular-signal sensors 115-2, 115-4, etc. have respective predetermined default positions adjacent to the user's forearm 119). The current position of the twelfth neuromuscular-signal sensor 115-12 can be determined based on a comparison of the sensed pulse at its current position and stored predetermined pulse rate strength thresholds, which are associated with respective predetermined default positions of the neuromuscular-signal sensors 115 (e.g., the user 105's wrist can be mapped with different expected pulse rates). In this example, the twelfth neuromuscular-signal sensor 115-12 can be determined to be at or near the respective predetermined default position of a ninth neuromuscular-signal sensor 115-9 because its sensed pulse would be similar to a predetermined pulse rate strength threshold associated with the respective predetermined default position of the ninth neuromuscular-signal sensor 115-9. Additionally or alternatively, because the pulse sensed by twelfth neuromuscular-signal sensor 115-12 at its current position would be below the twelfth neuromuscular-signal sensor 115-12's predetermined pulse rate strength threshold, an offset between the twelfth neuromuscular-signal sensor 115-12's current position and respective predetermined default position is determined to be present.

In some embodiments, a value for the offset is determined based on the difference between the determined current position and the respective predetermined default position. For example, a value for the offset of the twelfth neuromuscular-signal sensor 115-12 can be determined based on the difference between the respective predetermined default position of the twelfth neuromuscular-signal sensor 115-12 and its current position (the respective predetermined default position of the ninth neuromuscular-signal sensor 115-9). Alternatively or additionally, in some embodiments, a value for the offset is determined with respect to reference point. For example, the reference point (a position at the user 105's wrist that has the highest pulse strength) can be associated with the respective predetermined default position of a thirteenth neuromuscular-signal sensor 115-13, and the value of the offset can be determined based on distance between the twelfth neuromuscular-signal sensor 115-12's current position and respective predetermined default position relative to the reference point. Further, in FIG. 2, the offset of the twelfth neuromuscular-signal sensor 115-12 is used to determine that the user 105 is wearing the wrist-wearable device 110 in an opposite orientation to the predetermined default position 100.

The wrist-wearable device 110 adjusts analysis of neuromuscular signals sensed by the neuromuscular-signal sensors 115 based on an offset between the worn position of the wrist-wearable device 110 and a predetermined default position 100 of the wrist-wearable device. In particular, the wrist-wearable device 110 provides the sensed neuromuscular signals to the signal analysis module 150, which adjusts analysis of neuromuscular signals based on an offset between the worn position of the wrist-wearable device 110 and the predetermined default position 100 of the wrist-wearable device 110 such that the neuromuscular signals are sensed as if the wrist-wearable device 110 were at the predetermined default position 100 (e.g., through reindexing, sensor swapping, and/or sensor substitution as described below) and/or simulate neuromuscular signals of the wrist-wearable device 110 at the predetermined default position 100 (e.g., through signal correction and/or simulation as described below).

In some embodiments, adjusting the analysis of the neuromuscular signals sensed by the neuromuscular-signal sensors 115 based on the offset between the worn position of the wrist-wearable device 110 and the predetermined default position 100 can include analyzing neuromuscular signals sensed by one neuromuscular-signal sensor 115 in place of neuromuscular signals sensed by another neuromuscular-signal sensor, and vice versa. In other words, neuromuscular signals detected by different neuromuscular-signal sensors 115 can be interchanged to account for a determined offset (e.g., incorrect and/or improper placement of that the wrist-wearable device). For example, as shown in FIG. 2, for the wrist-wearable device 110 worn in the opposite orientation relative to the predetermined default position 100, the signal analysis module 150 adjusts the analysis of the neuromuscular signals sensed by neuromuscular-signal sensor 115 such that neuromuscular signals detected by even numbered neuromuscular-signal sensors 115-2, 115-4, 115-6, 115-8, 115-10, 115-12, and 115-14 are analyzed as neuromuscular signals detected by odd numbered neuromuscular-signal sensors 115-5, 115-3, 115-1, 115-13, 115-11, 115-9, and 115-7, respectively. Similarly, for the wrist-wearable device 110 worn in the opposite orientation relative to the predetermined default position 100, the signal analysis module 150 adjusts the analysis of the neuromuscular signals sensed by neuromuscular-signal sensor 115 such that neuromuscular signals detected by odd numbered neuromuscular-signal sensors 115-1, 115-3, 115-5, 115-7, 115-9, 115-11, and 115-13 are analyzed as neuromuscular signals detected by even numbered neuromuscular-signal sensors 115-6, 115-3, 115-2, 115-14, 115-12, 115-10, and 115-8, respectively. The adjusted analysis of the neuromuscular signals sensed by neuromuscular-signal sensor 115 is represented in FIG. 2 via apostrophes on the neuromuscular-signal sensor 115.

The wrist-wearable device 110, in accordance with a determination that the biometric data does not indicate that at least one neuromuscular-signal sensor 115 of the wrist-wearable device is offset from a respective predetermined default position, forgoes determining a worn position of the wrist-wearable device 110 on the user 105's wrist. More specifically, the wrist-wearable device 110 determines that it is worn in the predetermined default position 100 and forgoes determining an offset. Further, the wrist-wearable device 110 forgoes adjusting analysis of neuromuscular signals sensed by the neuromuscular-signal sensors 115. In other words, the wrist-wearable device 110 analyzes the neuromuscular signals sensed by the neuromuscular-signal sensors in their default state.

As described above, the wrist-wearable device 110 can determine a hand gesture performed by the user 105 based on the adjusted analyzed neuromuscular signals of the neuromuscular-signal sensors 115. The wrist-wearable device 110 can further cause performance of an action at the wrist-wearable device based on the hand gesture (e.g., a user input at the wrist-wearable device and/or a user input at another device communicatively coupled with the wrist-wearable device 110 (e.g., a smartphone, head-wearable device, computer, etc.).

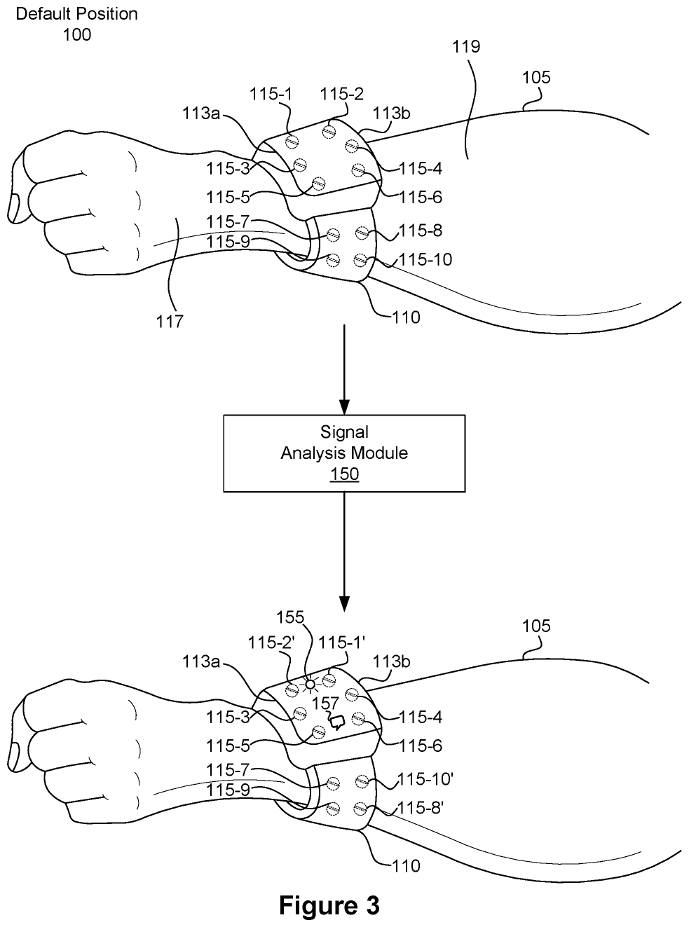

FIG. 3 illustrates automatic calibration of a wrist-wearable device to individually reassign neuromuscular signals sensed by the neuromuscular-signal sensors, in accordance with some embodiments. In some embodiments, the wrist-wearable device 110 is configured to reassign neuromuscular-signal sensors 115 in a widthwise and/or longitudinal portion of the wrist-wearable device 110 using the signal analysis module 150. As shown in FIG. 3, the user 105 wears the wrist-wearable device 110 in the predetermined default position 100 (e.g., the first edge 113a and odd numbered neuromuscular-signal sensors 115-1 through 115-9 are adjacent to the user's hand 117, and the second edge 113b and even numbered neuromuscular-signal sensors 115-2 through 115-10 are adjacent to the user's forearm 119) and individual numbered neuromuscular-signal sensors 115 in widthwise and/or longitudinal portions of the wrist-wearable device 110 are swapped with one another using the signal analysis module 150.

The wrist-wearable device 110 can adjust the analysis of neuromuscular signals sensed by neuromuscular-signal sensors based on the offset between the neuromuscular-signal sensors. More specifically, the wrist-wearable device 110 can analyze neuromuscular signals sensed by one neuromuscular-signal sensor 115 in place of neuromuscular signals sensed by another neuromuscular-signal sensor 115 by determining a position of the sensor neuromuscular-signal sensors 115 such that they can be accurately remapped. For example, the first neuromuscular-signal sensor 115-1 is at a first widthwise portion of the wrist-wearable device 110 and the second neuromuscular-signal sensor 115-2 is at a second widthwise portion of the wrist-wearable device 110, and the wrist-wearable device 110 adjusts analysis of the neuromuscular signals sensed by the first and second neuromuscular-signal sensors 115-1 and 115-2 based on an offset between the two neuromuscular-signal sensors (e.g., a positional difference between each neuromuscular-signal sensor's determined position). The adjusted analysis of the first neuromuscular-signal sensor 115-1 and the second neuromuscular-signal sensor 115-2 is such that neuromuscular signals sensed by second neuromuscular-signal sensor 115-2 are analyzed in place of the neuromuscular signals sensed by the first neuromuscular-signal sensor 115-1 and vice versa (e.g., the adjustment accurately remaps the first and second neuromuscular-signal sensors 115-1 and 115-2 as represented by adjusted first neuromuscular-signal sensor 115-1′ and adjusted second neuromuscular-signal sensor 115-2′). Additionally, the eighth neuromuscular-signal sensor 115-8 is at an eighth longitudinal portion of the wrist-wearable device 110 and the tenth neuromuscular-signal sensor 115-10 is at a tenth longitudinal portion of the wrist-wearable device 110. The wrist-wearable device 110 can adjust the analysis of the neuromuscular signals of the eighth and tenth neuromuscular-signal sensors 115-8 and 115-10 based on the offset between the two neuromuscular-signal sensors, such that neuromuscular signals sensed by tenth neuromuscular-signal sensor 115-10 are analyzed in place of the neuromuscular signals sensed by the eighth neuromuscular-signal sensor 115-8 and vice versa (e.g., adjustment represented by adjusted eighth neuromuscular-signal sensor 115-8′ and adjusted tenth neuromuscular-signal sensor 115-10′).

The wrist-wearable device 110 can use the signal analysis module 150 to interchange the neuromuscular signals detected by different neuromuscular-signal sensors 115 can during analysis. This allows the wrist-wearable device 110 to selectively analyze neuromuscular signals as needed to accurately detect hand gesture (e.g., detect hand gestures at or above a predetermined true positive rate (e.g., 90 percent) and and/or at or above a predetermined true negative rate (e.g., 90 percent)). Additionally or alternatively, the wrist-wearable device 110 can substitute neuromuscular signals to account for broken, dirty, malfunctioning (e.g., dead or inconsistent), and/or poorly functioning neuromuscular-signal sensors 115 (e.g., a neuromuscular-sensor 115 not contacting the user 105's wrist, or with increased false positives/negatives). For example, the eighth neuromuscular-signal sensor 115-8 can make poor contact with the user 105's skin or be malfunctioning and the wrist-wearable device 110 can use the neuromuscular signals detected by the tenth neuromuscular-signal sensor 115-10 in place of the neuromuscular signals detected by the eighth neuromuscular-signal sensor 115-8. In some embodiments, one or more neuromuscular-signal sensor 115 are at key positions on the user 105's wrist and substitution of one or more neuromuscular signals allows the wrist-wearable device to accurately detect hand gestures without reducing performance (e.g., predetermined true positive rate and/or predetermined true negative rate are still satisfied, or do not decrease by a predetermined amount (e.g., 5% decrease)). Alternatively or in addition, in some embodiments, the wrist-wearable device 110 can have one or more redundant neuromuscular-signal sensor 115 to allow for substitution of neuromuscular signals when other neuromuscular-signal sensor 115s fail or generate inaccurate neuromuscular signals.

In some embodiments, the wrist-wearable device 110 provides the user 105 with feedback notifying the user 105 of a manual adjustment that needs to be performed (e.g., if the autocalibration fails). For example, in some embodiments, the wrist-wearable device 110 determines whether a neuromuscular signals analysis or adjusted analysis satisfies predetermined performance criteria, and in accordance with a determination that the neuromuscular signals analysis does not satisfy the predetermined performance criteria, presents feedback to the user 105. The feedback is presented to the user 105 when the wrist-wearable device 110 cannot be auto-calibrated using the methods disclosed herein. The feedback, as discussed below, can prompt the user to manually adjust a worn position of the wrist-wearable device 110.

The predetermined performance criteria can include (i) a determined true positive rate at or above a predetermined true positive rate (e.g., 90 percent), (ii) a determined true negative rate at or above a predetermined true negative rate (e.g., 90 percent), (iii) a detected number of errors at or below a predetermined number of detected errors (e.g., 3 detected errors), (iv) the offset between the worn position of the wrist-wearable device and the predetermined default position of the wrist-wearable device is at or below a predetermined wrist-wearable device offset (e.g., 2 mm offset), and (v) the offset between the at least one neuromuscular-signal sensor of the plurality of neuromuscular-signal sensors and its respective predetermined default position is at or below a predetermined neuromuscular-signal sensor offset (e.g., 1 mm offset). For purposes of this disclosure, a detected error can be as a neuromuscular-signal sensor 115 and/or wrist-wearable device 110 offset, a malfunctioning neuromuscular-signal sensor 115, a poorly functioning neuromuscular-signal sensor 115, a broken neuromuscular-signal sensor 115, a dirty neuromuscular-signal sensor 115, or any other condition that can cause the wrist-wearable device 110 and/or a neuromuscular-signal sensor 115 to inaccurately detect or fail to detect neuromuscular signals.

The feedback can include a visual indicator, an audible indicator, and/or a haptic indicator. The feedback can be step-by-step instructions, audio guides, and/or visual guides presented to the user 105 via the wrist-wearable device 110 and/or a communicatively coupled device (e.g., a smartphone, head-wearable device, and/or an intermediary device). In some embodiments, the feedback includes instructions for performing user corrective actions that can result in the predetermined performance criteria to be satisfied. Non-limiting examples of the user corrective actions described in the instructions include removing and reattaching of the wrist-wearable device 110, manually adjusting the wrist-wearable device 110 (e.g., moving the wrist-wearable device 110 toward or away from the user's hand 117 or forearm 119, rotating the wrist-wearable device 110 about the user 105's wrist, flipping the wrist-wearable device 110, tightening or loosening the wrist-wearable device 110, etc.), manually adjusting one or more neuromuscular-signal sensors 115 (e.g., a band portion of the wrist-wearable device 110 can be stretched or backwards and the user 105 can be asked to correct the band position), cleaning one or more neuromuscular-signal sensors 115, etc. In some embodiments, the feedback includes instructions suggesting that the user 105 service or repair the wrist-wearable device 110 (e.g., perform a software or firmware update, bring in the wrist-wearable device 110 for repair, etc.). In other words, the feedback presented to the user 105 instructs the user 105 on how to improve the performance of the wrist-wearable device 110.

In some embodiments, the visual indicator can be provided via an illumination device 155 (e.g., an LED) or the display 1305 (FIG. 12A) of the wrist-wearable device 110 and/or a communicatively coupled device, which can flash in different colors, frequencies, and/or patterns (e.g., flashes or sequence of flashes associated with error codes or instructions) to let the user know the type of error (e.g., watch is lose, sensor is dirty, watch is on backwards, etc.) and how the error can be corrected. In some embodiments, the feedback is a message 157 presented on the display 1305 of the wrist-wearable device 110 and/or a communicatively coupled device. For example, a message 157 presented by the display of the wrist-wearable device 110 can instruct the user 105 to rotate the watch, slide the watch toward or away from the hand 117, etc. The audible indicator can be an audible message presented on a speaker 1374 (FIG. 12C) of the wrist-wearable device 110 and/or a communicatively coupled device. Alternatively or in addition, the audible indicator includes different alarms, or audible beeps (e.g., audible sounds at different frequencies and/or patterns (e.g., sounds or sequence of sounds associated with error codes or instructions)) that let the user know the type of error and how to correct the error. The haptic indicator can be a vibration or other haptic response presented by a haptic generator (e.g., haptic device 12224 FIG. 12C) of the wrist-wearable device 110 and/or a communicatively coupled device that notifies the user 105 of the type of error and how to correct the error.

In some embodiments, the wrist-wearable device 110, in conjunction with presenting feedback to the user 105, forgoes determining a hand gesture performed by the user based on the analysis or adjusted analysis of the neuromuscular signals of the neuromuscular-signal sensors 115. In some embodiments, the wrist-wearable device 110 waits until the user 105 performs a user corrective action before analyzing additional neuromuscular signals sensed neuromuscular-signal sensors 115. The wrist-wearable device 110, in response to a determination that a user corrective action was performed, analyzes the additional neuromuscular signals sensed by the neuromuscular-signal sensors 115 to determine whether the analysis of the additional neuromuscular signals satisfies the predetermined performance criteria. The wrist-wearable device 110, in accordance with a determination that the analysis of the additional neuromuscular signals does satisfy the predetermined performance criteria, determines a hand gesture performed by the user 105 based on the analyzed additional neuromuscular signals sensed by the neuromuscular-signal sensors 115 and causes performance of an action at the wrist-wearable device 115 based on the hand gesture. Alternatively or in addition, in accordance with a determination that the analysis of the additional neuromuscular signals does not satisfy the predetermined performance criteria, the wrist-wearable device 110 provides the user 105 with additional feedback for satisfying the predetermined performance criteria. The additional feedback is provided to further clarify previously presented instructions or correct newly detected errors. The additional feedback further ensures that the wrist-wearable device 110 is properly positioned on the user 105's while the user 105 is already manually adjusting the wrist-wearable device 110 rather than continuously providing feedback at various times in the user 105's day.

If the user 105 is not able to perform the additional corrective actions described in the additional feedback, the wrist-wearable device 110 can adjust analysis of the additional neuromuscular signals as described above. For example, in response to a repositioning event (e.g., the wrist-wearable device 110 was removed and reattached, was manually moved, and/or another user corrective action was performed), the wrist-wearable device 110 receives additional pulses (or heartrates) sensed by the neuromuscular-signal sensors 115 of the wrist-wearable device 110, and, in accordance with a determination that an additional pulse indicates that at least one neuromuscular-signal sensor 115 is offset from a respective predetermined default position (of the at least one neuromuscular-signal sensor 115), determines a new worn position of the wrist-wearable device 110 on the user 105's wrist. The wrist-wearable device 110 further adjusts analysis of additional neuromuscular signals sensed by the neuromuscular-signal sensor 115 based on an offset between the new worn position of the wrist-wearable device 1105 and the predetermined default position 100 of the wrist-wearable device 110.

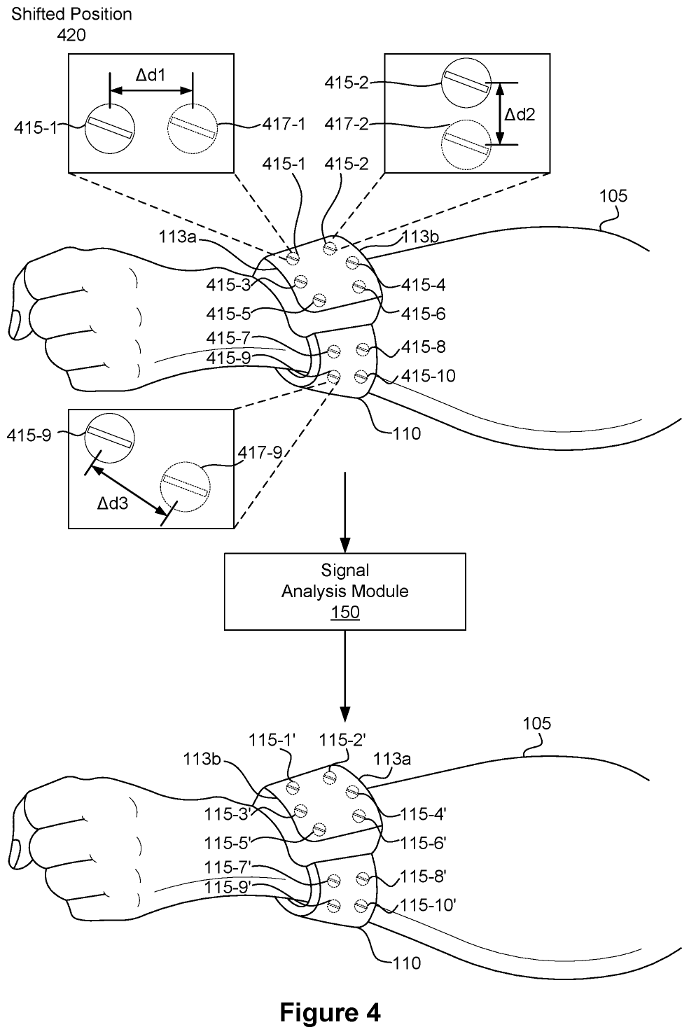

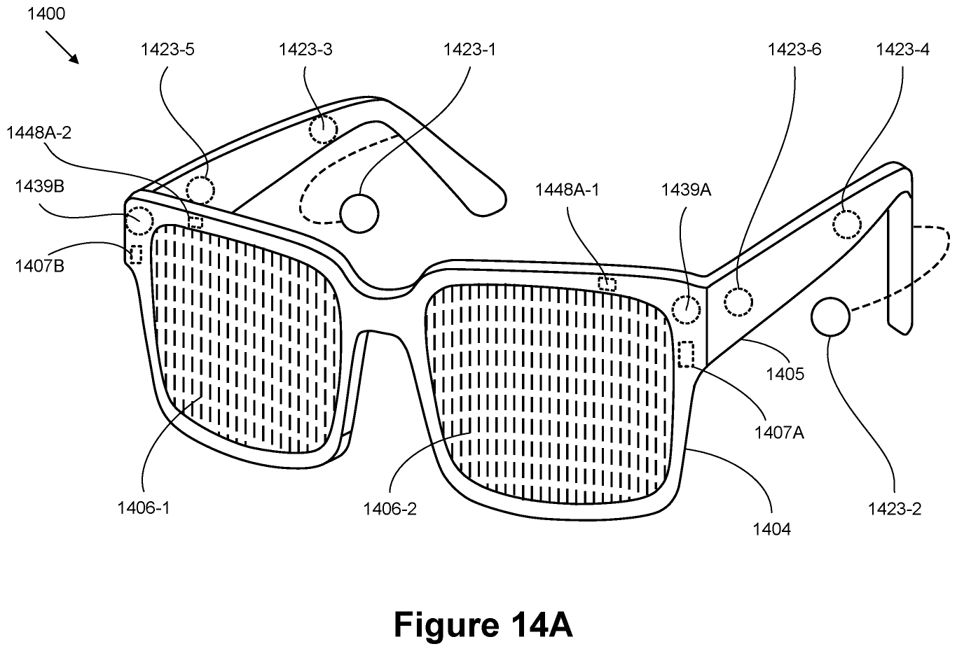

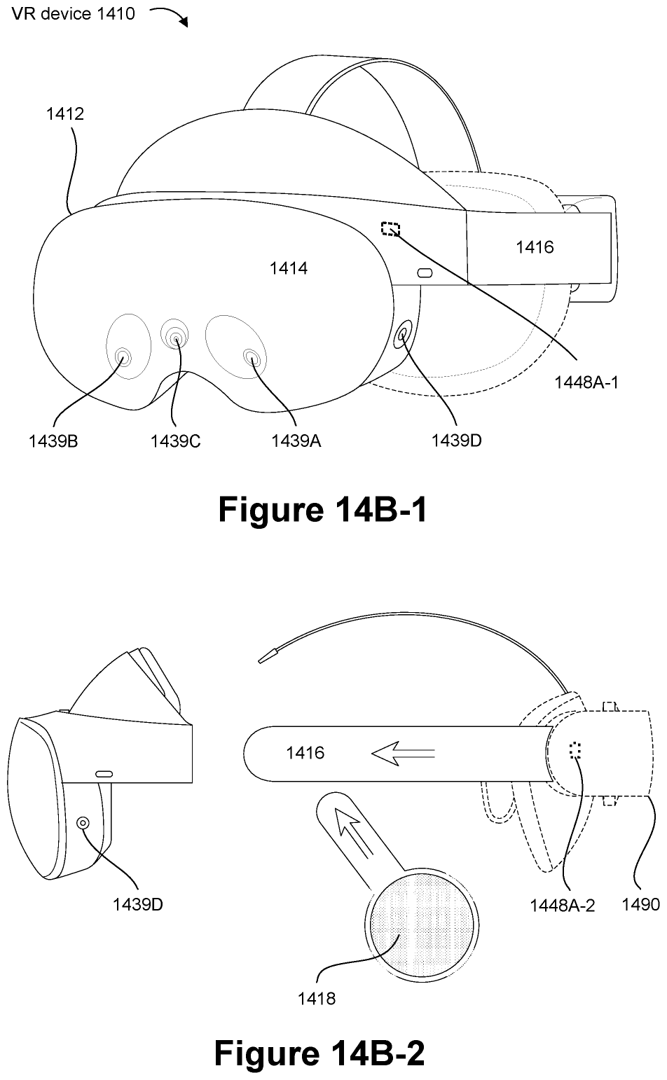

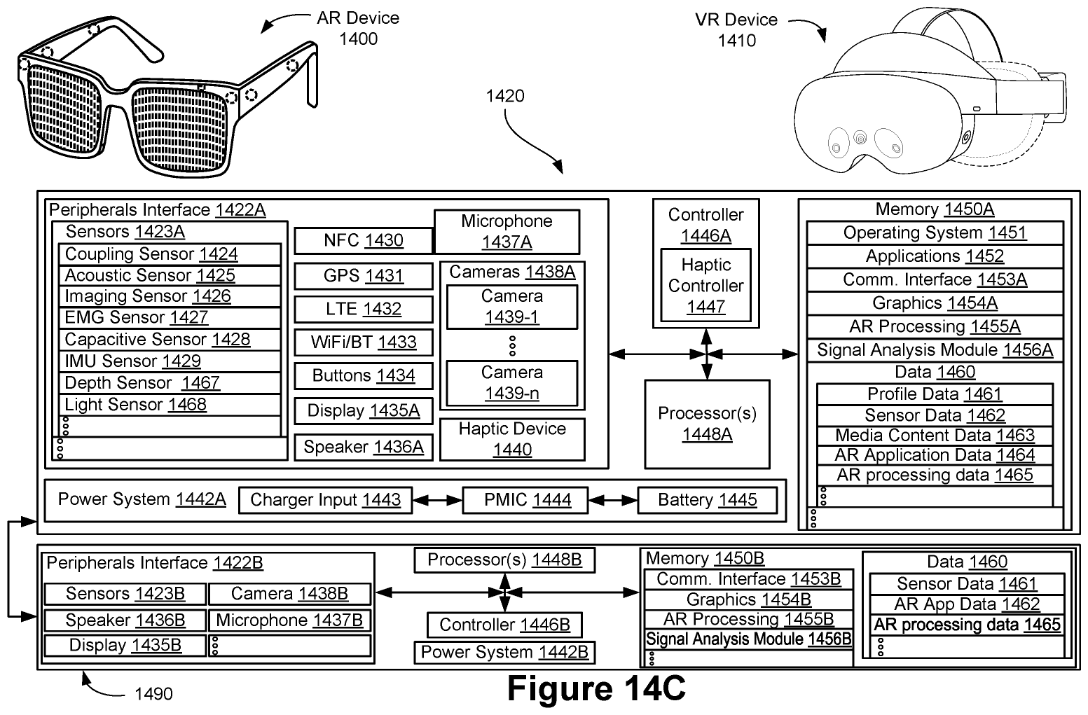

FIG. 4 illustrates positional calibration of neuromuscular-signal sensors of a wrist-wearable device and/or simulated neuromuscular-signal sensors, in accordance with some embodiments. The wrist-wearable device 110 is worn in the predetermined default position 100 (FIG. 1; e.g., the first edge 113a and odd numbered neuromuscular-signal sensors 415-1 through 415-9 are adjacent to the user's hand 117, and the second edge 113b and even numbered neuromuscular-signal sensors 415-2 through 415-10 are adjacent to the user's forearm 119). In some use cases, the wrist-wearable device 110 can shift or move while worn by the user 105 causing the wrist-wearable device 110 to be at a non-predetermined default position. Additionally or alternatively, the one or more the neuromuscular-signal sensors 415 (analogous to neuromuscular-signal sensors 115) can shift or move from their respective predetermined default positions by some distance. In some embodiments, the wrist-wearable device 110 is configured to correct neuromuscular signals sensed by the neuromuscular-signal sensors 415 and/or simulate neuromuscular signals to account for an offset of the wrist-wearable device 110 and/or an offset of at least one neuromuscular-signal sensor 415. In some embodiments, the corrected neuromuscular signals are based on historical sensor data (e.g., biometric data, neuromuscular signals, and/or other data collected by sensors 1425; FIG. 14A) obtained over a predetermined period of time (e.g., 15 days, 30 days, etc.). As an example, past neuromuscular signals can be used to simulate expected neuromuscular signals when the user 105 wears the wrist-wearable device 110 incorrectly.

As an example, in FIG. 4, a first neuromuscular-signal sensors 415-1 is shifted from its respective predetermined default position (a first predetermined default position 417-1) by a distance of d1, a second neuromuscular-signal sensors 415-2 is shifted from its respective predetermined default position (a second predetermined default position 417-2) by a distance of d2, and a ninth neuromuscular-signal sensors 415-9 is shifted from its respective predetermined default position (ninth predetermined default position 417-9) by a distance of d3. The wrist-wearable device 110 can provide the neuromuscular signals sensed by the one or more neuromuscular-signal sensors 415 to a signal analysis module 150, which corrects the sensed neuromuscular signals and/or simulates neuromuscular signals to account for the wrist-wearable device shift and/or neuromuscular-signal sensor shifts. More specifically, the wrist-wearable device 110 adjusts analysis of the neuromuscular signals sensed by the neuromuscular-signal sensors 415 by adjusting signal values of neuromuscular signals sensed by at least one neuromuscular-signal sensor 415, which are adjusted based on a distance offset that is equal to a distance between the current position of the least one neuromuscular-signal sensor 415 and its respective predetermined default position. For example, the signal values of the neuromuscular signals sensed by the first neuromuscular-signal sensor 415-1 can be adjusted based on the distance d1.

The wrist-wearable device 110 can adjust signal values of neuromuscular signals sensed by more than one neuromuscular-signal sensor 415 at a time. In some embodiments, the wrist-wearable device 110 adjusts the signal values of neuromuscular signals sensed by each neuromuscular-signal sensor 415 with a distance offset (e.g. the distance between its current position and respective predetermined default position). The signal values of the neuromuscular signals are adjusted based the respective distance offsets of the neuromuscular-signal sensors 415 that sensed the neuromuscular signals. For example, signal values of the neuromuscular signals sensed by the first neuromuscular-signal sensor 415-1 are adjusted by distance d1, signal values of the neuromuscular signals sensed by the second neuromuscular-signal sensor 415-2 are adjusted by distance d2, and signal values of the neuromuscular signals sensed by the ninth neuromuscular-signal sensor 415-9 are adjusted by distance d3.

The distance offsets can be a widthwise distance (e.g., distance d1), a longitudinal distance (e.g., distance d2), and/or a diagonal distance (e.g., distance d3). The different distance offsets can be the same or distinct. In some embodiments, different portions of the wrist-wearable device 110 can be stretched, rotated, twisted, pulled, etc. resulting in a neuromuscular-signal sensor 415 distance offset even if the wrist-wearable device 110 is properly worn. By adjusting the signal values of the sensed neuromuscular signals based on respective distance offsets, the wrist-wearable device 110 can improve its accuracy.

Alternatively or in addition, in some embodiments, the wrist-wearable device 110 simulates one or more neuromuscular signals based on the offset between the worn position of the wrist-wearable device 110 and the predetermined default position 100. More specifically, the wrist-wearable device 110 can simulate one or more neuromuscular signals such that they are consistent with neuromuscular signals measured at the predetermined default position 100. For example, in FIG. 4, the first neuromuscular-signal sensor 415-1 is at a first portion of the wrist-wearable device 110, which is offset from the first predetermined default position 417-1 by the distance of d1, and senses neuromuscular signals at the first portion of the wrist-wearable device 110; the wrist-wearable device 110 provides the neuromuscular signals sensed at the first portion of the wrist-wearable device 110 by the first neuromuscular-signal sensor 415-1 to the signal analysis module 150. The signal analysis module 150 determines a simulated neuromuscular signal for the first neuromuscular-signal sensor 415-1 based on the offset distance d1, such that the simulated neuromuscular signal is representative of a neuromuscular signal measured by the neuromuscular-signal sensor 415-1 at the first predetermined default position 417-1. Alternatively or additionally, in some embodiments, the signal analysis module 150 determines a simulated neuromuscular signal for the first neuromuscular-signal sensor 415-1 based on the offset between the worn position of the wrist-wearable device 110 and the predetermined default position 100, such that the simulated neuromuscular signal is representative of a neuromuscular signal measured by the neuromuscular-signal sensor 415-1 at the first predetermined default position 417-1.

In some embodiments, the wrist-wearable device 110 can simulate neuromuscular signals to account for widthwise offsets (e.g., distance d1), longitudinal offsets (e.g., distance d2) in widthwise, or a combination of the two (e.g., distance d3). The wrist-wearable device 110 can simulate neuromuscular signals for any number of neuromuscular-signal sensors 415 that are offset. In some embodiments, the wrist-wearable device simulates neuromuscular signals for the minimum number of neuromuscular-signal sensors 415 needed to satisfy the predetermined performance criteria. If the wrist-wearable device 110 determines that the wrist-wearable device 110 is not offset from the predetermined default position 100, the wrist-wearable device forgoes simulating the neuromuscular signals.

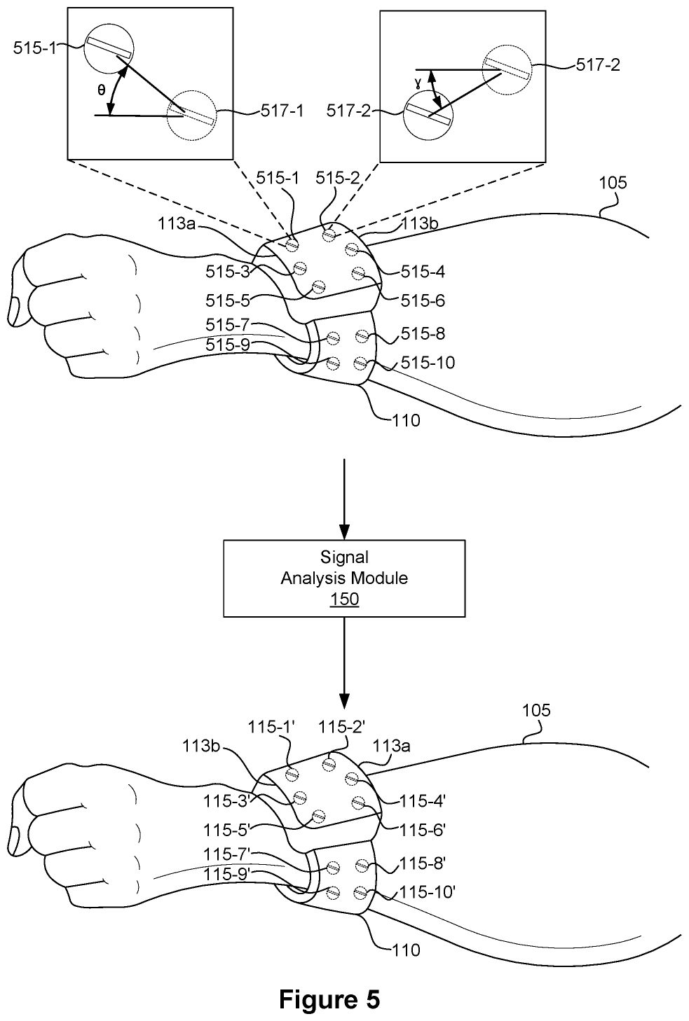

FIG. 5 illustrates angular calibration of neuromuscular-signal sensors of a wrist-wearable device, in accordance with some embodiments. The wrist-wearable device 110 is worn in the predetermined default position 100, as described above in reference to FIG. 1 and FIG. 4. In some use cases, the wrist-wearable device 110 can shift, move, twist, or rotate while worn by the user 105 causing the wrist-wearable device 110 to be at a non-predetermined default position (position other than the predetermined default position 100) and/or one or more the neuromuscular-signal sensors 515 (analogous to neuromuscular-signal sensors 115) to shift or move from their respective predetermined default positions by some angle. In some embodiments, the wrist-wearable device 110 is configured to correct neuromuscular signals sensed by the neuromuscular-signal sensors 515 and/or simulate neuromuscular signals to account for an angular offset of the wrist-wearable device 110 and/or an angular offset of at least one neuromuscular-signal sensor 515. As described above in reference to FIG. 4, the corrected neuromuscular signals can be based on historical sensor data or neuromuscular signals obtained over a predetermined period of time (e.g., 15 days, 30 days, etc.).

As an example, in FIG. 5, a first neuromuscular-signal sensors 515-1 is shifted from its respective predetermined default position (a first predetermined default position 517-1) by a first angle (e.g., theta; θ) and a second neuromuscular-signal sensors 515-2 is shifted from its respective predetermined default position (a second predetermined default position 517-2) by a second angle (e.g., gamma; γ). As described above in reference to FIG. 4, the wrist-wearable device 110 can provide the neuromuscular signals sensed by the one or more neuromuscular-signal sensors 515 to a signal analysis module 150 to correct the sensed neuromuscular signals and/or simulate neuromuscular signals to account for the wrist-wearable device shift and/or neuromuscular-signal sensor shifts. In the example illustrated in FIG. 5, the wrist-wearable device 110 adjusts analysis of the neuromuscular signals sensed by the first neuromuscular-signal sensor 515-1 based on the first angle (θ) and the neuromuscular signals sensed by the second neuromuscular-signal sensor 515-2 based on the second angle (γ).

The wrist-wearable device 110 can adjust signal values of neuromuscular signals sensed by more than one neuromuscular-signal sensor 515 at a time. In some embodiments, the wrist-wearable device 110 adjusts the signal values of neuromuscular signals sensed by each neuromuscular-signal sensor 515 with an angular offset (e.g. the angle difference between its current position and respective predetermined default position). The signal values of the neuromuscular signals are adjusted based the respective angular offsets of the neuromuscular-signal sensors 515 that sensed the neuromuscular signals. For example, signal values of the neuromuscular signals sensed by the first neuromuscular-signal sensor 515-1 are adjusted by the first angle (θ) and signal values of the neuromuscular signals sensed by the second neuromuscular-signal sensor 515-2 are adjusted by the second angle (γ). The first and second angles θ and γ can be the same or distinct. The angular offsets can be in the same or opposite directions

As described above, in some embodiments, different portions of the wrist-wearable device 110 can be stretched, rotated, twisted, pulled, etc. resulting in a neuromuscular-signal sensor 515 angular offset even if the wrist-wearable device 110 is properly worn. As described above, by adjusting the signal values of the sensed neuromuscular signals based on respective angular offsets, the wrist-wearable device 110 can improve its accuracy.

Alternatively or in addition, in some embodiments, the wrist-wearable device 110 simulates one or more neuromuscular signals based on the angular offset between the worn position of the wrist-wearable device 110 and the predetermined default position 100. Similar to the process described above in reference to FIG. 4, the wrist-wearable device 110 can simulate one or more neuromuscular signals such that they are consistent with neuromuscular signals measured at the predetermined default position 100. For example, in FIG. 5, the first neuromuscular-signal sensor 515-1 is at a first portion of the wrist-wearable device 110, which is offset from the first predetermined default position 517-1 by the first angle (θ), and senses neuromuscular signals at the first portion of the wrist-wearable device 110; the wrist-wearable device 110 provides the neuromuscular signals sensed at the first portion of the wrist-wearable device 110 by the first neuromuscular-signal sensor 515-1 to the signal analysis module 150. The signal analysis module 150 determines a simulated neuromuscular signal for the first neuromuscular-signal sensor 515-1 based on a first angular offset (e.g., first angle (θ)), such that the simulated neuromuscular signal is representative of a neuromuscular signal measured by the neuromuscular-signal sensor 515-1 at the first predetermined default position 517-1. Alternatively or additionally, in some embodiments, the analysis module 150 determines a simulated neuromuscular signal for the first neuromuscular-signal sensor 515-1 based on the offset between the worn position of the wrist-wearable device 110 and the predetermined default position 100, such that the simulated neuromuscular signal is representative of a neuromuscular signal measured by the neuromuscular-signal sensor 515-1 at the first predetermined default position 517-1.

In some embodiments, the wrist-wearable device 110 can simulate neuromuscular signals to account for widthwise offsets (e.g., distance d1), longitudinal offsets (e.g., distance d2) in widthwise, or a combination of the two (e.g., distance d3). The wrist-wearable device 110 can simulate neuromuscular signals for any number of neuromuscular-signal sensors 415 that are offset. In some embodiments, the wrist-wearable device simulates neuromuscular signals for the minimum number of neuromuscular-signal sensors 415 needed to satisfy the predetermined performance criteria. If the wrist-wearable device 110 determines that the wrist-wearable device 110 is not offset from the predetermined default position 100, the wrist-wearable device forgoes simulating the neuromuscular signals.

A skilled artisan will appreciate that the different techniques described above in reference to FIG. 2-5 can be performed independently or in conjunction with one another. In some embodiments, the wrist-wearable device 110 can reindex, sensor swap, and/or sensor substitute neuromuscular-signal sensors 115 without signal correction and/or signal simulation. Similarly, the wrist-wearable device 110 can correction one or more neuromuscular signals and/or simulate one or more neuromuscular signals without reindexing, sensor swapping, and/or sensor substituting neuromuscular-signal sensors 115.

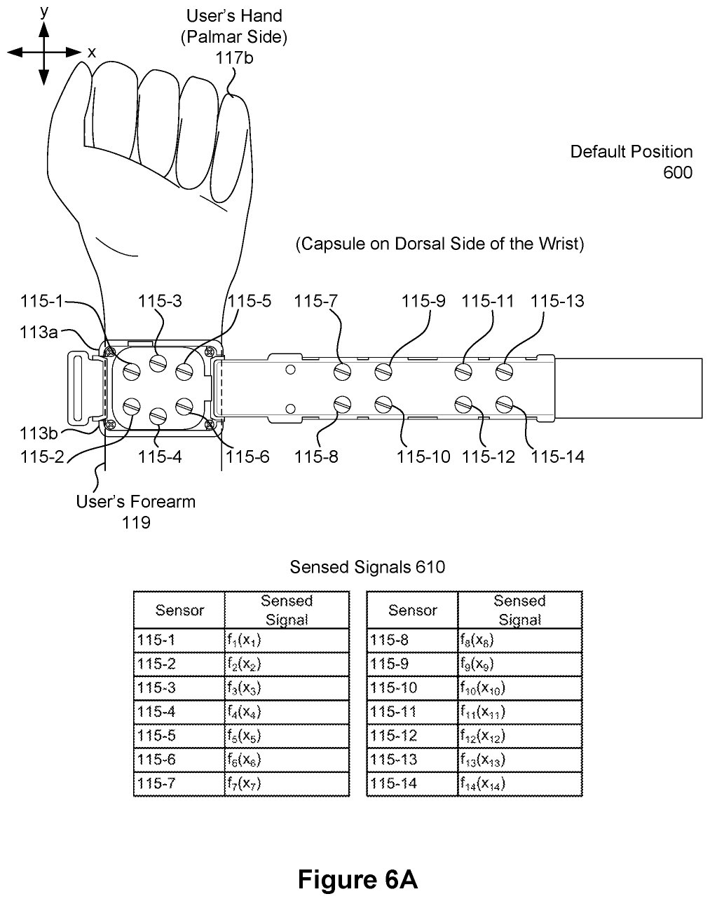

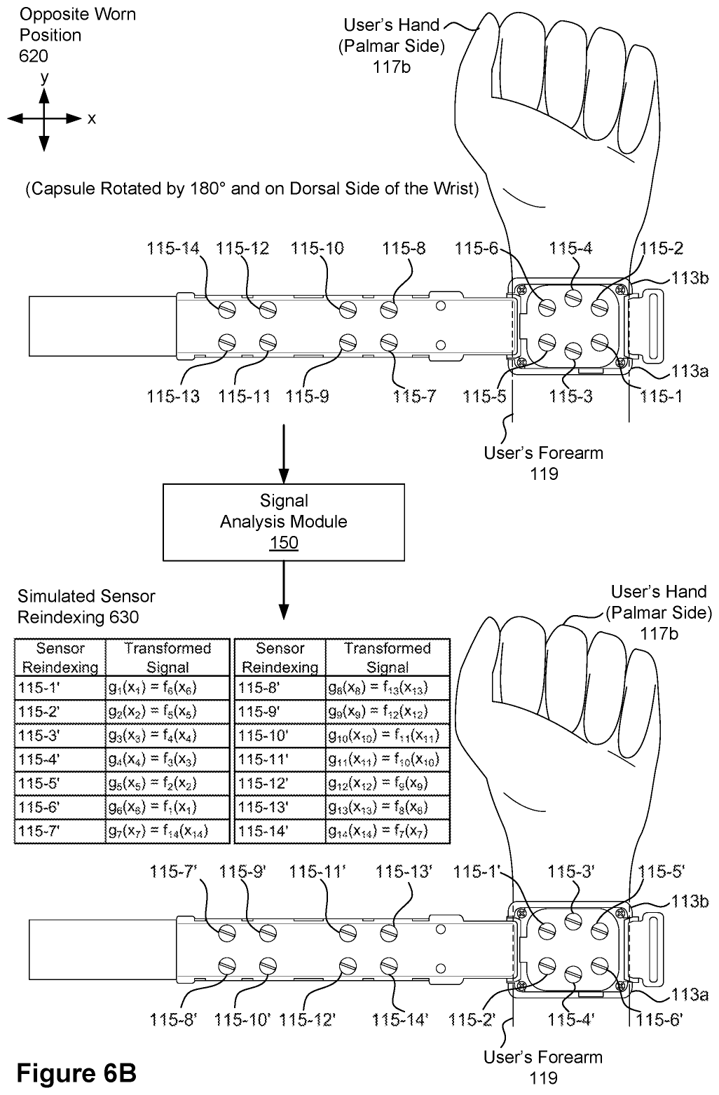

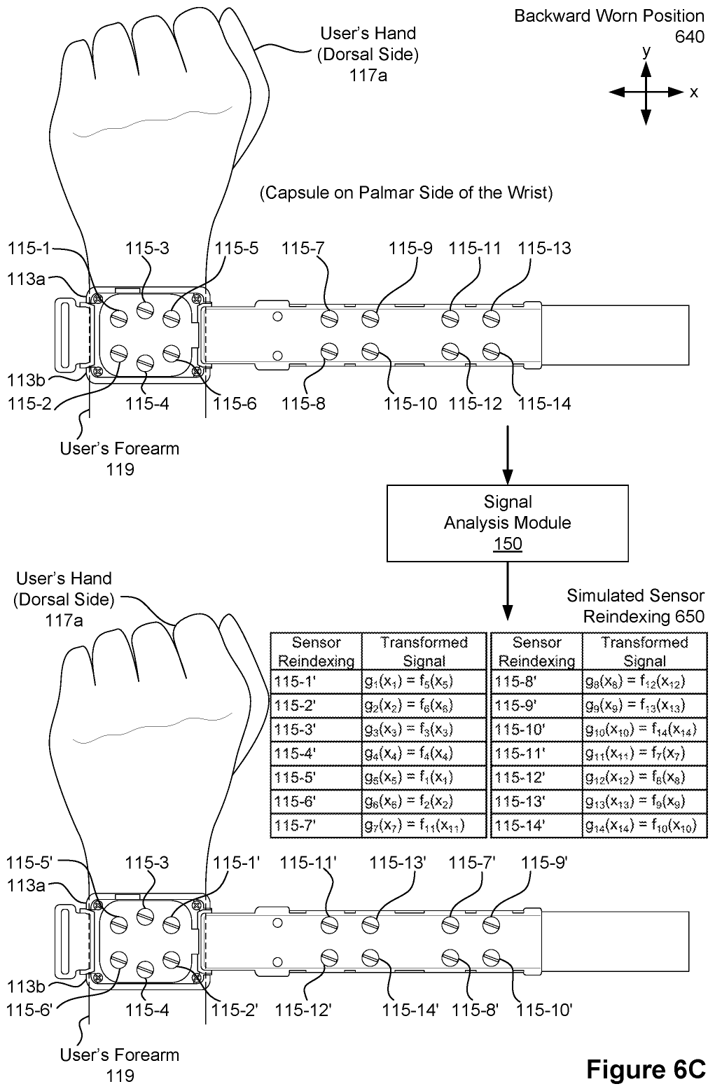

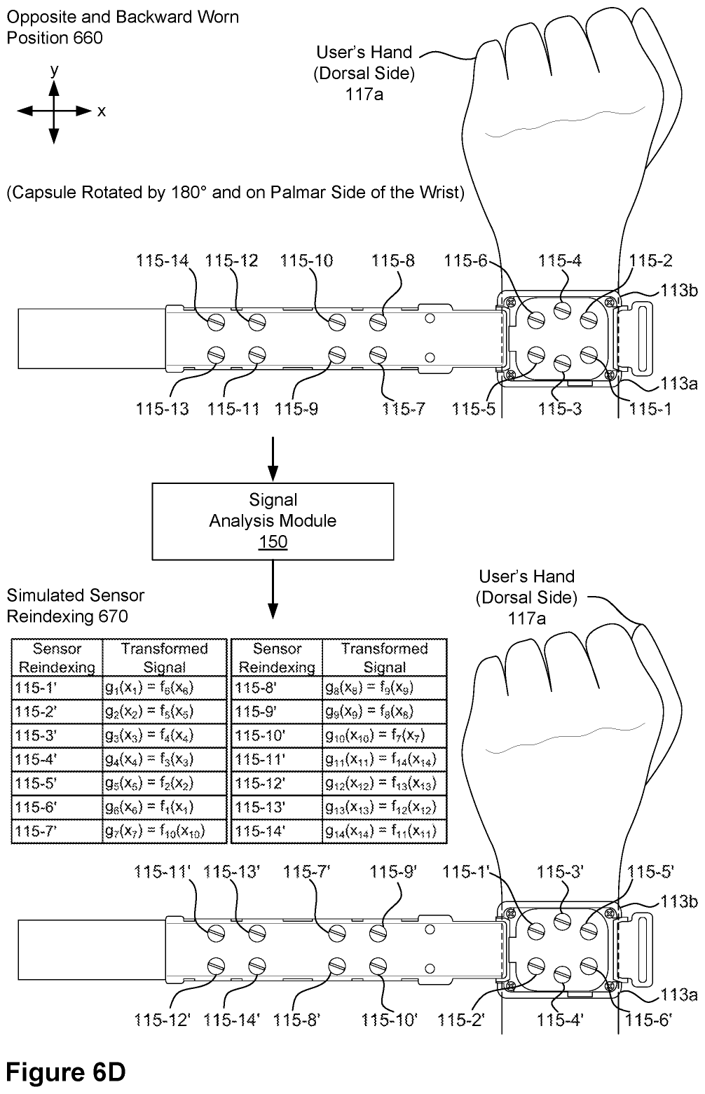

FIGS. 6A-6D illustrate the wrist-wearable device reindexing one or more neuromuscular-signal sensors based different user worn positions, in accordance with some embodiments. FIG. 6A illustrates the wrist-wearable device 110 worn in a default position 600 (analogous to the predetermined default position 100). In particular, the user's hand 117 is shown palm side up (e.g., the palmar side of the user's hand 117b is shown), a capsule portion 112 of the wrist-wearable device 110 is on the dorsal surface of the user's hand 117 (e.g., surface opposite the palmar side of the user's hand 117b), a first edge 113a of the wrist-wearable device 110 is worn adjacent to the user's hand 117, and a second edge 113b of the wrist-wearable device 110 is worn adjacent to the user's forearm 119. Similar to FIG. 1, odd numbered neuromuscular-signal sensors 115-1, 115-3, 115-5, 115-7, 115-9, 115-11, and 115-13 have respective predetermined default positions adjacent to the user's hand 117 and even numbered neuromuscular-signal sensors 115-2, 115-4, 115-6, 115-8, 115-10, 115-12, and 115-14 have respective predetermined default positions adjacent to the user's forearm 119.

FIG. 6A further includes sensed signal table 610 illustrating each neuromuscular-signal sensor 115 and the respective neuromuscular signals sensed by the neuromuscular-signal sensor 115. For example, the first neuromuscular-signal sensor 115-1 senses first neuromuscular signals f1(x1), the second neuromuscular-signal sensor 115-2 senses second neuromuscular signals f2(x2), the third neuromuscular-signal sensor 115-2 senses third neuromuscular signals f3(x3), etc.

In FIG. 6B, the wrist-wearable device 110 is shown worn in an opposite orientation to the default position 600. In particular, the opposite worn position 620 (similar to the worn position described above in reference to FIG. 2) shows the palmar side of the user's hand 117b, the first edge 113a of the wrist-wearable device 110 worn adjacent to the user's forearm 119 instead of adjacent to the user's hand 117, the second edge 113b worn adjacent to the user's hand 117 instead of adjacent to the user' forearm 119, and the capsule portion 112 of the wrist-wearable device 110 positioned on the dorsal surface of the user's hand 117. Further, even numbered neuromuscular-signal sensors 115-2 through 115-14, are adjacent to the user's hand 117 and odd numbered neuromuscular-signal sensors 115-1 through 115-13 are adjacent to the user's forearm 119 (which are opposite to the default position 600).

As described above in reference to FIG. 2, the wrist-wearable device 110 can, upon determining that pulses sensed by one or more neuromuscular-signal sensors 115 indicate that at least one neuromuscular-signal sensor 115 of the wrist-wearable device 110 is offset from a respective predetermined default position, determine a worn position of the wrist-wearable device 110 on the user's wrist, and adjust analysis of neuromuscular signals sensed by the neuromuscular-signal sensors 115 based on an offset between the worn position of the wrist-wearable device 110 (e.g., the opposite worn position 620) and the default position 600 of the wrist-wearable device 110. Adjusting analysis of the neuromuscular signals sensed by the neuromuscular-signal sensors 115 based on the offset between the opposite worn position 620 and the default position 600 of the wrist-wearable device 110 can include analyzing neuromuscular signals sensed by the one neuromuscular-signal sensor 115 in place of the neuromuscular signals sensed by another neuromuscular-signal sensor 115 (e.g., swapping or reindexing the neuromuscular-signal sensors).

For example, as shown in FIG. 6B, the wrist-wearable device 110 provides the neuromuscular signals sensed by the neuromuscular-signal sensors 115 to the signal analysis module 150 which adjusts analysis of neuromuscular signals such that the neuromuscular-signal sensors 115 are reindexed to the default position 600. In particular, as shown in simulated sensor reindexing table 630, the fourteenth neuromuscular-signal sensor 115-14 is reindexed to a simulated seventh neuromuscular-signal sensor 115-7′ (e.g., which provides neuromuscular signals that are analyzed as neuromuscular signals sensed by the seventh neuromuscular-signal sensor 115-7 as shown in the default position 600) and the seventh neuromuscular-signal sensor 115-7 is reindexed to a simulated fourteenth neuromuscular-signal sensor 115-14′ (e.g., which provides neuromuscular signals that are analyzed as neuromuscular signals sensed by the fourteenth neuromuscular-signal sensor 115-14 as shown in the default position 600). Similarly, the twelfth neuromuscular-signal sensor 115-12 is reindexed to a simulated ninth neuromuscular-signal sensor 115-9′, the tenth neuromuscular-signal sensor 115-10 is reindexed to a simulated eleventh neuromuscular-signal sensor 115-11′, and the eighth neuromuscular-signal sensor 115-8 is reindexed to a simulated thirteenth neuromuscular-signal sensor 115-13′. The odd neuromuscular-signal sensors 115-9, 115-11, and 115-13 are reindexed to simulated even neuromuscular-signal sensors 115-12′, 115-10′, and 115-5′, respectively. The neuromuscular-signal sensors 115 under the capsule portion 112 are also reindexed. For example, the odd neuromuscular-signal sensors 115-1, 115-3, and 115-5 are reindexed to simulated even neuromuscular-signal sensors 115-6′, 115-4′, and 115-2′, respectively; and the even neuromuscular-signal sensors 115-6, 115-4, and 115-2 are reindexed to simulated even neuromuscular-signal sensors 115-1′, 115-3′, and 115-5′, respectively.

Turning to FIG. 6C, the wrist-wearable device 110 is shown worn in a backward or upside orientation to the default position 600. In particular, the backward worn position 640 shows the dorsal side of the user's hand 117a, the capsule portion 112 of the wrist-wearable device 110 positioned on the palmar surface of the user's hand 117 (instead of the palmar surface as is the case for the default position 600), the first edge 113a of the wrist-wearable device 110 worn adjacent to the user's hand 117, and the second edge 113b worn adjacent to the user's 119. The even numbered neuromuscular-signal sensors 115-2 through 115-14, are adjacent to the user's forearm 119 and the odd numbered neuromuscular-signal sensors 115-1 through 115-13 are adjacent to the user's hand 117 (which are on opposite sides of the user 105's wrist when compared to the default position 600 configuration).

As described above, the wrist-wearable device 110 can adjust analysis of neuromuscular signals sensed by the neuromuscular-signal sensors 115 based on an offset between the worn position of the wrist-wearable device 110 (e.g., the backward worn position 640) and the default position 600 of the wrist-wearable device 110. Further, adjusting analysis of the neuromuscular signals sensed by the neuromuscular-signal sensors 115 based on the offset between the backward worn position 640 and the default position 600 of the wrist-wearable device 110 can include analyzing neuromuscular signals sensed by the one neuromuscular-signal sensor 115 in place of the neuromuscular signals sensed by another neuromuscular-signal sensor 115 (e.g., swapping or reindexing the neuromuscular-signal sensors).

For example, as shown in FIG. 6C, the wrist-wearable device 110 provides the neuromuscular signals sensed by the neuromuscular-signal sensors 115 to the signal analysis module 150 which adjusts analysis of neuromuscular signals such that the neuromuscular-signal sensors 115 are reindexed to the default position 600. In particular, as shown in simulated sensor reindexing table 650, the fourteenth neuromuscular-signal sensor 115-14 is reindexed to a simulated tenth neuromuscular-signal sensor 115-10′ (e.g., which provides neuromuscular signals that are analyzed as neuromuscular signals sensed by the tenth neuromuscular-signal sensor 115-10 as shown in the default position 600) and the tenth neuromuscular-signal sensor 115-10 is reindexed to a simulated fourteenth neuromuscular-signal sensor 115-14′ (e.g., which provides neuromuscular signals that are analyzed as neuromuscular signals sensed by the fourteenth neuromuscular-signal sensor 115-14 as shown in the default position 600). Similarly, the twelfth neuromuscular-signal sensor 115-12 is reindexed to a simulated eighth neuromuscular-signal sensor 115-8′ and the eighth neuromuscular-signal sensor 115-8 is reindexed to a simulated twelfth neuromuscular-signal sensor 115-12′. The odd neuromuscular-signal sensors 115-7, 115-9, 115-11, and 115-13 are reindexed to simulated neuromuscular-signal sensors 115-11′, 115-13′, 115-11′, and 115-9′, respectively.

In some embodiments, the neuromuscular-signal sensors 115 under the capsule portion 112 are also reindexed. For example, the odd neuromuscular-signal sensors 115-1 and 115-5 are reindexed to simulated neuromuscular-signal sensors 115-5′ and 115-1′, respectively; and the even neuromuscular-signal sensors 115-2 and 115-5 are reindexed to simulated neuromuscular-signal sensors 115-6′ and 115-2′, respectively. When the wrist-wearable device 110 is in the backward worn position 640, neuromuscular-signal sensors 115-3 and 115-4 are not reindexed as they positioned at the center of the capsule portion 112. Alternatively, in some embodiments, the neuromuscular-signal sensors 115 under the capsule portion 112 are not reindexed and their respective neuromuscular signals are processed without being adjusted.

In FIG. 6D, the wrist-wearable device 110 is shown worn in a backward or upside orientation and in an opposite orientation to the default position 600. In particular, the opposite and backward worn position 660 shows the dorsal side of the user's hand 117a, the capsule portion 112 of the wrist-wearable device 110 positioned on the palmar surface of the user's hand 117 (instead of the palmar surface as is the case for the default position 600), the first edge 113a of the wrist-wearable device 110 worn adjacent to the user's forearm 119 instead of adjacent to the user's hand 117, and the second edge 113b worn adjacent to the user's hand 117 instead of adjacent to the user' forearm 119. The even numbered neuromuscular-signal sensors 115-2 through 115-14, are adjacent to the user's hand 117 and the odd numbered neuromuscular-signal sensors 115-1 through 115-13 are adjacent to the user's forearm 119 (which are opposite and upside down to the default position 600).

As described above, the wrist-wearable device 110 can adjust analysis of neuromuscular signals sensed by the neuromuscular-signal sensors 115 based on an offset between the worn position of the wrist-wearable device 110 (e.g., the opposite backward worn position 660) and the default position 600 of the wrist-wearable device 110. Further, adjusting analysis of the neuromuscular signals sensed by the neuromuscular-signal sensors 115 based on the offset between the opposite and backward worn position 660 and the default position 600 of the wrist-wearable device 110 can include analyzing neuromuscular signals sensed by the one neuromuscular-signal sensor 115 in place of the neuromuscular signals sensed by another neuromuscular-signal sensor 115 (e.g., swapping or reindexing the neuromuscular-signal sensors).

For example, as shown in FIG. 6D, the wrist-wearable device 110 provides the neuromuscular signals sensed by the neuromuscular-signal sensors 115 to the signal analysis module 150 which adjusts analysis of neuromuscular signals such that the neuromuscular-signal sensors 115 are reindexed to the default position 600. In particular, as shown in simulated sensor reindexing table 650, the even neuromuscular-signal sensor 115-14, 115-12, 115-10, and 115-8 are reindexed to simulated odd neuromuscular-signal sensors 115-11′, 115-13′, 115-7′, and 115-9′, respectively (e.g., which provides neuromuscular signals that are analyzed as neuromuscular signals sensed by neuromuscular-signal sensors 115 at their default position shown in the default position 600). Similarly odd neuromuscular-signal sensors 115-13, 115-11, 115-9, and 115-7 are reindexed to simulated even neuromuscular-signal sensors 115-12′, 115-14′, 115-8′, and 115-10′, respectively (e.g., which provides neuromuscular signals that are analyzed as neuromuscular signals sensed by neuromuscular-signal sensors 115-10 at their default position shown in the default position 600). The neuromuscular-signal sensors 115 under the capsule portion 112 are also reindexed. For example, the odd neuromuscular-signal sensors 115-1, 115-3, and 115-5 are reindexed to simulated even neuromuscular-signal sensors 115-6′, 115-4′, and 115-2′, respectively; and the even neuromuscular-signal sensors 115-6, 115-4, and 115-2 are reindexed to simulated even neuromuscular-signal sensors 115-1′, 115-3′, and 115-5′, respectively.

In other words, in FIG. 6D, the neuromuscular-signal sensors 115 are reindexed such that neuromuscular signals sensed by the odd neuromuscular-signal sensors 115-1, 115-3, 115-5, 115-7, 115-9, 115-11, and 115-13 are analyzed as if sensed by even neuromuscular-signal sensors 115-2, 115-4, 115-6, 115-8, 115-10, 115-12, and 115-14 adjacent to the user's forearm 119 and neuromuscular signals sensed by the even neuromuscular-signal sensors 115-2, 115-4, 115-6, 115-8, 115-10, 115-12, and 115-14 are analyzed as if sensed by odd neuromuscular-signal sensors 115-1, 115-3, 115-5, 115-7, 115-9, 115-11, and 115-13 adjacent to the user's hand 117.

By reindexing the neuromuscular-signal sensors 115 as described above in reference to FIGS. 6A-6D, the wrist-wearable device 110 is able to configure the neuromuscular-signal sensors 115 such that it operates as if in the default position 600 even if the user 105 wears the wrist-wearable device 110 incorrectly. This allows the wrist-wearable device 110 to accurately determine a hand gesture performed by the user 105 even if the wrist-wearable device 110 is worn incorrectly. Additionally, the wrist-wearable device 110 is able to automatically calibrate itself without relying on the user 105 to readjust the wrist-wearable device 110 (except in situations where the autocalibration does not satisfy the predetermined performance criteria, which results in feedback to provide to the user 105, as described above in reference to FIG. 3).

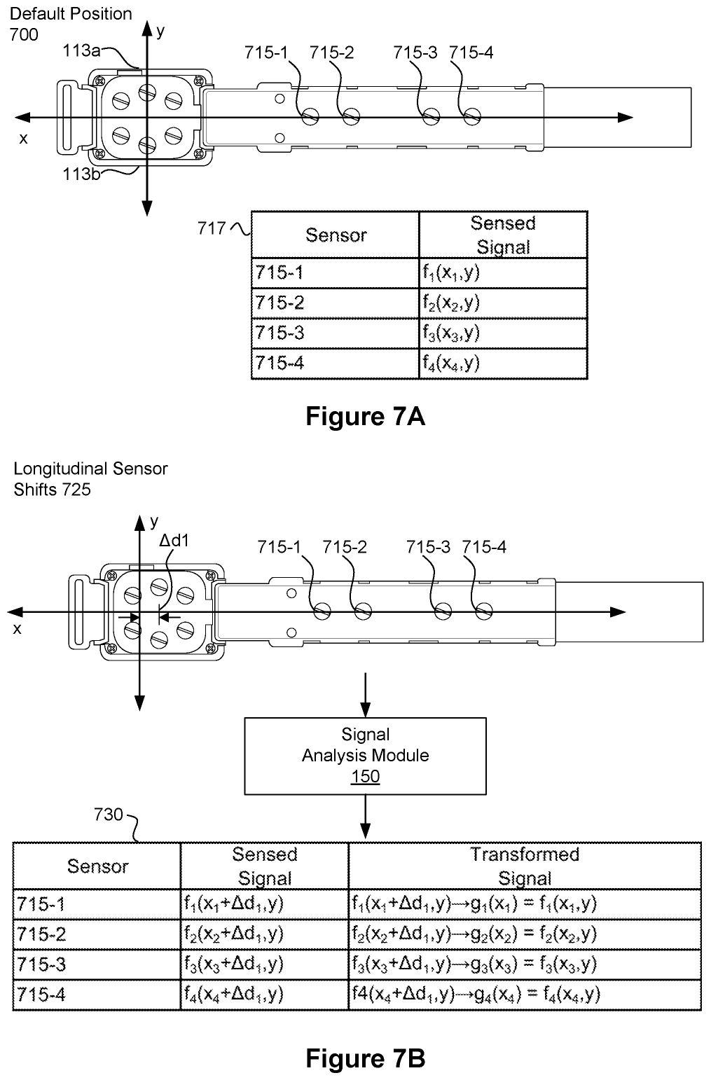

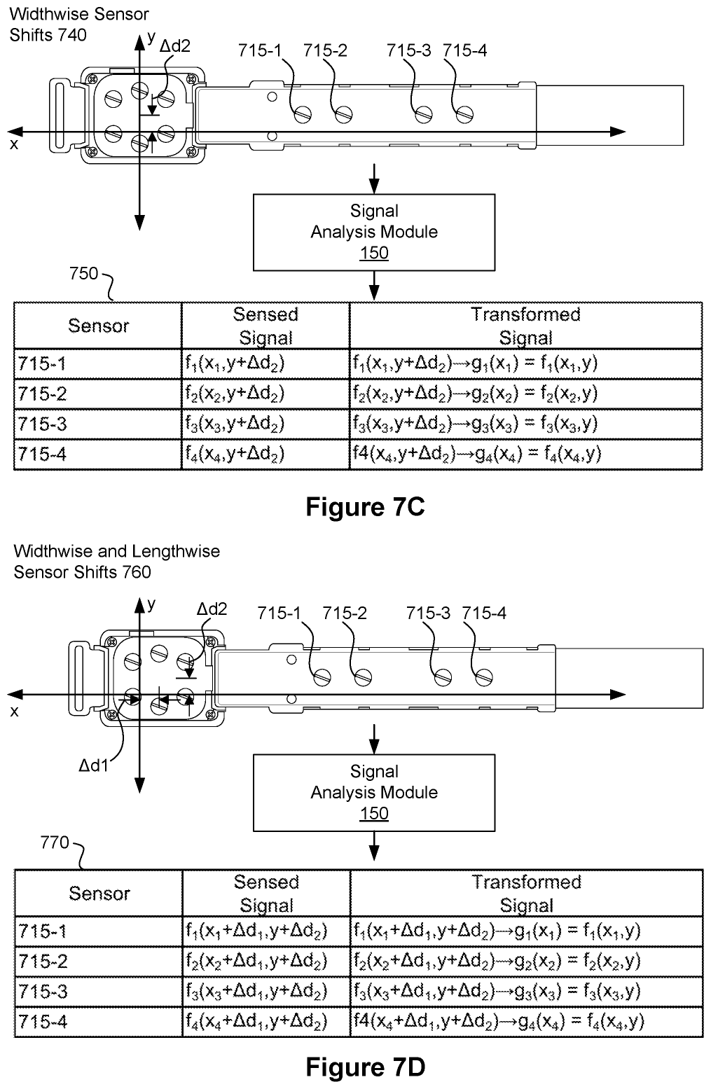

FIGS. 7A-7D illustrate adjustments to neuromuscular signals sensed by neuromuscular-signal sensors with longitudinal and/or widthwise offsets, in accordance with some embodiments. In some embodiments, adjustments to neuromuscular signals sensed by neuromuscular-signal sensors 115 with longitudinal and/or widthwise offsets can be based on historical sensor data obtained over a predetermined period of time as described above in reference to FIG. 4. FIG. 7A shows illustrates a wrist-wearable device 710 worn in a default position 700 (analogous to the predetermined default position 100 and default position 600). In particular, a capsule portion 112 of the wrist-wearable device 710 is on the dorsal surface of the user's hand 117 (e.g., FIGS. 1 and 6A), a first edge 113a of the wrist-wearable device 710 is worn adjacent to the user's hand 117, and a second edge 113b of the wrist-wearable device 710 is worn adjacent to the user's forearm 119. The wrist-wearable device 710 shows another configuration of the neuromuscular-signal sensors 715. In particular, a subset of the neuromuscular-signal sensors 715 are positioned at distinct center portions of the band of the wrist-wearable device 710.

FIG. 7A further includes a default position sensed signal table 717 illustrating each neuromuscular-signal sensor 715 and the respective neuromuscular signals sensed by the neuromuscular-signal sensor 715. For example, the first neuromuscular-signal sensor 715-1 senses first neuromuscular signals f1(x1,y), the second neuromuscular-signal sensor 715-2 senses second neuromuscular signals f2(x2,y), the third neuromuscular-signal sensor 715-2 senses third neuromuscular signals f3(x3,y), etc. Each x value represents a respective longitudinal position along the wrist-wearable device 710 and the y value represents a widthwise position along the wrist-wearable device 710.

Turning to FIG. 7B, the wrist-wearable device 710 is shown shifted a longitudinal distance from the default position 700 (e.g., longitudinal sensor shifts 725). In particular, the wrist-wearable device 710 has a longitudinal offset of distance d1 from the default position 700. Each neuromuscular-signal sensor 715 can be shifted by the same or distinct longitudinal offsets. For example, each neuromuscular-signal sensor 715 can be shifted by longitudinal distance d1. Alternatively, a first neuromuscular-signal sensor 715-1 can be shifted by a first longitudinal distance and a second neuromuscular-signal sensor 715-2 can be shifted by a second longitudinal distance that is distinct from the first longitudinal distance. One or more neuromuscular-signal sensors 715 can be shifted by different longitudinal distances due to compression, elongation, and/or twists of different portions of the wearable structure of the wrist-wearable device 710.

The wrist-wearable device 710 can, upon determining the presence of a wrist-wearable device 710 offset and/or a neuromuscular-signal sensor 715 offset (as discussed above in reference to FIGS. 2-6D), determines a worn position of the wrist-wearable device 710 and adjust analysis of neuromuscular signals sensed by the neuromuscular-signal sensors 715 based on a determined offset between the current worn position of the wrist-wearable device 710 and the default position 700 of the wrist-wearable device 710 (e.g., longitudinal distance d1) and/or a determined offset between at least one neuromuscular-signal sensor 715 and its respective predetermined default position. In some embodiments, adjusting analysis of the neuromuscular signals sensed by the neuromuscular-signal sensors 715 based on the offset of the wrist-wearable device 710 and/or an offset between at least one neuromuscular-signal sensor 715 and its respective predetermined default position includes adjusting signal values of neuromuscular signals sensed by at least one neuromuscular-signal sensor 715. In other words, the wrist-wearable device 710 can process the sensed neuromuscular signals to account for the longitudinal distance d1 offset.

For example, as shown in FIG. 7B, the wrist-wearable device 710 provides the neuromuscular signals sensed by the neuromuscular-signal sensors 715 to the signal analysis module 150 which adjusts analysis of neuromuscular signals such that the sensed neuromuscular signals are transformed or simulated as if measured by a wrist-wearable device 710 worn in the default position 700. In particular, as shown in longitudinally adjusted signal table 730, the first through fourth neuromuscular-signal sensors 715-1 through 715-4 sense neuromuscular signals at their respective longitudinal position plus the longitudinal distance d1 and the signal analysis module 150 adjusts analysis of the neuromuscular signals such that they are simulated as sensed at the respective longitudinal position of the first through fourth neuromuscular-signal sensors 715-1 through 715-4. For example, the first neuromuscular-signal sensor 715-1 senses neuromuscular signals f1(x1+Δd1,y) (e.g., neuromuscular signals sensed at longitudinal position x1 plus distance d1 and at a y widthwise position of the wrist-wearable device 710) which are adjusted by the signal analysis module 150 to simulate neuromuscular signals f1(x1,y) (e.g., neuromuscular signals sensed at longitudinal position x1 and at a y widthwise position of the wrist-wearable device 710). Additionally, the neuromuscular signals sensed by the neuromuscular-signal sensors 115 under the capsule portion 112 can also adjusted based on the longitudinal distance d1 as described above. Although the above example adjusts neuromuscular signals sensed by the neuromuscular-signal sensors 715 based on longitudinal distance d1, the skilled artisan will appreciate that the signal analysis module 150 can adjusts the neuromuscular signals for each neuromuscular-signal sensors 715 based on the respective longitudinal offset between its current position and its respective predetermined default position.

In FIG. 7C, the wrist-wearable device 710 is shown shifted a widthwise distance from the default position 700 (e.g., widthwise sensor shifts 740). In particular, the wrist-wearable device 710 has a widthwise offset of distance d2 from the default position 700. Each neuromuscular-signal sensor 715 can be shifted by the same or distinct widthwise offsets. For example, each neuromuscular-signal sensor 715 can be shifted by widthwise distance d2. Alternatively, the first neuromuscular-signal sensor 715-1 can be shifted by a first widthwise distance and a second neuromuscular-signal sensor 715-2 can be shifted by a second widthwise distance that is distinct from the first widthwise distance. One or more neuromuscular-signal sensors 715 can be shifted by different widthwise distances due to compression, elongation, and/or twists of different portions of the wearable structure of the wrist-wearable device 710.

The wrist-wearable device 710 can, upon determining the presence of a wrist-wearable device 710 offset and/or a neuromuscular-signal sensor 715 offset (as discussed above in reference to FIGS. 2-6D), determines a worn position of the wrist-wearable device 710 and adjust analysis of neuromuscular signals sensed by the neuromuscular-signal sensors 715 based on a determined offset between the current worn position of the wrist-wearable device 710 and the default position 700 of the wrist-wearable device 710 (e.g., widthwise distance d2) and/or a determined offset between at least one neuromuscular-signal sensor 715 and its respective predetermined default position. In some embodiments, adjusting analysis of the neuromuscular signals sensed by the neuromuscular-signal sensors 715 based on the offset of the wrist-wearable device 710 and/or an offset between at least one neuromuscular-signal sensor 715 and its respective predetermined default position includes adjusting signal values of neuromuscular signals sensed by at least one neuromuscular-signal sensor 715. In other words, the wrist-wearable device 710 can process the sensed neuromuscular signals to account for the widthwise distance d2 offset.

For example, as shown in FIG. 7C, the wrist-wearable device 710 provides the neuromuscular signals sensed by the neuromuscular-signal sensors 715 to the signal analysis module 150 which adjusts analysis of neuromuscular signals such that the sensed neuromuscular signals are transformed or simulated as if measured by a wrist-wearable device 710 worn in the default position 700. In particular, as shown in widthwise adjusted signal table 750, the first through fourth neuromuscular-signal sensors 715-1 through 715-4 sense neuromuscular signals at their respective widthwise position plus the widthwise distance d2 and the signal analysis module 150 adjusts analysis of the neuromuscular signals such that they are simulated as sensed at the respective widthwise position of the first through fourth neuromuscular-signal sensors 715-1 through 715-4. For example, the first neuromuscular-signal sensor 715-1 senses neuromuscular signals f1(x1,y+Δd2) (e.g., neuromuscular signals sensed at longitudinal position x1 and at a y widthwise position plus distance d2 of the wrist-wearable device 710) which are adjusted by the signal analysis module 150 to simulate neuromuscular signals f1(x1,y) (e.g., neuromuscular signals sensed at longitudinal position x1 and at a y widthwise position of the wrist-wearable device 710). The neuromuscular signals sensed by the neuromuscular-signal sensors 115 under the capsule portion 112 can also adjusted based on the widthwise distance d2 as described above. Although the above example adjusts neuromuscular signals sensed by the neuromuscular-signal sensors 715 based on widthwise distance d2, the skilled artisan will appreciate that the signal analysis module 150 can adjusts the neuromuscular signals for each neuromuscular-signal sensors 715 based on the respective widthwise offset between its current position and its respective predetermined default position.

In FIG. 7D, the wrist-wearable device 710 is shown shifted widthwise and longitudinal distances from the default position 700 (e.g., widthwise and longitudinal sensor shifts 760). In particular, the wrist-wearable device 710 has a longitudinal distance d1 and a widthwise offset of distance d2 from the default position 700. Each neuromuscular-signal sensor 715 can be shifted by the same or distinct longitudinal and/or widthwise offsets. For example, each neuromuscular-signal sensor 715 can be shifted by longitudinal distance d1 and widthwise distance d2. Alternatively, the first neuromuscular-signal sensor 715-1 can be shifted by a first longitudinal distance and a first widthwise distance and a second neuromuscular-signal sensor 715-2 can be shifted by a second longitudinal distance and a second widthwise distance that are distinct from the first longitudinal distance and the first widthwise distance.

The wrist-wearable device 710 can, upon determining the presence of a wrist-wearable device 710 offset and/or a neuromuscular-signal sensor 715 offset (as discussed above in reference to FIGS. 2-6D), determines a worn position of the wrist-wearable device 710 and adjust analysis of neuromuscular signals sensed by the neuromuscular-signal sensors 715 based on a determined offset between the current worn position of the wrist-wearable device 710 and the default position 700 of the wrist-wearable device 710 (e.g., longitudinal and widthwise distances d1 and d2) and/or a determined offset between at least one neuromuscular-signal sensor 715 and its respective predetermined default position. In other words, the wrist-wearable device 710 can process the sensed neuromuscular signals to account for both the longitudinal and widthwise distances d1 and d2.

For example, as shown in FIG. 7D, the wrist-wearable device 710 provides the neuromuscular signals sensed by the neuromuscular-signal sensors 715 to the signal analysis module 150 which adjusts analysis of neuromuscular signals such that the sensed neuromuscular signals are transformed or simulated as if measured by a wrist-wearable device 710 worn in the default position 700. In particular, as shown in widthwise and longitudinal adjusted signal table 770, the first through fourth neuromuscular-signal sensors 715-1 through 715-4 sense neuromuscular signals at their current positions (e.g., respective longitudinal positions plus the distance d1 and respective widthwise positions plus the distance d2) and the signal analysis module 150 adjusts analysis of the neuromuscular signals such that they are simulated as sensed at the respective longitudinal and widthwise positions of the first through fourth neuromuscular-signal sensors 715-1 through 715-4. For example, the first neuromuscular-signal sensor 715-1 senses neuromuscular signals f1(x1+Δd1,y+Δd2) (e.g., neuromuscular signals sensed at longitudinal position x1 plus distance d1 and at a y widthwise position plus distance d2 of the wrist-wearable device 710) which are adjusted by the signal analysis module 150 to simulate neuromuscular signals f1(x1,y) (e.g., neuromuscular signals sensed at longitudinal position x1 and at a y widthwise position of the wrist-wearable device 710). The neuromuscular signals sensed by the neuromuscular-signal sensors 115 under the capsule portion 112 can also adjusted based on the longitudinal and widthwise distances d1 and d2 as described above. Although the above example adjusts neuromuscular signals sensed by the neuromuscular-signal sensors 715 based on longitudinal and widthwise distances d1 and d2, the skilled artisan will appreciate that the signal analysis module 150 can adjusts the neuromuscular signals for each neuromuscular-signal sensors 715 based on the respective longitudinal and widthwise offsets between its current position and its respective predetermined default position.

In some embodiments, in accordance with a determination that an offset is present, the wrist-wearable device 710 adjusts the neuromuscular signals sensed by the minimum number of neuromuscular-signal sensors 115/715 needed to satisfy the predetermined performance criteria as described above in reference to FIG. 3. Alternatively, in some embodiments, in accordance with a determination that an offset is present, the wrist-wearable device 710 adjusts the neuromuscular signals sensed by all of the neuromuscular-signal sensors 115/715. In some embodiments, in accordance with a determination that an offset is present, the wrist-wearable device 710 adjusts the neuromuscular signals sensed by neuromuscular-signal sensors 115/715 with respective predetermined default positions (e.g., neuromuscular-signal sensors 115/715 with respective predetermined default positions at or near the user 105's arteries or key muscle groups for sensing neuromuscular signals).

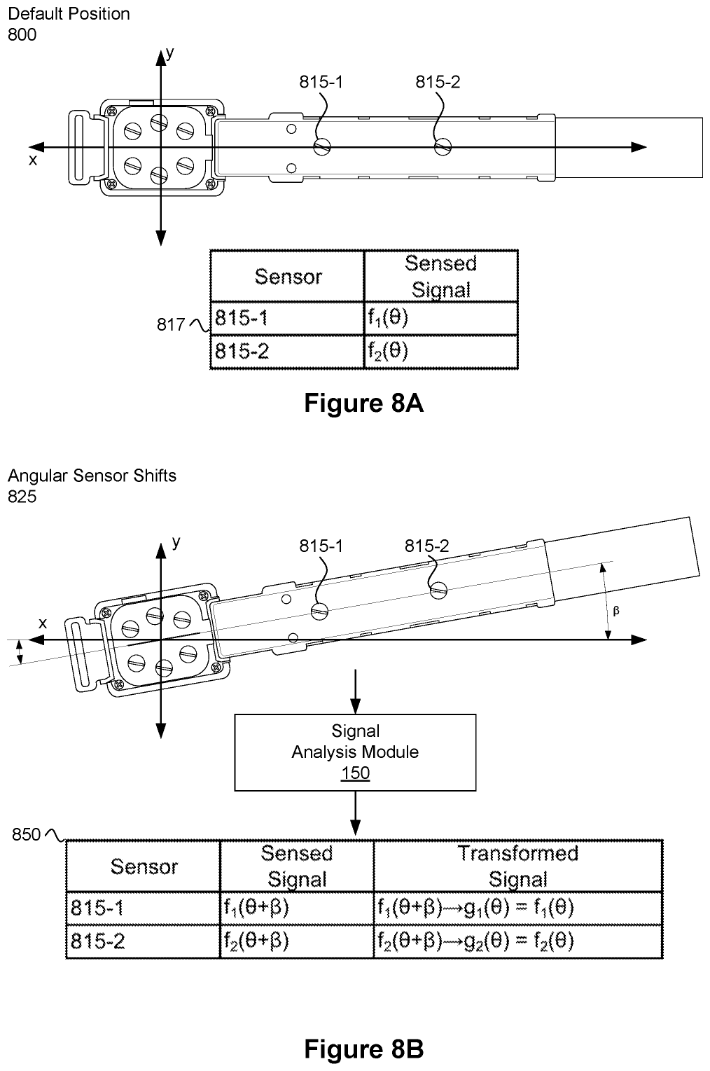

FIGS. 8A and 8B illustrate adjustments to neuromuscular signals sensed by neuromuscular-signal sensors with angular offsets, in accordance with some embodiments. In some embodiments, adjustments to neuromuscular signals sensed by neuromuscular-signal sensors 115 with angular offsets can be based on historical sensor data obtained over a predetermined period of time as described above in reference to FIG. 5. FIG. 8A shows illustrates a wrist-wearable device 810 worn in a default position 800 (analogous to the predetermined default position 100 and default positions 600 and 700). In particular, a capsule portion 112 of the wrist-wearable device 810 is on the dorsal surface of the user's hand 117 (e.g., FIGS. 1 and 6A), a first edge 113a of the wrist-wearable device 810 is worn adjacent to the user's hand 117, and a second edge 113b of the wrist-wearable device 810 is worn adjacent to the user's forearm 119. The wrist-wearable device 810 shows another configuration of the neuromuscular-signal sensors 815. In particular, a subset of the neuromuscular-signal sensors 815 are positioned at distinct center portions of the band of the wrist-wearable device 810.

FIG. 8A further includes a default position sensed signal table 817 illustrating each neuromuscular-signal sensor 815 and the respective neuromuscular signals sensed by the neuromuscular-signal sensor 815. For example, the first neuromuscular-signal sensor 815-1 senses first neuromuscular signals f1(θ) and the second neuromuscular-signal sensor 815-2 senses second neuromuscular signals f2(θ). Each θ value represents a respective angular position relative to centerline x of the wrist-wearable device 810.

Turning to FIG. 8B, the wrist-wearable device 810 is shown rotated from the default position 800 (e.g., angular sensor shifts 825). In particular, the wrist-wearable device 810 has an angular offset of β from the default position 800. Each neuromuscular-signal sensor 815 can be shifted by the same or distinct angular offsets. For example, each neuromuscular-signal sensor 815 can be shifted by angle β. Alternatively, a first neuromuscular-signal sensor 815-1 can be shifted by a first angle and a second neuromuscular-signal sensor 815-2 can be shifted by a second angle that is distinct from the first angle. One or more neuromuscular-signal sensors 815 can be shifted by different angles due to compression, elongation, and/or twists of different portions of the wearable structure of the wrist-wearable device 810.

The wrist-wearable device 810 can, upon determining the presence of a wrist-wearable device 810 offset and/or a neuromuscular-signal sensor 815 offset (as discussed above in reference to FIGS. 2-7D), determines a worn position of the wrist-wearable device 810 and adjust analysis of neuromuscular signals sensed by the neuromuscular-signal sensors 815 based on a determined offset between the current worn position of the wrist-wearable device 810 and the default position 800 of the wrist-wearable device 810 (e.g., angle β) and/or a determined offset between at least one neuromuscular-signal sensor 815 and its respective predetermined default position. In some embodiments, adjusting analysis of the neuromuscular signals sensed by the neuromuscular-signal sensors 815 based on the offset of the wrist-wearable device 810 and/or an offset between at least one neuromuscular-signal sensor 815 and its respective predetermined default position includes adjusting signal values of neuromuscular signals sensed by at least one neuromuscular-signal sensor 815. In other words, the wrist-wearable device 810 can process the sensed neuromuscular signals to account for the angular offset 1.

For example, as shown in FIG. 8B, the wrist-wearable device 810 provides the neuromuscular signals sensed by the neuromuscular-signal sensors 815 to the signal analysis module 150 which adjusts analysis of neuromuscular signals such that the sensed neuromuscular signals are transformed or simulated as if measured by a wrist-wearable device 810 worn in the default position 800. In particular, as shown in angular adjusted signal table 850, the first and second neuromuscular-signal sensors 815-1 and 815-2 sense neuromuscular signals at their respective positions shifted by angle β and the signal analysis module 150 adjusts analysis of the neuromuscular signals such that they are simulated as sensed at the respective position (e.g., at angle θ without the angular shift β) of the first and second neuromuscular-signal sensors 815-1 and 815-2. For example, the first neuromuscular-signal sensor 815-1 senses neuromuscular signals f1(θ+β) which are adjusted by the signal analysis module 150 to simulate neuromuscular signals f1(θ).

Although not shown, the neuromuscular signals sensed by the neuromuscular-signal sensors 115 under the capsule portion 112 can also adjusted based on the angular shift as described above. Although the above example adjusts neuromuscular signals sensed by the neuromuscular-signal sensors 815 based on an angular shift β, the skilled artisan will appreciate that the signal analysis module 150 can adjusts the neuromuscular signals for each neuromuscular-signal sensors 815 based on the respective angular offset between its current position and its respective predetermined default position.

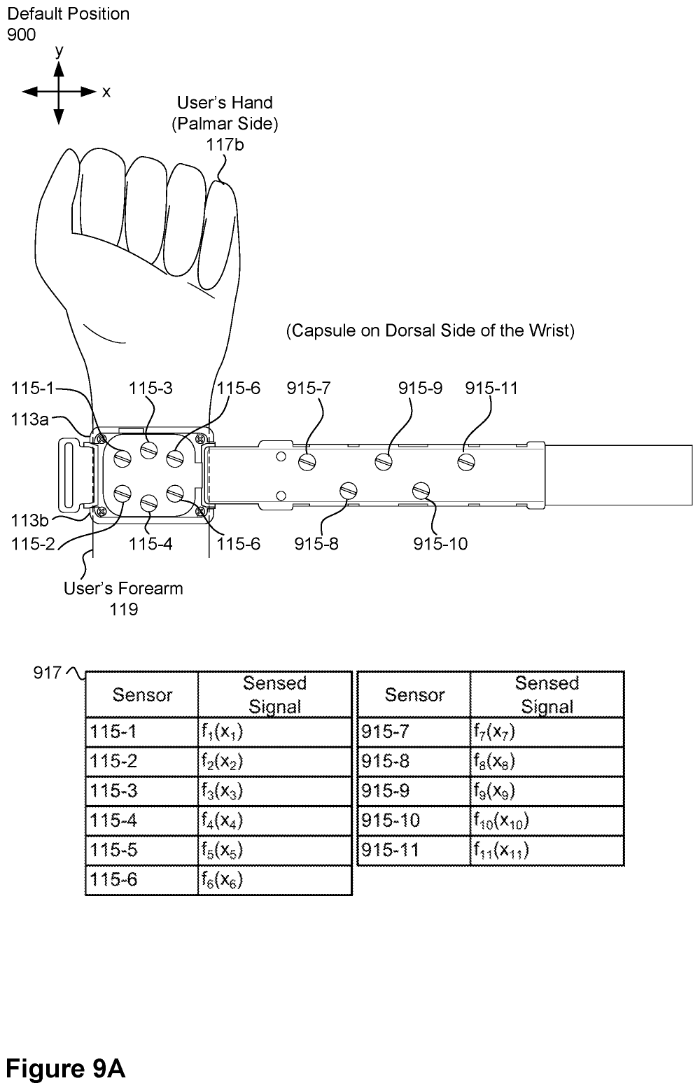

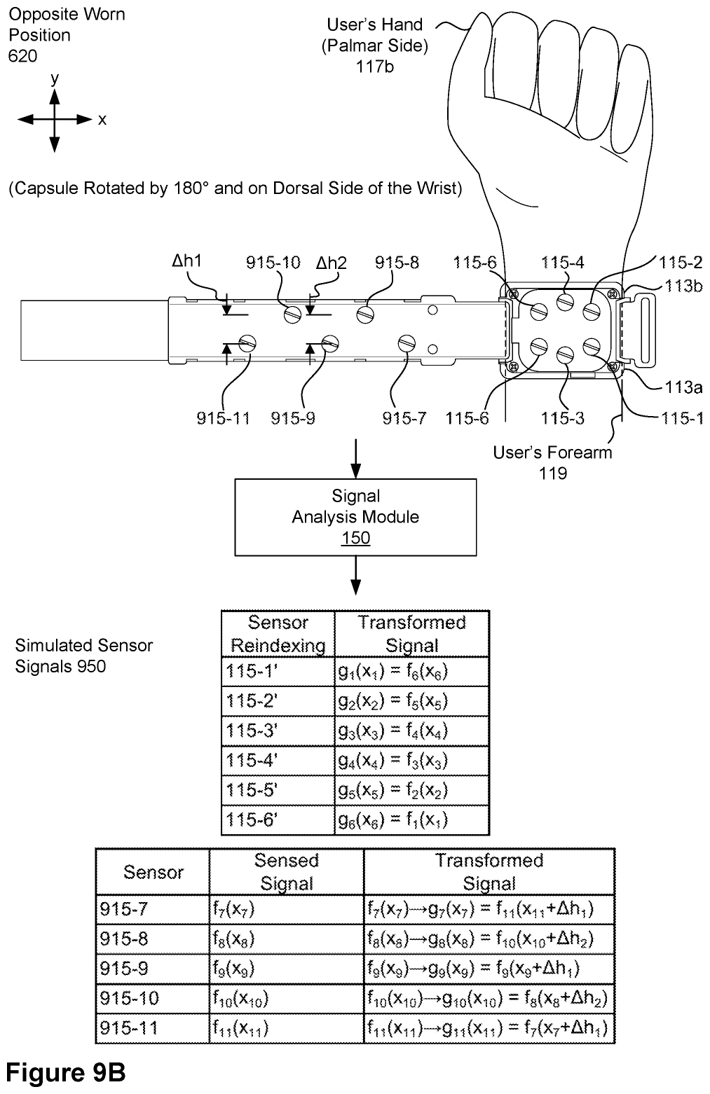

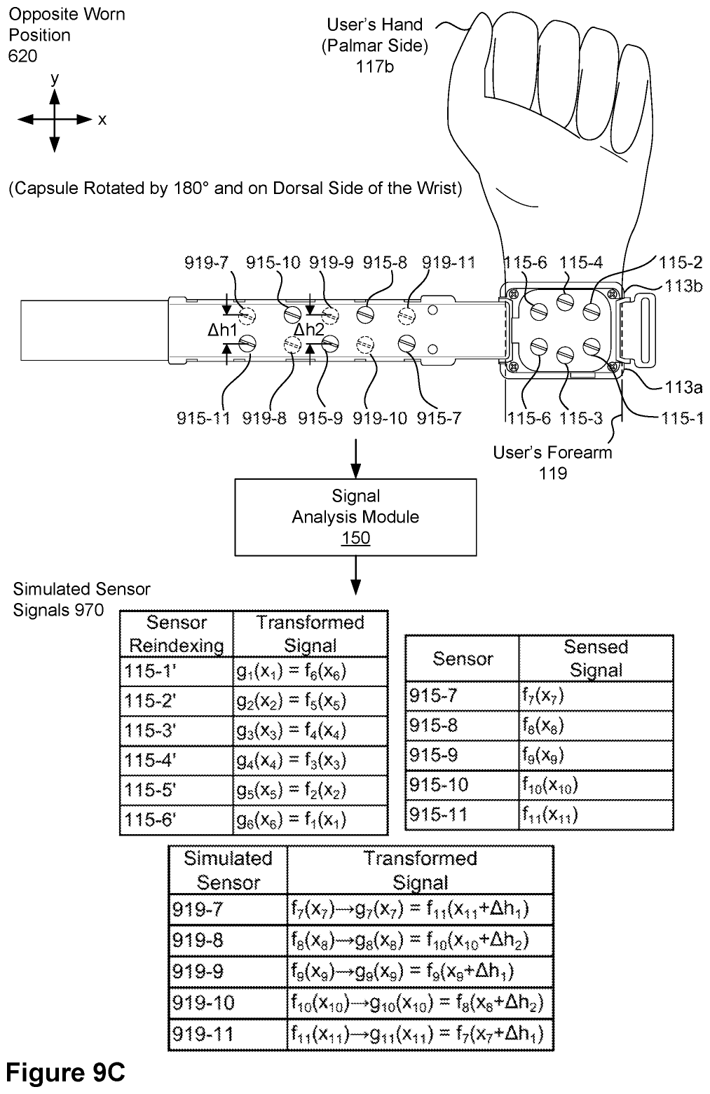

FIGS. 9A-9C illustrate the wrist-wearable device simulating one or more neuromuscular-signal sensors based different user worn positions, in accordance with some embodiments. The wrist-wearable device 910 shows an alternate neuromuscular-signal sensor 915 configuration, such as a non-symmetrical neuromuscular-signal sensor 915 configuration. Further, the wrist-wearable device 910 is shown worn in a default position 900 (analogous to the predetermined default position 100 and default positions 600, 700, and 800). In particular, the user's hand 117 is shown palm side up (e.g., the palmar side of the user's hand 117b is shown), a capsule portion 112 of the wrist-wearable device 910 is on the dorsal surface of the user's hand 117 (e.g., surface opposite the palmar side of the user's hand 117b), a first edge 113a of the wrist-wearable device 910 is worn adjacent to the user's hand 117, and a second edge 113b of the wrist-wearable device 910 is worn adjacent to the user's forearm 119. Similar to FIGS. 1 and 6A, odd numbered neuromuscular-signal sensors 915-1, 915-3, 915-5, 915-7, 915-9, and 915-11 have respective predetermined default positions adjacent to the user's hand 117 and even numbered neuromuscular-signal sensors 915-2, 915-4, 915-6, 915-8, and 915-10 have respective predetermined default positions adjacent to the user's forearm 119.

FIG. 9A further includes sensed signal table 917 illustrating each neuromuscular-signal sensor 915 and the respective neuromuscular signals sensed by the neuromuscular-signal sensor 915. For example, the first neuromuscular-signal sensor 915-1 senses first neuromuscular signals f1(x1), the second neuromuscular-signal sensor 915-2 senses second neuromuscular signals f2(x2), the third neuromuscular-signal sensor 915-2 senses third neuromuscular signals f3(x3), etc.

In FIG. 9B, the wrist-wearable device 910 is shown worn in an opposite orientation to the default position 900. In particular, the opposite worn position 920 (similar to the worn position described above in reference to FIGS. 2 and 6B) shows the palmar side of the user's hand 117b, the first edge 113a of the wrist-wearable device 910 worn adjacent to the user's forearm 119 instead of adjacent to the user's hand 117, the second edge 113b worn adjacent to the user's hand 117 instead of adjacent to the user' forearm 119, and the capsule portion 112 of the wrist-wearable device 910 positioned on the dorsal surface of the user's hand 117. Further, even numbered neuromuscular-signal sensors 915-2 through 915-14, are adjacent to the user's hand 117 and odd numbered neuromuscular-signal sensors 915-1 through 915-13 are adjacent to the user's forearm 119 (which are opposite to the default position 600).

As described above in reference to FIGS. 2 and 6B, the wrist-wearable device 910 can, upon determining a wrist-wearable device 910 offset and/or at least one neuromuscular-signal sensors 915 offset, adjust analysis of neuromuscular signals sensed by the neuromuscular-signal sensors 915 based on an offset between the worn position of the wrist-wearable device 910 (e.g., the opposite worn position 920) and the default position 600 of the wrist-wearable device 910 and/or based on an offset between the position of a neuromuscular-signal sensors 915 and its respective predetermined default position. Adjusting analysis of the neuromuscular signals sensed by the neuromuscular-signal sensors 915 can include swapping or reindexing the neuromuscular-signal sensors and/or simulate neuromuscular signals as discussed above in reference to FIGS. 2A-8B. In some embodiments, the wrist-wearable device 910 adjust analysis of neuromuscular signals such that the sensed neuromuscular signals closely align with expected neuromuscular signal values even if not exact (as long as the predetermined performance criteria is satisfied).

For example, as shown in FIG. 9B, the wrist-wearable device 910 provides the neuromuscular signals sensed by the neuromuscular-signal sensors 915 to the signal analysis module 150 which adjusts analysis of neuromuscular signals such that the sensed neuromuscular signals are transformed or simulated as if measured by a wrist-wearable device 910 worn in the default position 900. In particular, as shown in simulated sensor signals table 950, the even numbered neuromuscular-signal sensors 915-8 and 915-10 sense neuromuscular signals at their respective widthwise position (e.g., on opposite sides and adjacent to the user's hand 117 (offset by their respective predetermined default position by a distance of h2)) and the signal analysis module 150 adjusts analysis of the neuromuscular signals such that they are reindexed and simulated as sensed at their respective widthwise position. In other words, the neuromuscular signals are signal corrected such that they simulate expected neuromuscular signals. For example, the tenth neuromuscular-signal sensor 915-10 senses neuromuscular signals f10(x10) which are adjusted by the signal analysis module 150 to simulate neuromuscular signals f8(x8+Δh2). Similarly, odd numbered neuromuscular-signal sensors 915-7, 915-9, and 915-11 sense neuromuscular signals at their respective widthwise position (e.g., adjacent to the user's forearm 119, which is offset by their respective default position by a distance of h1) and the signal analysis module 150 adjusts analysis of the neuromuscular signals such that they are reindexed and simulated as sensed at their respective widthwise position (e.g., the seventh neuromuscular-signal sensor 915-7 senses neuromuscular signals f7(x7) which are adjusted by the signal analysis module 150 to simulate neuromuscular signals f11(x11+Δh1)). The neuromuscular signals sensed by the neuromuscular-signal sensors 115 under the capsule portion 112 would be adjusted as described above in reference to FIG. 6B.

Turning to FIG. 9C, the wrist-wearable device 910 is also shown worn in an opposite orientation to the default position 900. FIG. 9C illustrates neuromuscular-signal sensors simulation, which is a variation of the reindexing and signal correction described above in FIG. 9B. In some embodiments, the wrist-wearable device 910 adjust analysis of neuromuscular signals in order to generate virtual or simulated neuromuscular-signal sensors 919, which provide simulated neuromuscular signals that closely align with expected neuromuscular signal values even if not exact (as long as the predetermined performance criteria is satisfied).

For example, as shown in FIG. 9C, the wrist-wearable device 910 provides the neuromuscular signals sensed by the neuromuscular-signal sensors 915 to the signal analysis module 150 which adjusts analysis of neuromuscular signals in order to generate simulated neuromuscular-signal sensors 919. The simulated neuromuscular-signal sensors 919 provide simulated neuromuscular signals that attempt to replicate expected neuromuscular signals of neuromuscular-signal sensors 915 in their respective predetermined default positions. For example, as shown in simulated sensor table 970, simulated sensors 919-7 through 919-11 are generated based on neuromuscular signals received from neuromuscular-signal sensors 915-7 through 915-11 and the simulated neuromuscular signals are reindexed as if the wrist-wearable device 910 were in the default position 900. The neuromuscular signals sensed by the neuromuscular-signal sensors 115 under the capsule portion 112 would be adjusted as described above in reference to FIG. 6B.

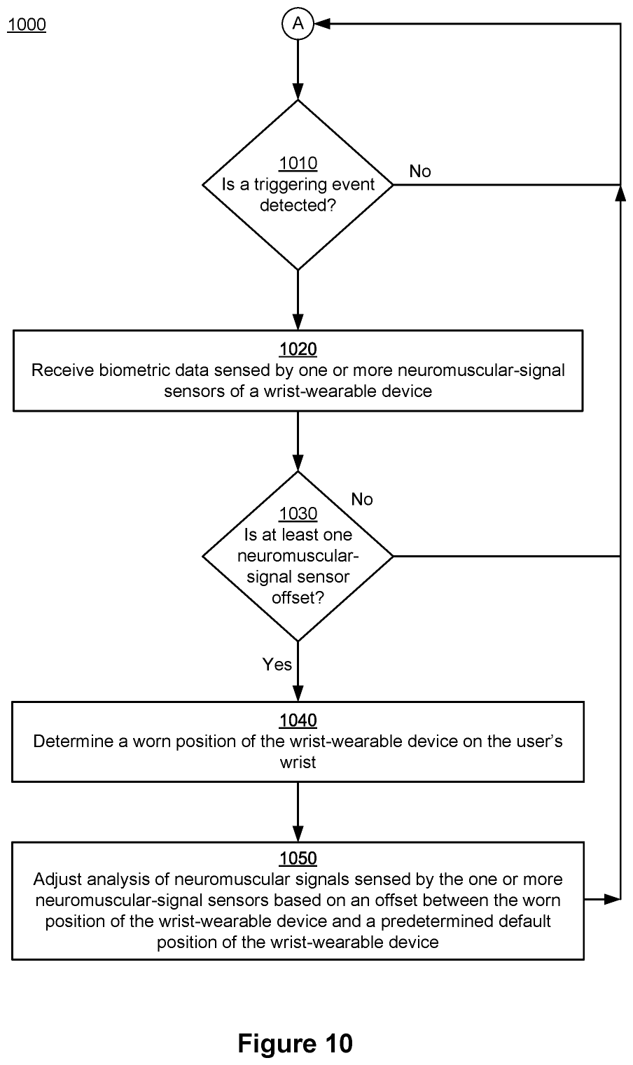

FIG. 10 illustrates a flow diagram of a method for calibrating neuromuscular signals sensed by a plurality of neuromuscular-signal sensors, in accordance with some embodiments. Operations (e.g., steps) of the method 1000 can be performed by one or more processors (e.g., CPU 1379 (e.g., or processor as shown in FIG. 13B) and/or MCU) of a wrist-wearable device 110. In some embodiments, the wrist-wearable device 110 is coupled with one or more sensors (e.g., various sensors discussed in reference to FIGS. 13A and 14B, such as a heart rate sensor, IMU, an EMG sensor, SpO2 sensor, altimeter, thermal sensor or thermal couple, ambient light sensor, ambient noise sensor), a display, a speaker, an imaging sensor 1336 (FIGS. 13A and 13B), and a microphone to perform the one or more operations. At least some of the operations shown in FIG. 10 correspond to instructions stored in a computer memory or computer-readable storage medium (e.g., memory 1380 (FIG. 13B), such as storage and/or RAM). Operations of the method 1000 can be performed by the wrist-wearable device 110 alone or in conjunction with one or more processors and/or hardware components of another device communicatively coupled to the wrist-wearable device 110 (e.g., a smartphone, head-wearable device, a laptop, a tablet, etc.) and/or instructions stored in memory or computer-readable medium of the other device communicatively coupled to the wrist-wearable device 110.

The method 1000 includes determining (1010) whether a triggering event is detected. A triggering event, as described above in reference to FIG. 2, can movement of s a portion of the wrist-wearable device 110 and/or any other condition that can cause neuromuscular signals sensed by the neuromuscular-signal sensors 115 to be inconsistent with expected results. If a triggering event is not detected (“No” at operation 1010), the method 1000 continues to monitor any changes with the wrist-wearable device 110. Alternatively, if a triggering is detected (“Yes” at operation 1010), the method 1000 includes receiving (1020) biometric data sensed by one or more neuromuscular-signal sensors 115 of the wrist-wearable device. As described above in reference to FIG. 2, biometric data can include a heart rate, a pulse rate, etc.

The method 1000 further includes determining (1030) whether at least one neuromuscular-signal sensor 115 of the wrist-wearable device 110 is offset. In accordance with a determination that at least one neuromuscular-signal sensor 115 of the wrist-wearable device 110 is not offset (“No” at operation 1030), the method 1000 returns to operation 1010 and continues to monitor any changes with the wrist-wearable device 110. Alternatively, in accordance with a determination that at least one neuromuscular-signal sensor 115 of the wrist-wearable device 110 is offset (“Yes” at operation 1030), the method 1000 includes determining (1040) a worn position of the wrist-wearable device on the user's wrist, and adjusting (1050) analysis of neuromuscular signals sensed by the one or more neuromuscular-signal sensors based on an offset between the worn position of the wrist-wearable device and a predetermined default position of the wrist-wearable device. Different examples of the adjustments to the analysis of the sensed neuromuscular signals are provided above in reference to FIGS. 2-10.

After adjusting analysis of neuromuscular signals, the method 1000 returns to operation 1010 and continues to monitor any changes with the wrist-wearable device 110.

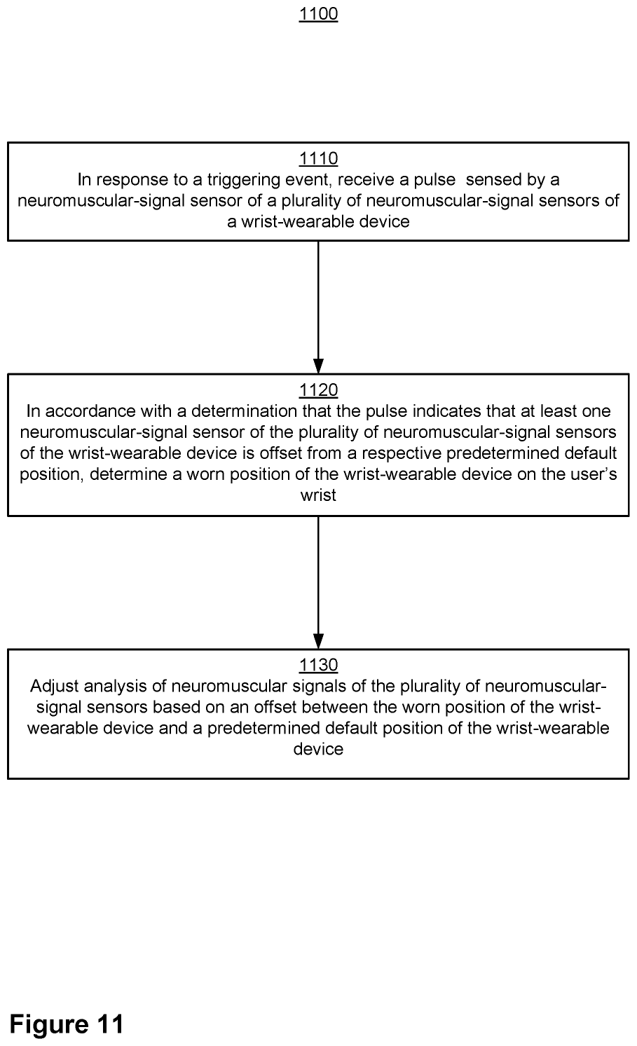

FIG. 11 illustrates a detailed flow diagram of a method for calibrating neuromuscular signals sensed by a plurality of neuromuscular-signal sensors, in accordance with some embodiments. Similar to method 1000 of FIG. 10, operations of the method 1100 can be performed by one or more processors of a wrist-wearable device 110. At least some of the operations shown in FIG. 11 correspond to instructions stored in a computer memory or computer-readable storage medium. Operations of the method 1100 can be performed by the wrist-wearable device 110 alone or in conjunction with one or more processors and/or hardware components of another device (e.g., a smartphone, head-wearable device, and/or an intermediary device) communicatively coupled to the wrist-wearable device 110 and/or instructions stored in memory or computer-readable medium of the other device communicatively coupled to the wrist-wearable device 110.

Method 1100 includes, in response to a triggering event, receiving (1110) a pulse sensed by a neuromuscular-signal sensor of a plurality of neuromuscular-signal sensors of a wrist-wearable device. A triggering event can be movement of the wrist-wearable device 110; initial placement of the wrist-wearable device 110 on the user's skin, and/or other examples provided above in reference to FIG. 2. The method 1100 includes, in accordance with a determination that the pulse indicates that at least one neuromuscular-signal sensor of the plurality of neuromuscular-signal sensors of the wrist-wearable device is offset from a respective predetermined default position, determining (1120) a worn position of the wrist-wearable device on the user's wrist. In some embodiments, the respective predetermined default position is associated with a predetermined pulse strength threshold, and the determination that the pulse indicates that the at least one neuromuscular-signal sensor of the plurality of neuromuscular-signal sensors of the wrist-wearable device is offset from the respective predetermined default position is based on a pulse strength of the at least one neuromuscular-signal sensor being below the predetermined pulse strength threshold. Different examples for determining that at least one neuromuscular-signal sensors 115 is offset from its respective predetermined default position are provided above in reference to FIG. 2.

In some embodiments, determining the worn position of the wrist-wearable device on the user's wrist includes determining, based on a comparison of respective pulse strengths of pulses sensed by neuromuscular-signal sensors of the plurality of neuromuscular-signal sensors, a neuromuscular-signal sensor with a highest pulse strength; and determining a respective offset between the neuromuscular-signal sensor with the highest pulse strength and its respective predetermined default position. In some embodiments, the neuromuscular-signal sensor with the highest pulse strength is predicted to be at or near the user's artery. In other words, as described above in reference to at least FIG. 2, in some embodiments, one or more neuromuscular-signal sensors 115 of the wrist-wearable device 110 can be mapped to a particular location on the user's wrist and each location can be associated with a respective pulse strength that can be used as reference points determining the wrist-wearable device 110's current position and/or each neuromuscular-signal sensors 115 current position.

Method 1100 further includes adjusting (1130) analysis of neuromuscular signals of the plurality of neuromuscular-signal sensors based on an offset between the worn position of the wrist-wearable device and a predetermined default position of the wrist-wearable device. In some embodiments, the plurality of neuromuscular-signal sensors includes a first neuromuscular-signal sensor and a second neuromuscular-signal sensor; and adjusting the analysis of the neuromuscular signals of the plurality of neuromuscular-signal sensors based on the offset between the worn position of the wrist-wearable device and the predetermined default position includes analyzing neuromuscular signals sensed by the second neuromuscular-signal sensor in place of the neuromuscular signals sensed by the first neuromuscular-signal sensor and analyzing neuromuscular signals sensed by the first neuromuscular-signal sensor in place of the neuromuscular signals sensed by the second neuromuscular-signal sensor. More specifically, neuromuscular signals sensed by neuromuscular-signal sensors 115 can be reindexed or swapped as discussed above in reference to at least FIGS. 2, 3, and 6A-6D.

In some embodiments, the first neuromuscular-signal sensor is at a first widthwise portion of the wrist-wearable device and the second neuromuscular-signal sensor is at a second widthwise portion of the wrist-wearable device. In some embodiments, the first neuromuscular-signal sensor is at a first longitudinal portion of the wrist-wearable device and the second neuromuscular-signal sensor is at a second longitudinal portion of the wrist-wearable device. Different examples of longitudinal and widthwise swaps are described above in reference to FIGS. 3 and 6A-6D.

In some embodiments, the plurality of neuromuscular-signal sensors includes a first neuromuscular-signal sensor at a first portion of the wrist-wearable device; and adjusting the analysis of the neuromuscular signals of the plurality of neuromuscular-signal sensors based on the offset between the worn position of the wrist-wearable device and the predetermined default position includes analyzing neuromuscular signals sensed by the first neuromuscular-signal sensor such that the neuromuscular signals sensed by the first neuromuscular-signal sensor are simulated at a second portion of the wrist-wearable device determined by the distance between the first portion of the wrist-wearable device and the offset between the worn position of the wrist-wearable device and the predetermined default position. In some embodiments, the first portion of the wrist-wearable device is a first widthwise portion of the wrist-wearable device and the second portion of the wrist-wearable device is a second widthwise portion of the wrist-wearable device. In some embodiments, the first portion of the wrist-wearable device is a first longitudinal portion of the wrist-wearable device and the second portion of the wrist-wearable device is a second longitudinal portion of the wrist-wearable device. In some embodiments, the offset from the respective predetermined default position is a distance offset with the at least one neuromuscular-signal sensor of the plurality of neuromuscular-signal sensors of the wrist-wearable device offset from the respective predetermined default position by a first distance; and adjusting the signal values of neuromuscular signals sensed by the at least one neuromuscular-signal sensor of the plurality of neuromuscular-signal sensors of the wrist-wearable device includes adjusting the signal values based on the first distance. In other words, in some embodiments, the wrist-wearable device 110 can adjust or correct neuromuscular signals sensed one or more neuromuscular-signal sensors 115 based on an offset caused by movement of shifts in the wrist-wearable device 110's position as shown and described above in reference to FIGS. 4 and 7A-7D.

In some embodiments, adjusting analysis of the neuromuscular signals of the plurality of neuromuscular-signal sensors includes adjusting signal values of neuromuscular signals sensed by at least one neuromuscular-signal sensor of the plurality of neuromuscular-signal sensors of the wrist-wearable device. In some embodiments, the offset from the respective predetermined default position is a rotational (or angular) offset with the at least one neuromuscular-signal sensor of the plurality of neuromuscular-signal sensors of the wrist-wearable device offset from the respective predetermined default position by a first angle; and adjusting the signal values of neuromuscular signals sensed by the at least one neuromuscular-signal sensor of the plurality of neuromuscular-signal sensors of the wrist-wearable device includes adjusting the signal values based on the first angle. More specifically, in some embodiments, the wrist-wearable device 110 can adjust or correct neuromuscular signals sensed one or more neuromuscular-signal sensors 115 based on an angular offset caused by movement of shifts in the wrist-wearable device 110's position as shown and described above in reference to FIGS. 5, 8A, and 8B.

In some embodiments, adjusting analysis of the neuromuscular signals of the plurality of neuromuscular-signal sensors includes adjusting signal values of neuromuscular signals sensed by an additional neuromuscular-signal sensor of the plurality of neuromuscular-signal sensors of the wrist-wearable device. In some embodiments, the offset from the respective predetermined default position is a distance offset with the additional neuromuscular-signal sensor of the plurality of neuromuscular-signal sensors of the wrist-wearable device offset from the respective predetermined default position by a second distance; and adjusting the signal values of neuromuscular signals sensed by the additional neuromuscular-signal sensor of the plurality of neuromuscular-signal sensors of the wrist-wearable device includes adjusting the signal values based on the second distance. In some embodiments, the offset from the respective predetermined default position is a rotational offset with the additional neuromuscular-signal sensor of the plurality of neuromuscular-signal sensors of the wrist-wearable device offset from the respective predetermined default position by a second angle; and adjusting the signal values of neuromuscular signals sensed by the additional neuromuscular-signal sensor of the plurality of neuromuscular-signal sensors of the wrist-wearable device includes adjusting the signal values based on the second angle. In other words, the wrist-wearable device 110 can adjust or correct the sensed neuromuscular signals for a single neuromuscular-signal sensor 115 or more than one neuromuscular-signal sensor 115 at a time.

In some embodiments, the method 1100 further includes determining a hand gesture performed by the user based on the adjusted analyzed neuromuscular signals of the plurality of neuromuscular-signal sensors; and causing performance of an action at the wrist-wearable device based on the hand gesture.

In some embodiments, adjusting analysis of the neuromuscular signals of the plurality of neuromuscular-signal sensors based on the offset between the worn position of the wrist-wearable device and the predetermined default position of the wrist-wearable device, includes determining whether the adjusted analysis of the neuromuscular signals satisfies predetermined performance criteria. In some embodiments, the predetermined performance criteria include one or more of (i) a determined true positive rate at or above a predetermined true positive rate, (ii) a determined true negative rate at or above a predetermined true negative rate, (iii) a detected number of errors at or below a predetermined number of detected errors, (iv) the offset between the worn position of the wrist-wearable device and the predetermined default position of the wrist-wearable device is at or below a predetermined wrist-wearable device offset, and (v) the offset between the at least one neuromuscular-signal sensor of the plurality of neuromuscular-signal sensors and its respective predetermined default position is at or below a predetermined neuromuscular-signal sensor offset. Additional examples of the predetermined performance criteria are provided above in reference to FIG. 3.

In some embodiments, the method 1100 further includes, in accordance with a determination that the adjusted analysis of the neuromuscular signals does not satisfy the predetermined performance criteria, causing the wrist-wearable device to present feedback to the user. In some embodiments, the method 1100 includes, in conjunction with causing the wrist-wearable device to present feedback to the user, forgoing determining a hand gesture performed by the user based on the adjusted analysis of the neuromuscular signals of the plurality of neuromuscular-signal sensors. In some embodiments, the feedback includes one or more of a visual indicator, an audible indicator, and a haptic indicator. In some embodiments, the feedback includes instructions for performing user corrective actions that cause the predetermined performance criteria to be satisfied. In some embodiments, the user corrective actions described in the instructions include removal and reattachment of the wrist-wearable device, manual adjustment of the wrist-wearable device, clean the neuromuscular-signal sensor, and service the wrist-wearable device. Examples of the feedback presented by the wrist-wearable device 110 are provided above in reference to FIG. 3.

In some embodiments, the method 1100 includes, in response to a determination that a user corrective action (e.g., a user repositioning or adjusting the wrist-wearable device 110 or other examples provided above in reference to FIG. 3) was performed, analyzing additional neuromuscular signals of the plurality of neuromuscular-signal sensors; and determining whether the analysis of the additional neuromuscular signals satisfies the predetermined performance criteria. In some embodiments, the method 1100 includes in accordance with a determination that the analysis of the additional neuromuscular signals does not satisfy the predetermined performance criteria, presenting additional feedback to the user. For example, if the user attempts to correct a position of the wrist-wearable device 110 such that it is in its predetermined default position but, after an adjustment, the wrist-wearable device 110 is still not in the predetermined default position (or other predetermined performance criteria are not satisfied), the wrist-wearable device 110 provides additional feedback for improving the performance of the wrist-wearable device 110. The additional feedback is provided to ensure that the user wears the wrist-wearable device 110 correctly such that the user does not continue to see errors.

Alternatively, in some embodiments, the method 1100 includes, in response to a user corrective action (e.g., a repositioning event), receiving an additional pulse sensed by the neuromuscular-signal sensor of the plurality of neuromuscular-signal sensors of the wrist-wearable device; in accordance with a determination that the additional pulse indicates that at least one neuromuscular-signal sensor of the plurality of neuromuscular-signal sensors of the wrist-wearable device is offset from a respective predetermined default position, determining a new worn position of the wrist-wearable device on the user's wrist; and adjusting analysis of additional neuromuscular signals of the plurality of neuromuscular-signal sensors based on an offset between the new worn position of the wrist-wearable device and the predetermined default position of the wrist-wearable device. In other words, in some embodiments, the wrist-wearable device 110 will forgo providing additional feedback (e.g., in the case where the user opts not to perform an additional corrective action), and will attempt to recalibrate the neuromuscular-signal sensors 115 as described above.

In some embodiments, the method 1100 includes, in accordance with a determination that the analysis of the additional neuromuscular signals does satisfy the predetermined performance criteria, determining a hand gesture performed by the user based on the analyzed additional neuromuscular signals of the plurality of neuromuscular-signal sensors; and causing performance of an action at the wrist-wearable device based on the hand gesture.

In some embodiments, the method 1100 includes, in accordance with a determination that the pulse indicates that the neuromuscular-signal sensor of the plurality of neuromuscular-signal sensors of the wrist-wearable device is not offset from the respective predetermined default position, forgoing determining a worn position of the wrist-wearable device on the user's wrist; and forgoing adjusting analysis of neuromuscular signals of the plurality of neuromuscular-signal sensors.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU), microcontroller unit (MCU), etc.), is an electronic component that is responsible for executing instructions and controlling the operation of an electronic device (e.g., a wrist-wearable device 1300, a head-wearable device, a handheld intermediary processing device 1500, or other computer system). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing, and/or can be customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) which may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include: (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware, and/or boot loaders); (iii) flash memory, magnetic disk storage devices, optical disk storage devices, other non-volatile solid state storage devices, which can be configured to store data in electronic devices (e.g., USB drives, memory cards, and/or solid-state drives (SSDs); and (iv) cache memory configured to temporarily store frequently accessed data and instructions. Memory, as described herein, can include structured data (e.g., SQL databases, MongoDB databases, GraphQL data, JSON data, etc.). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including: (i) a power source, which can be an alternating current (AC) adapter or a direct current (DC) adapter power supply; (ii) a charger input, and can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and to ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals, and can provide a means for input and output of data and signals. Examples of peripheral interfaces can include: (i) universal serial bus (USB) and/or micro-USB interfaces configured for connecting devices to an electronic device; (ii) bluetooth interfaces configured to allow devices to communicate with each other, including bluetooth low energy (BLE); (iii) near field communication (NFC) interfaces configured to be short-range wireless interface for operations such as access control; (iv) POGO pins, which may be small, spring-loaded pins configured to provide a charging interface; (v) wireless charging interfaces; (vi) GPS interfaces; (vii) WiFi interfaces for providing a connection between a device and a wireless network; (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can includer: (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) light sensors (e.g., time-of-flight sensors, infrared light sensors, visible light sensors, etc.), and/or sensor for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and to diagnose neuromuscular disorders; (iv) electrooculography (EOG) sensors configure to measure the electrical activity of eye muscles to detect eye movement and diagnose eye disorders.

As described herein, an application stored in memory of an electronic device (e.g., software) includes instructions stored in the memory. Examples of such applications include: (i) games; (ii) word processors; (iii) messaging applications; (iv) media-streaming applications; (v) financial applications; (vi) calendars; (vii) clocks; (viii) web-browsers; (ix) social media applications, (x) camera applications, (xi) web-based applications; (xii) health applications; (xiii) artificial reality applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified.

### Example AR System

FIG. 12 illustrates example AR systems, in accordance with some embodiments. FIG. 12 shows an AR system 1200 and example user interactions using a wrist-wearable device 1300, a head-wearable device (e.g., AR device 1400), and/or a handheld intermediary processing device (HIPD) 1500. As the skilled artisan will appreciate upon reading the descriptions provided herein, the above-example AR systems (described in detail below) can perform various functions and/or operations described above with reference to FIGS. 1-11.

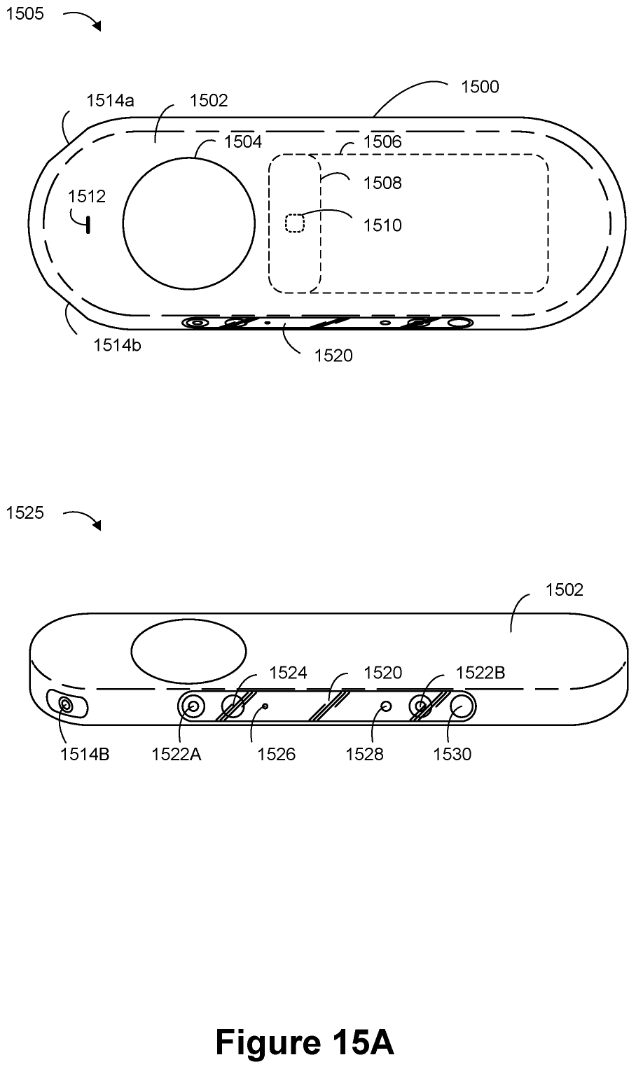

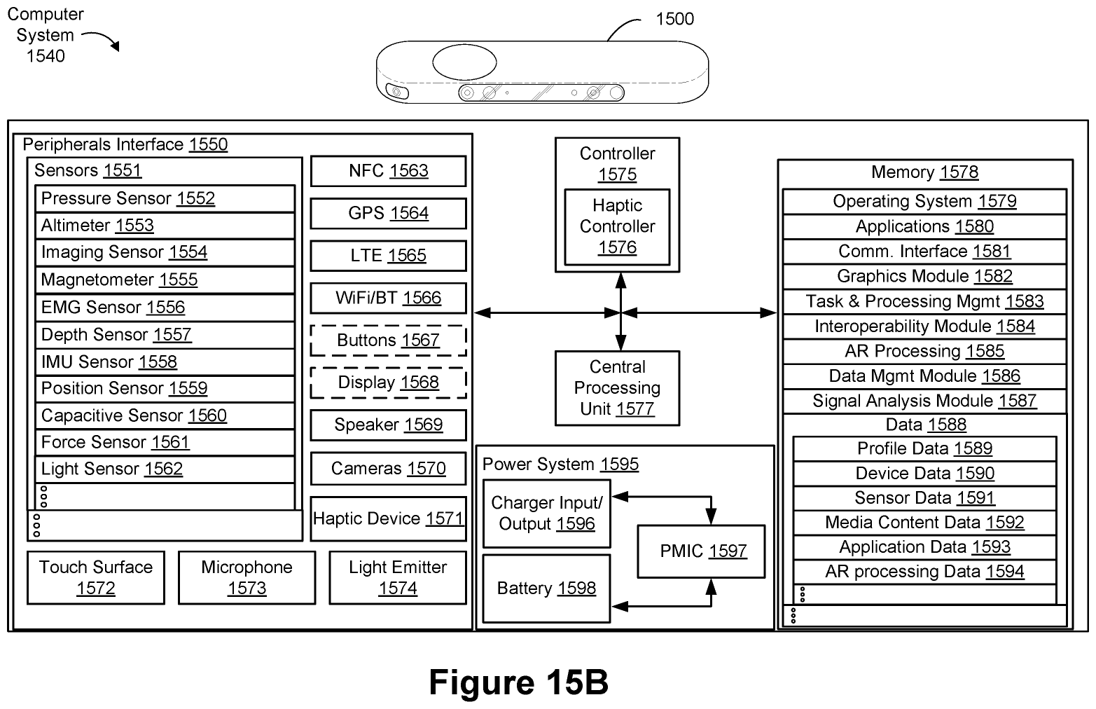

The wrist-wearable device 1300 and its constituent components are described below in reference to FIGS. 13A-13B, the head-wearable devices and their constituent components are described below in reference to FIGS. 14A-14D, and the HIPD 1500 and its constituent components are described below in reference to FIGS. 15A-15B. The wrist-wearable device 1300, the head-wearable devices, and/or the HIPD 1500 can communicatively couple via a network 1225 (e.g., cellular, near field, Wi-Fi, personal area network, or wireless LAN). Additionally, the wrist-wearable device 1300, the head-wearable devices, and/or the HIPD 1500 can also communicatively couple with one or more servers 1230, computers 1240 (e.g., laptops or computers), mobile devices 1250 (e.g., smartphones or tablets), and/or other electronic devices via the network 1225 (e.g., cellular, near field, Wi-Fi, personal area network, or wireless LAN).

Turning to FIG. 12A, a user 1202 is shown wearing the wrist-wearable device 1300 and the AR device 1400, and having the HIPD 1500 on their desk. The wrist-wearable device 1300, the AR device 1400, and the HIPD 1500 facilitate user interaction with an AR environment. In particular, as shown by the first AR system 1200a, the wrist-wearable device 1300, the AR device 1400, and/or the HIPD 1500 cause presentation of one or more avatars 1204, digital representations of contacts 1206, and virtual objects 1208. As discussed below, the user 1202 can interact with the one or more avatars 1204, digital representations of the contacts 1206, and virtual objects 1208 via the wrist-wearable device 1300, the AR device 1400, and/or the HIPD 1500.

The user 1202 can use any of the wrist-wearable device 1300, the AR device 1400, and/or the HIPD 1500 to provide user inputs. For example, the user 1202 can perform one or more hand gestures that are detected by the wrist-wearable device 1300 (e.g., using one or more EMG sensors and/or IMUs, described below in reference to FIGS. 13A-13B) and/or AR device 1400 (e.g., using one or more image sensors or cameras, described below in reference to FIGS. 14A-14B) to provide a user input. Alternatively, or additionally, the user 1202 can provide a user input via one or more touch surfaces of the wrist-wearable device 1300, the AR device 1400, and/or the HIPD 1500, and/or voice commands captured by a microphone of the wrist-wearable device 1300, the AR device 1400, and/or the HIPD 1500. In some embodiments, the wrist-wearable device 1300, the AR device 1400, and/or the HIPD 1500 include a digital assistant to help the user in providing a user input (e.g., completing a sequence of operations, suggesting different operations or commands, providing reminders, or confirming a command). In some embodiments, the user 1202 can provide a user input via one or more facial gestures and/or facial expressions. For example, cameras of the wrist-wearable device 1300, the AR device 1400, and/or the HIPD 1500 can track the user 1202's eyes for navigating a user interface.

The wrist-wearable device 1300, the AR device 1400, and/or the HIPD 1500 can operate alone or in conjunction to allow the user 1202 to interact with the AR environment. In some embodiments, the HIPD 1500 is configured to operate as a central hub or control center for the wrist-wearable device 1300, the AR device 1400, and/or another communicatively coupled device. For example, the user 1202 can provide an input to interact with the AR environment at any of the wrist-wearable device 1300, the AR device 1400, and/or the HIPD 1500, and the HIPD 1500 can identify one or more back-end and front-end tasks to cause the performance of the requested interaction and distribute instructions to cause the performance of the one or more back-end and front-end tasks at the wrist-wearable device 1300, the AR device 1400, and/or the HIPD 1500. In some embodiments, a back-end task is a background-processing task that is not perceptible by the user (e.g., rendering content, decompression, or compression), and a front-end task is a user-facing task that is perceptible to the user (e.g., presenting information to the user or providing feedback to the user). As described below in reference to FIGS. 15A-15B, the HIPD 1500 can perform the back-end tasks and provide the wrist-wearable device 1300 and/or the AR device 1400 operational data corresponding to the performed back-end tasks such that the wrist-wearable device 1300 and/or the AR device 1400 can perform the front-end tasks. In this way, the HIPD 1500, which has more computational resources and greater thermal headroom than the wrist-wearable device 1300 and/or the AR device 1400, performs computationally intensive tasks and reduces the computer resource utilization and/or power usage of the wrist-wearable device 1300 and/or the AR device 1400.

In the example shown by the first AR system 1200a, the HIPD 1500 identifies one or more back-end tasks and front-end tasks associated with a user request to initiate an AR video call with one or more other users (represented by the avatar 1204 and the digital representation of the contact 1206) and distributes instructions to cause the performance of the one or more back-end tasks and front-end tasks. In particular, the HIPD 1500 performs back-end tasks for processing and/or rendering image data (and other data) associated with the AR video call and provides operational data associated with the performed back-end tasks to the AR device 1400 such that the AR device 1400 performs front-end tasks for presenting the AR video call (e.g., presenting the avatar 1204 and the digital representation of the contact 1206).

In some embodiments, the HIPD 1500 can operate as a focal or anchor point for causing the presentation of information. This allows the user 1202 to be generally aware of where information is presented. For example, as shown in the first AR system 1200a, the avatar 1204 and the digital representation of the contact 1206 are presented above the HIPD 1500. In particular, the HIPD 1500 and the AR device 1400 operate in conjunction to determine a location for presenting the avatar 1204 and the digital representation of the contact 1206. In some embodiments, information can be presented within a predetermined distance from the HIPD 1500 (e.g., within five meters). For example, as shown in the first AR system 1200a, virtual object 1208 is presented on the desk some distance from the HIPD 1500. Similar to the above example, the HIPD 1500 and the AR device 1400 can operate in conjunction to determine a location for presenting the virtual object 1208. Alternatively, in some embodiments, presentation of information is not bound by the HIPD 1500. More specifically, the avatar 1204, the digital representation of the contact 1206, and the virtual object 1208 do not have to be presented within a predetermined distance of the HIPD 1500.

User inputs provided at the wrist-wearable device 1300, the AR device 1400, and/or the HIPD 1500 are coordinated such that the user can use any device to initiate, continue, and/or complete an operation. For example, the user 1202 can provide a user input to the AR device 1400 to cause the AR device 1400 to present the virtual object 1208 and, while the virtual object 1208 is presented by the AR device 1400, the user 1202 can provide one or more hand gestures via the wrist-wearable device 1300 to interact and/or manipulate the virtual object 1208.

Having discussed an example AR system, devices for interacting with such AR systems, and other computing systems more generally, devices and components will now be discussed in greater detail below. Some definitions of devices and components that can be included in some or all of the example devices discussed below are defined here for ease of reference. A skilled artisan will appreciate that certain types of the components described below may be more suitable for a particular set of devices and less suitable for a different set of devices. But subsequent references to the components defined here should be considered to be encompassed by the definitions provided.

In some embodiments discussed below, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, which facilitates communication, and/or data processing, and/or data transfer between the respective electronic devices and/or electronic components.

### Example Wrist-Wearable Devices

FIGS. 13A and 13B illustrate an example wrist-wearable device 1300, in accordance with some embodiments. The wrist-wearable device 1300 is an instance of the wearable device 110 described in reference to FIGS. 1-11 herein, such that the wrist-wearable device should be understood to have the features of the wrist-wearable device 1300 and vice versa. FIG. 13A illustrates components of the wrist-wearable device 1300, which can be used individually or in combination, including combinations that include other electronic devices and/or electronic components.

FIG. 13A shows a wearable band 1310 and a watch body 1320 (or capsule) being coupled, as discussed below, to form the wrist-wearable device 1300. The wrist-wearable device 1300 can perform various functions and/or operations associated with navigating through user interfaces and selectively opening applications, as well as the functions and/or operations described above with reference to FIGS. 1-11.

As will be described in more detail below, operations executed by the wrist-wearable device 1300 can include (i) presenting content to a user (e.g., displaying visual content via a display 1305); (ii) detecting (e.g., sensing) user input (e.g., sensing a touch on peripheral button 1323 and/or at a touch screen of the display 1305, a hand gesture detected by sensors (e.g., biopotential sensors)); (iii) sensing biometric data via one or more sensors 1313 (e.g., neuromuscular signals, heart rate, temperature, or sleep); messaging (e.g., text, speech, or video); image capture via one or more imaging devices or cameras 1325; wireless communications (e.g., cellular, near field, Wi-Fi, or personal area network); location determination; financial transactions; providing haptic feedback; alarms; notifications; biometric authentication; health monitoring; and/or sleep monitoring.

The above-example functions can be executed independently in the watch body 1320, independently in the wearable band 1310, and/or via an electronic communication between the watch body 1320 and the wearable band 1310. In some embodiments, functions can be executed on the wrist-wearable device 1300 while an AR environment is being presented (e.g., via the AR system 1200). As the skilled artisan will appreciate upon reading the descriptions provided herein, the novel wearable devices described herein can be used with other types of AR environments.

The wearable band 1310 can be configured to be worn by a user such that an inner (or inside) surface of the wearable structure 1311 of the wearable band 1310 is in contact with the user's skin. When worn by a user, sensors 1313 contact the user's skin. The sensors 1313 can sense biometric data such as a user's heart rate, saturated oxygen level, temperature, sweat level, neuromuscular-signal sensors, or a combination thereof. The sensors 1313 can also sense data about a user's environment, including a user's motion, altitude, location, orientation, gait, acceleration, position, or a combination thereof. In some embodiments, the sensors 1313 are configured to track a position and/or motion of the wearable band 1310. The one or more sensors 1313 can include any of the sensors defined above and/or discussed below with respect to FIG. 13B.

The one or more sensors 1313 can be distributed on an inside and/or an outside surface of the wearable band 1310. In some embodiments, the one or more sensors 1313 are uniformly spaced along the wearable band 1310. Alternatively, in some embodiments, the one or more sensors 1313 are positioned at distinct points along the wearable band 1310. As shown in FIG. 13A, the one or more sensors 1313 can be the same or distinct. For example, in some embodiments, the one or more sensors 1313 can be shaped as a pill (e.g., sensor 1313a), an oval, a circle a square, an oblong (e.g., sensor 1313c), and/or any other shape that maintains contact with the user's skin (e.g., such that neuromuscular signal and/or other biometric data can be accurately measured at the user's skin). In some embodiments, the one or more sensors 1313 are aligned to form pairs of sensors (e.g., for sensing neuromuscular signals based on differential sensing within each respective sensor). For example, sensor 1313b is aligned with an adjacent sensor to form sensor pair 1314a, and sensor 1313d is aligned with an adjacent sensor to form sensor pair 1314b. In some embodiments, the wearable band 1310 does not have a sensor pair. Alternatively, in some embodiments, the wearable band 1310 has a predetermined number of sensor pairs (one pair of sensors, three pairs of sensors, four pairs of sensors, six pairs of sensors, or sixteen pairs of sensors).

The wearable band 1310 can include any suitable number of sensors 1313. In some embodiments, the amount and arrangements of sensors 1313 depend on the particular application for which the wearable band 1310 is used. For instance, a wearable band 1310 configured as an armband, wristband, or chest-band may include a plurality of sensors 1313 with a different number of sensors 1313 and different arrangement for each use case, such as medical use cases, compared to gaming or general day-to-day use cases.

In accordance with some embodiments, the wearable band 1310 further includes an electrical ground electrode and a shielding electrode. The electrical ground and shielding electrodes, like the sensors 1313, can be distributed on the inside surface of the wearable band 1310 such that they contact a portion of the user's skin. For example, the electrical ground and shielding electrodes can be at an inside surface of coupling mechanism 1316 or an inside surface of a wearable structure 1311. The electrical ground and shielding electrodes can be formed and/or use the same components as the sensors 1313. In some embodiments, the wearable band 1310 includes more than one electrical ground electrode and more than one shielding electrode.

The sensors 1313 can be formed as part of the wearable structure 1311 of the wearable band 1310. In some embodiments, the sensors 1313 are flush or substantially flush with the wearable structure 1311 such that they do not extend beyond the surface of the wearable structure 1311. While flush with the wearable structure 1311, the sensors 1313 are still configured to contact the user's skin (e.g., via a skin-contacting surface). Alternatively, in some embodiments, the sensors 1313 extend beyond the wearable structure 1311 a predetermined distance (e.g., 0.1 mm to 2 mm) to make contact and depress into the user's skin. In some embodiments, the sensors 1313 are coupled to an actuator (not shown) configured to adjust an extension height (e.g., a distance from the surface of the wearable structure 1311) of the sensors 1313 such that the sensors 1313 make contact and depress into the user's skin. In some embodiments, the actuators adjust the extension height between 0.01 mm to 1.2 mm. This allows the user to customize the positioning of the sensors 1313 to improve the overall comfort of the wearable band 1310 when worn while still allowing the sensors 1313 to contact the user's skin. In some embodiments, the sensors 1313 are indistinguishable from the wearable structure 1311 when worn by the user.

The wearable structure 1311 can be formed of an elastic material, elastomers, etc., configured to be stretched and fitted to be worn by the user. In some embodiments, the wearable structure 1311 is a textile or woven fabric. As described above, the sensors 1313 can be formed as part of a wearable structure 1311. For example, the sensors 1313 can be molded into the wearable structure 1311 or be integrated into a woven fabric (e.g., the sensors 1313 can be sewn into the fabric and mimic the pliability of fabric (e.g., the sensors 1313 can be constructed from a series of woven strands of fabric)).

The wearable structure 1311 can include flexible electronic connectors that interconnect the sensors 1313, the electronic circuitry, and/or other electronic components (described below in reference to FIG. 13B) that are enclosed in the wearable band 1310. In some embodiments, the flexible electronic connectors are configured to interconnect the sensors 1313, the electronic circuitry, and/or other electronic components of the wearable band 1310 with respective sensors and/or other electronic components of another electronic device (e.g., watch body 1320). The flexible electronic connectors are configured to move with the wearable structure 1311 such that the user adjustment to the wearable structure 1311 (e.g., resizing, pulling, or folding) does not stress or strain the electrical coupling of components of the wearable band 1310.

As described above, the wearable band 1310 is configured to be worn by a user. In particular, the wearable band 1310 can be shaped or otherwise manipulated to be worn by a user. For example, the wearable band 1310 can be shaped to have a substantially circular shape such that it can be configured to be worn on the user's lower arm or wrist. Alternatively, the wearable band 1310 can be shaped to be worn on another body part of the user, such as the user's upper arm (e.g., around a bicep), forearm, chest, legs, etc. The wearable band 1310 can include a retaining mechanism 1312 (e.g., a buckle or a hook and loop fastener) for securing the wearable band 1310 to the user's wrist or other body part. While the wearable band 1310 is worn by the user, the sensors 1313 sense data (referred to as sensor data) from the user's skin. In particular, the sensors 1313 of the wearable band 1310 obtain (e.g., sense and record) neuromuscular signals.

The sensed data (e.g., sensed neuromuscular signals) can be used to detect and/or determine the user's intention to perform certain motor actions. In particular, the sensors 1313 sense and record neuromuscular signals from the user as the user performs muscular activations (e.g., movements or gestures). The detected and/or determined motor action (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1305 of the wrist-wearable device 1300 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1313 can be used to provide a user with an enhanced interaction with a physical object (e.g., devices communicatively coupled with the wearable band 1310) and/or a virtual object in an AR application generated by an AR system (e.g., user interface objects presented on the display 1305 or another computing device (e.g., a smartphone)).

In some embodiments, the wearable band 1310 includes one or more haptic devices 1346 (FIG. 13B; e.g., a vibratory haptic actuator) that are configured to provide haptic feedback (e.g., a cutaneous and/or kinesthetic sensation) to the user's skin. The sensors 1313 and/or the haptic devices 1346 can be configured to operate in conjunction with multiple applications including, without limitation, health monitoring, social media, games, and AR (e.g., the applications associated with AR).

The wearable band 1310 can also include a coupling mechanism 1316 (e.g., a cradle or a shape of the coupling mechanism can correspond to the shape of the watch body 1320 of the wrist-wearable device 1300) for detachably coupling a capsule (e.g., a computing unit) or watch body 1320 (via a coupling surface of the watch body 1320) to the wearable band 1310. In particular, the coupling mechanism 1316 can be configured to receive a coupling surface proximate to the bottom side of the watch body 1320 (e.g., a side opposite to a front side of the watch body 1320 where the display 1305 is located), such that a user can push the watch body 1320 downward into the coupling mechanism 1316 to attach the watch body 1320 to the coupling mechanism 1316. In some embodiments, the coupling mechanism 1316 can be configured to receive a top side of the watch body 1320 (e.g., a side proximate to the front side of the watch body 1320 where the display 1305 is located) that is pushed upward into the cradle, as opposed to being pushed downward into the coupling mechanism 1316. In some embodiments, the coupling mechanism 1316 is an integrated component of the wearable band 1310 such that the wearable band 1310 and the coupling mechanism 1316 are a single unitary structure. In some embodiments, the coupling mechanism 1316 is a type of frame or shell that allows the watch body 1320 coupling surface to be retained within or on the wearable band 1310 coupling mechanism 1316 (e.g., a cradle, a tracker band, a support base, or a clasp).

The coupling mechanism 1316 can allow for the watch body 1320 to be detachably coupled to the wearable band 1310 through a friction fit, a magnetic coupling, a rotation-based connector, a shear-pin coupler, a retention spring, one or more magnets, a clip, a pin shaft, a hook-and-loop fastener, or a combination thereof. A user can perform any type of motion to couple the watch body 1320 to the wearable band 1310 and to decouple the watch body 1320 from the wearable band 1310. For example, a user can twist, slide, turn, push, pull, or rotate the watch body 1320 relative to the wearable band 1310, or a combination thereof, to attach the watch body 1320 to the wearable band 1310 and to detach the watch body 1320 from the wearable band 1310. Alternatively, as discussed below, in some embodiments, the watch body 1320 can be decoupled from the wearable band 1310 by actuation of the release mechanism 1329.

The wearable band 1310 can be coupled with a watch body 1320 to increase the functionality of the wearable band 1310 (e.g., converting the wearable band 1310 into a wrist-wearable device 1300, adding an additional computing unit and/or battery to increase computational resources and/or a battery life of the wearable band 1310, or adding additional sensors to improve sensed data). As described above, the wearable band 1310 (and the coupling mechanism 1316) is configured to operate independently (e.g., execute functions independently) from watch body 1320. For example, the coupling mechanism 1316 can include one or more sensors 1313 that contact a user's skin when the wearable band 1310 is worn by the user and provide sensor data for determining control commands.

A user can detach the watch body 1320 (or capsule) from the wearable band 1310 in order to reduce the encumbrance of the wrist-wearable device 1300 to the user. For embodiments in which the watch body 1320 is removable, the watch body 1320 can be referred to as a removable structure, such that in these embodiments the wrist-wearable device 1300 includes a wearable portion (e.g., the wearable band 1310) and a removable structure (the watch body 1320).

Turning to the watch body 1320, the watch body 1320 can have a substantially rectangular or circular shape. The watch body 1320 is configured to be worn by the user on their wrist or on another body part. More specifically, the watch body 1320 is sized to be easily carried by the user, attached on a portion of the user's clothing, and/or coupled to the wearable band 1310 (forming the wrist-wearable device 1300). As described above, the watch body 1320 can have a shape corresponding to the coupling mechanism 1316 of the wearable band 1310. In some embodiments, the watch body 1320 includes a single release mechanism 1329 or multiple release mechanisms (e.g., two release mechanisms 1329 positioned on opposing sides of the watch body 1320, such as spring-loaded buttons) for decoupling the watch body 1320 and the wearable band 1310. The release mechanism 1329 can include, without limitation, a button, a knob, a plunger, a handle, a lever, a fastener, a clasp, a dial, a latch, or a combination thereof.

A user can actuate the release mechanism 1329 by pushing, turning, lifting, depressing, shifting, or performing other actions on the release mechanism 1329. Actuation of the release mechanism 1329 can release (e.g., decouple) the watch body 1320 from the coupling mechanism 1316 of the wearable band 1310, allowing the user to use the watch body 1320 independently from wearable band 1310 and vice versa. For example, decoupling the watch body 1320 from the wearable band 1310 can allow the user to capture images using rear-facing camera 1325b. Although the coupling mechanism 1316 is shown positioned at a corner of watch body 1320, the release mechanism 1329 can be positioned anywhere on watch body 1320 that is convenient for the user to actuate. In addition, in some embodiments, the wearable band 1310 can also include a respective release mechanism for decoupling the watch body 1320 from the coupling mechanism 1316. In some embodiments, the release mechanism 1329 is optional and the watch body 1320 can be decoupled from the coupling mechanism 1316, as described above (e.g., via twisting or rotating).

The watch body 1320 can include one or more peripheral buttons 1323 and 1327 for performing various operations at the watch body 1320. For example, the peripheral buttons 1323 and 1327 can be used to turn on or wake (e.g., transition from a sleep state to an active state) the display 1305, unlock the watch body 1320, increase or decrease volume, increase or decrease brightness, interact with one or more applications, interact with one or more user interfaces. Additionally, or alternatively, in some embodiments, the display 1305 operates as a touch screen and allows the user to provide one or more inputs for interacting with the watch body 1320.

In some embodiments, the watch body 1320 includes one or more sensors 1321. The sensors 1321 of the watch body 1320 can be the same or distinct from the sensors 1313 of the wearable band 1310. The sensors 1321 of the watch body 1320 can be distributed on an inside and/or an outside surface of the watch body 1320. In some embodiments, the sensors 1321 are configured to contact a user's skin when the watch body 1320 is worn by the user. For example, the sensors 1321 can be placed on the bottom side of the watch body 1320 and the coupling mechanism 1316 can be a cradle with an opening that allows the bottom side of the watch body 1320 to directly contact the user's skin. Alternatively, in some embodiments, the watch body 1320 does not include sensors that are configured to contact the user's skin (e.g., including sensors internal and/or external to the watch body 1320 that are configured to sense data of the watch body 1320 and the watch body 1320's surrounding environment). In some embodiments, the sensors 1313 are configured to track a position and/or motion of the watch body 1320.

The watch body 1320 and the wearable band 1310 can share data using a wired communication method (e.g., a Universal Asynchronous Receiver/Transmitter (UART) or a USB transceiver) and/or a wireless communication method (e.g., near-field communication or Bluetooth). For example, the watch body 1320 and the wearable band 1310 can share data sensed by the sensors 1313 and 1321, as well as application- and device-specific information (e.g., active and/or available applications), output devices (e.g., display or speakers), and/or input devices (e.g., touch screens, microphones, or imaging sensors).

In some embodiments, the watch body 1320 can include, without limitation, a front-facing camera 1325a and/or a rear-facing camera 1325b, sensors 1321 (e.g., a biometric sensor, an IMU sensor, a heart rate sensor, a saturated oxygen sensor, a neuromuscular-signal sensor, an altimeter sensor, a temperature sensor, a bioimpedance sensor, a pedometer sensor, an optical sensor (e.g., FIG. 13B; imaging sensor 1363), a touch sensor, a sweat sensor). In some embodiments, the watch body 1320 can include one or more haptic devices 1376 (FIG. 13B; a vibratory haptic actuator) that is configured to provide haptic feedback (e.g., a cutaneous and/or kinesthetic sensation) to the user. The sensors 1321 and/or the haptic device 1376 can also be configured to operate in conjunction with multiple applications, including, without limitation, health-monitoring applications, social media applications, game applications, and AR applications (e.g., the applications associated with AR).

As described above, the watch body 1320 and the wearable band 1310, when coupled, can form the wrist-wearable device 1300. When coupled, the watch body 1320 and wearable band 1310 operate as a single device to execute functions (e.g., operations, detections, or communications) described herein. In some embodiments, each device is provided with particular instructions for performing the one or more operations of the wrist-wearable device 1300. For example, in accordance with a determination that the watch body 1320 does not include neuromuscular-signal sensors, the wearable band 1310 can include alternative instructions for performing associated instructions (e.g., providing sensed neuromuscular-signal data to the watch body 1320 via a different electronic device). Operations of the wrist-wearable device 1300 can be performed by the watch body 1320 alone or in conjunction with the wearable band 1310 (e.g., via respective processors and/or hardware components) and vice versa. In some embodiments, operations of the wrist-wearable device 1300, the watch body 1320, and/or the wearable band 1310 can be performed in conjunction with one or more processors and/or hardware components of another communicatively coupled device (e.g., FIGS. 15A-15B; the HIPD 1500).

As described below with reference to the block diagram of FIG. 13B, the wearable band 1310 and/or the watch body 1320 can each include independent resources required to independently execute functions. For example, the wearable band 1310 and/or the watch body 1320 can each include a power source (e.g., a battery), a memory, data storage, a processor (e.g., a CPU), communications, a light source, and/or input/output devices.

FIG. 13B shows block diagrams of a computing system 1330 corresponding to the wearable band 1310 and a computing system 1360 corresponding to the watch body 1320, according to some embodiments. A computing system of the wrist-wearable device 1300 includes a combination of components of the wearable band computing system 1330 and the watch body computing system 1360, in accordance with some embodiments.

The watch body 1320 and/or the wearable band 1310 can include one or more components shown in watch body computing system 1360. In some embodiments, a single integrated circuit includes all or a substantial portion of the components of the watch body computing system 1360 that are included in a single integrated circuit. Alternatively, in some embodiments, components of the watch body computing system 1360 are included in a plurality of integrated circuits that are communicatively coupled. In some embodiments, the watch body computing system 1360 is configured to couple (e.g., via a wired or wireless connection) with the wearable band computing system 1330, which allows the computing systems to share components, distribute tasks, and/or perform other operations described herein (individually or as a single device).

The watch body computing system 1360 can include one or more processors 1379, a controller 1377, a peripherals interface 1361, a power system 1395, and memory (e.g., a memory 1380), each of which are defined above and described in more detail below.

The power system 1395 can include a charger input 1396, a power-management integrated circuit (PMIC) 1397, and a battery 1398, each of which are defined above. In some embodiments, a watch body 1320 and a wearable band 1310 can have respective charger inputs (e.g., charger inputs 1396 and 1357), respective batteries (e.g., batteries 1398 and 1359), and can share power with each other (e.g., the watch body 1320 can power and/or charge the wearable band 1310 and vice versa). Although watch body 1320 and/or the wearable band 1310 can include respective charger inputs, a single charger input can charge both devices when coupled. The watch body 1320 and the wearable band 1310 can receive a charge using a variety of techniques. In some embodiments, the watch body 1320 and the wearable band 1310 can use a wired charging assembly (e.g., power cords) to receive the charge. Alternatively, or in addition, the watch body 1320 and/or the wearable band 1310 can be configured for wireless charging. For example, a portable charging device can be designed to mate with a portion of watch body 1320 and/or wearable band 1310 and wirelessly deliver usable power to a battery of watch body 1320 and/or wearable band 1310. The watch body 1320 and the wearable band 1310 can have independent power systems (e.g., power system 1395 and 1356) to enable each to operate independently. The watch body 1320 and wearable band 1310 can also share power (e.g., one can charge the other) via respective PMICs (e.g., PMICs 1397 and 1358) that can share power over power and ground conductors and/or over wireless charging antennas.

In some embodiments, the peripherals interface 1361 can include one or more sensors 1321, many of which listed below are defined above. The sensors 1321 can include one or more coupling sensors 1362 for detecting when the watch body 1320 is coupled with another electronic device (e.g., a wearable band 1310). The sensors 1321 can include imaging sensors 1363 (one or more of the cameras 1325 and/or separate imaging sensors 1363 (e.g., thermal-imaging sensors)). In some embodiments, the sensors 1321 include one or more SpO2 sensors 1364. In some embodiments, the sensors 1321 include one or more biopotential-signal sensors (e.g., EMG sensors 1365, which may be disposed on a user-facing portion of the watch body 1320 and/or the wearable band 1310). In some embodiments, the sensors 1321 include one or more capacitive sensors 1366. In some embodiments, the sensors 1321 include one or more heart rate sensors 1367. In some embodiments, the sensors 1321 include one or more IMUs 1368. In some embodiments, one or more IMUs 1368 can be configured to detect movement of a user's hand or other location that the watch body 1320 is placed or held.

In some embodiments, the peripherals interface 1361 includes an NFC component 1369, a GPS component 1370, a long-term evolution (LTE) component 1371, and/or a Wi-Fi and/or Bluetooth communication component 1372. In some embodiments, the peripherals interface 1361 includes one or more buttons 1373 (e.g., the peripheral buttons 1323 and 1327 in FIG. 13A), which, when selected by a user, cause operations to be performed at the watch body 1320. In some embodiments, the peripherals interface 1361 includes one or more indicators, such as a light-emitting diode (LED), to provide a user with visual indicators (e.g., message received, low battery, an active microphone, and/or a camera).

The watch body 1320 can include at least one display 1305 for displaying visual representations of information or data to the user, including user-interface elements and/or three-dimensional (3D) virtual objects. The display can also include a touch screen for inputting user inputs, such as touch gestures, swipe gestures, and the like. The watch body 1320 can include at least one speaker 1374 and at least one microphone 1375 for providing audio signals to the user and receiving audio input from the user. The user can provide user inputs through the microphone 1375 and can also receive audio output from the speaker 1374 as part of a haptic event provided by the haptic controller 1378. The watch body 1320 can include at least one camera 1325, including a front-facing camera 1325a and a rear-facing camera 1325b. The cameras 1325 can include ultra-wide-angle cameras, wide-angle cameras, fish-eye cameras, spherical cameras, telephoto cameras, depth-sensing cameras, or other types of cameras.

The watch body computing system 1360 can include one or more haptic controllers 1378 and associated componentry (e.g., haptic devices 1376) for providing haptic events at the watch body 1320 (e.g., a vibrating sensation or audio output in response to an event at the watch body 1320). The haptic controllers 1378 can communicate with one or more haptic devices 1376, such as electroacoustic devices, including a speaker of the one or more speakers 1374 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1378 can provide haptic events to respective haptic actuators that are capable of being sensed by a user of the watch body 1320. In some embodiments, the one or more haptic controllers 1378 can receive input signals from an application of the applications 1382.

In some embodiments, the computer system 1330 and/or the computer system 1360 can include memory 1380, which can be controlled by a memory controller of the one or more controllers 1377 and/or one or more processors 1379. In some embodiments, software components stored in the memory 1380 include one or more applications 1382 configured to perform operations at the watch body 1320. In some embodiments, the one or more applications 1382 include games, word processors, messaging applications, calling applications, web browsers, social media applications, media streaming applications, financial applications, calendars, clocks, etc. In some embodiments, software components stored in the memory 1380 include one or more communication interface modules 1383 as defined above. In some embodiments, software components stored in the memory 1380 include one or more graphics modules 1384 for rendering, encoding, and/or decoding audio and/or visual data; and one or more data management modules 1385 for collecting, organizing, and/or providing access to the data 1387 stored in memory 1380. In some embodiments, software components stored in the memory 1380 include a signal analysis module 1386A, which is configured to perform the features described above in reference to FIGS. 1-11. For example, the signal analysis module 1386A can be configured to adjust analysis of neuromuscular signals sensed by a plurality of neuromuscular-signal sensors based on an offset between the worn position of the wrist-wearable device and a predetermined default position of the wrist-wearable device; adjust analysis of neuromuscular signals sensed by the plurality of neuromuscular-signal sensors based on an offset between a position of a neuromuscular-signal sensor 115 and the neuromuscular-signal sensor 115's respective predetermined default position; and/or reindex, swap, and/or adjusts neuromuscular signals. In some embodiments, the signal analysis module 150 is configured to determine a gesture performed by the user based on the sensed neuromuscular signals. In some embodiments, one or more of applications 1382 and/or one or more modules can work in conjunction with one another to perform various tasks at the watch body 1320.

In some embodiments, software components stored in the memory 1380 can include one or more operating systems 1381 (e.g., a Linux-based operating system, an Android operating system, etc.). The memory 1380 can also include data 1387. The data 1387 can include profile data 1388A, sensor data 1389A, media content data 1390, application data 1391, and AR processing data 1392A, which stores data related to the performance of the features described above in reference to FIGS. 1-11. For example, the AR processing data 1392A can include one or more models and/or algorithms for adjusting the analysis of the neuromuscular signals, data corresponding to previously processed neuromuscular signals, previously adjusted analyses of the neuromuscular signals, models and/or algorithms for determining a gesture performed by a user, and/or other operations described in reference to FIGS. 1-11.

It should be appreciated that the watch body computing system 1360 is an example of a computing system within the watch body 1320, and that the watch body 1320 can have more or fewer components than shown in the watch body computing system 1360, combine two or more components, and/or have a different configuration and/or arrangement of the components. The various components shown in watch body computing system 1360 are implemented in hardware, software, firmware, or a combination thereof, including one or more signal processing and/or application-specific integrated circuits.

Turning to the wearable band computing system 1330, one or more components that can be included in the wearable band 1310 are shown. The wearable band computing system 1330 can include more or fewer components than shown in the watch body computing system 1360, combine two or more components, and/or have a different configuration and/or arrangement of some or all of the components. In some embodiments, all, or a substantial portion of the components of the wearable band computing system 1330 are included in a single integrated circuit. Alternatively, in some embodiments, components of the wearable band computing system 1330 are included in a plurality of integrated circuits that are communicatively coupled. As described above, in some embodiments, the wearable band computing system 1330 is configured to couple (e.g., via a wired or wireless connection) with the watch body computing system 1360, which allows the computing systems to share components, distribute tasks, and/or perform other operations described herein (individually or as a single device).

The wearable band computing system 1330, similar to the watch body computing system 1360, can include one or more processors 1349, one or more controllers 1347 (including one or more haptics controller 1348), a peripherals interface 1331 that can include one or more sensors 1313 and other peripheral devices, power source (e.g., a power system 1356), and memory (e.g., a memory 1350) that includes an operating system (e.g., an operating system 1351), data (e.g., data 1354 including profile data 1388B, sensor data 1389B, AR processing data 1392B, etc.), and one or more modules (e.g., a communications interface module 1352, a data management module 1353, a signal analysis module 1386B, etc.).

The one or more sensors 1313 can be analogous to sensors 1321 of the computer system 1360 in light of the definitions above. For example, sensors 1313 can include one or more coupling sensors 1332, one or more SpO2 sensors 1334, one or more EMG sensors 1335, one or more capacitive sensors 1336, one or more heart rate sensors 1337, and one or more IMU sensors 1338.

The peripherals interface 1331 can also include other components analogous to those included in the peripheral interface 1361 of the computer system 1360, including an NFC component 1339, a GPS component 1340, an LTE component 1341, a Wi-Fi and/or Bluetooth communication component 1342, and/or one or more haptic devices 1376 as described above in reference to peripherals interface 1361. In some embodiments, the peripherals interface 1331 includes one or more buttons 1343, a display 1333, a speaker 1344, a microphone 1345, and a camera 1355. In some embodiments, the peripherals interface 1331 includes one or more indicators, such as an LED.

It should be appreciated that the wearable band computing system 1330 is an example of a computing system within the wearable band 1310, and that the wearable band 1310 can have more or fewer components than shown in the wearable band computing system 1330, combine two or more components, and/or have a different configuration and/or arrangement of the components. The various components shown in wearable band computing system 1330 can be implemented in one or a combination of hardware, software, and firmware, including one or more signal processing and/or application-specific integrated circuits.

The wrist-wearable device 1300 with respect to FIG. 13A is an example of the wearable band 1310 and the watch body 1320 coupled, so the wrist-wearable device 1300 will be understood to include the components shown and described for the wearable band computing system 1330 and the watch body computing system 1360. In some embodiments, wrist-wearable device 1300 has a split architecture (e.g., a split mechanical architecture or a split electrical architecture) between the watch body 1320 and the wearable band 1310. In other words, all of the components shown in the wearable band computing system 1330 and the watch body computing system 1360 can be housed or otherwise disposed in a combined watch device 1300, or within individual components of the watch body 1320, wearable band 1310, and/or portions thereof (e.g., a coupling mechanism 1316 of the wearable band 1310).

The techniques described above can be used with any device for sensing neuromuscular signals, including the arm-wearable devices of FIG. 13A-13B, but could also be used with other types of wearable devices for sensing neuromuscular signals (such as body-wearable or head-wearable devices that might have neuromuscular sensors closer to the brain or spinal column).

In some embodiments, a wrist-wearable device 1300 can be used in conjunction with a head-wearable device described below (e.g., AR device 1400 and VR device 1410) and/or an HIPD 1500, and the wrist-wearable device 1300 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 1400 and VR device 1410.

### Example Head-Wearable Devices

FIGS. 14A, 14B-1, 14B-2, and 14C show example head-wearable devices, in accordance with some embodiments. Head-wearable devices can include, but are not limited to, AR devices 1400 (e.g., AR or smart eyewear devices, such as smart glasses, smart monocles, smart contacts, etc.), VR devices 1410 (e.g., VR headsets or head-mounted displays (HMDs)), or other ocularly coupled devices. The AR devices 1400 and the VR devices 1410 are instances of the head-wearable devices described in reference to FIG. 12 herein, such that the head-wearable device should be understood to have the features of the AR devices 1400 and/or the VR devices 1410 and vice versa. In some embodiments, the AR devices 1400 and the VR devices 1410 can perform various functions and/or operations associated with navigating through user interfaces and selectively opening applications, as well as the functions and/or operations described above with reference to FIGS. 1-11.

In some embodiments, an AR system (e.g., FIG. 12; AR system 1200) includes an AR device 1400 (as shown in FIG. 14A) and/or VR device 1410 (as shown in FIGS. 14B-1-B-2). In some embodiments, the AR device 1400 and the VR device 1410 can include one or more analogous components (e.g., components for presenting interactive AR environments, such as processors, memory, and/or presentation devices, including one or more displays and/or one or more waveguides), some of which are described in more detail with respect to FIG. 14C. The head-wearable devices can use display projectors (e.g., display projector assemblies 1407A and 1407B) and/or waveguides for projecting representations of data to a user. Some embodiments of head-wearable devices do not include displays.

FIG. 14A shows an example visual depiction of the AR device 1400 (e.g., which may also be described herein as augmented-reality glasses and/or smart glasses). The AR device 1400 can work in conjunction with additional electronic components that are not shown in FIGS. 14A, such as a wearable accessory device and/or an intermediary processing device, in electronic communication or otherwise configured to be used in conjunction with the AR device 1400. In some embodiments, the wearable accessory device and/or the intermediary processing device may be configured to couple with the AR device 1400 via a coupling mechanism in electronic communication with a coupling sensor 1424, where the coupling sensor 1424 can detect when an electronic device becomes physically or electronically coupled with the AR device 1400. In some embodiments, the AR device 1400 can be configured to couple to a housing (e.g., a portion of frame 1404 or temple arms 1405), which may include one or more additional coupling mechanisms configured to couple with additional accessory devices. The components shown in FIG. 14A can be implemented in hardware, software, firmware, or a combination thereof, including one or more signal-processing components and/or application-specific integrated circuits (ASICs).

The AR device 1400 includes mechanical glasses components, including a frame 1404 configured to hold one or more lenses (e.g., one or both lenses 1406-1 and 1406-2). One of ordinary skill in the art will appreciate that the AR device 1400 can include additional mechanical components, such as hinges configured to allow portions of the frame 1404 of the AR device 1400 to be folded and unfolded, a bridge configured to span the gap between the lenses 1406-1 and 1406-2 and rest on the user's nose, nose pads configured to rest on the bridge of the nose and provide support for the AR device 1400, earpieces configured to rest on the user's ears and provide additional support for the AR device 1400, temple arms 1405 configured to extend from the hinges to the earpieces of the AR device 1400, and the like. One of ordinary skill in the art will further appreciate that some examples of the AR device 1400 can include none of the mechanical components described herein. For example, smart contact lenses configured to present AR to users may not include any components of the AR device 1400.

The lenses 1406-1 and 1406-2 can be individual displays or display devices (e.g., a waveguide for projected representations). The lenses 1406-1 and 1406-2 may act together or independently to present an image or series of images to a user. In some embodiments, the lenses 1406-1 and 1406-2 can operate in conjunction with one or more display projector assemblies 1407A and 1407B to present image data to a user. While the AR device 1400 includes two displays, embodiments of this disclosure may be implemented in AR devices with a single near-eye display (NED) or more than two NEDs.

The AR device 1400 includes electronic components, many of which will be described in more detail below with respect to FIG. 14C. Some example electronic components are illustrated in FIG. 14A, including sensors 1423-1, 1423-2, 1423-3, 1423-4, 1423-5, and 1423-6, which can be distributed along a substantial portion of the frame 1404 of the AR device 1400. The different types of sensors are described below in reference to FIG. 14C. The AR device 1400 also includes a left camera 1439A and a right camera 1439B, which are located on different sides of the frame 1404. And the eyewear device includes one or more processors 1448A and 1448B (e.g., an integral microprocessor, such as an ASIC) that is embedded into a portion of the frame 1404.

FIGS. 14B-1 and 14B-2 show an example visual depiction of the VR device 1410 (e.g., a head-mounted display (HMD) 1412, also referred to herein as an AR headset, a head-wearable device, or a VR headset). The HMD 1412 includes a front body 1414 and a frame 1416 (e.g., a strap or band) shaped to fit around a user's head. In some embodiments, the front body 1414 and/or the frame 1416 includes one or more electronic elements for facilitating presentation of and/or interactions with an AR and/or VR system (e.g., displays, processors (e.g., processor 1448A-1), IMUs, tracking emitters or detectors, or sensors). In some embodiments, the HMD 1412 includes output audio transducers (e.g., an audio transducer 1418-1), as shown in FIG. 14B-2. In some embodiments, one or more components, such as the output audio transducer(s) 1418 and the frame 1416, can be configured to attach and detach (e.g., are detachably attachable) to the HMD 1412 (e.g., a portion or all of the frame 1416 and/or the output audio transducer 1418), as shown in FIG. 14B-2. In some embodiments, coupling a detachable component to the HMD 1412 causes the detachable component to come into electronic communication with the HMD 1412. The VR device 1410 includes electronic components, many of which will be described in more detail below with respect to FIG. 14C.

FIGS. 14B-1 and 14B-2 also show that the VR device 1410 having one or more cameras, such as the left camera 1439A and the right camera 1439B, which can be analogous to the left and right cameras on the frame 1404 of the AR device 1400. In some embodiments, the VR device 1410 includes one or more additional cameras (e.g., cameras 1439C and 1439D), which can be configured to augment image data obtained by the cameras 1439A and 1439B by providing more information. For example, the camera 1439C can be used to supply color information that is not discerned by cameras 1439A and 1439B. In some embodiments, one or more of the cameras 1439A to 1439D can include an optional IR (infrared) cut filter configured to remove IR light from being received at the respective camera sensors.

The VR device 1410 can include a housing 1490 storing one or more components of the VR device 1410 and/or additional components of the VR device 1410. The housing 1490 can be a modular electronic device configured to couple with the VR device 1410 (or an AR device 1400) and supplement and/or extend the capabilities of the VR device 1410 (or an AR device 1400). For example, the housing 1490 can include additional sensors, cameras, power sources, and processors (e.g., processor 1448A-2). to improve and/or increase the functionality of the VR device 1410. Examples of the different components included in the housing 1490 are described below in reference to FIG. 14C.

Alternatively, or in addition, in some embodiments, the head-wearable device, such as the VR device 1410 and/or the AR device 1400, includes, or is communicatively coupled to, another external device (e.g., a paired device), such as an HIPD 15 (discussed below in reference to FIGS. 15A-15B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckbands may also apply to various other paired devices, such as smartwatches, smartphones, wrist bands, other wearable devices, hand-held controllers, tablet computers, or laptop computers.

In some situations, pairing external devices, such as an intermediary processing device (e.g., an HIPD device 1500, an optional neckband, and/or a wearable accessory device) with the head-wearable devices (e.g., an AR device 1400 and/or a VR device 1410) enables the head-wearable devices to achieve a similar form factor of a pair of glasses while still providing sufficient battery and computational power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable device overall while allowing the head-wearable device to retain its desired functionality. For example, the intermediary processing device (e.g., the HIPD 1500) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computational capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an AR environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, and/or storage) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, such as an HIPD 1500, can process information generated by one or more of its sensors and/or information provided by other communicatively coupled devices. For example, a head-wearable device can include an IMU, and the intermediary processing device (a neckband and/or an HIPD 1500) can compute all inertial and spatial calculations from the IMUs located on the head-wearable device. Additional examples of processing performed by a communicatively coupled device, such as the HIPD 1500, are provided below in reference to FIGS. 15A and 15B.

AR systems may include a variety of types of visual feedback mechanisms. For example, display devices in the AR devices 1400 and/or the VR devices 1410 may include one or more liquid-crystal displays (LCDs), light emitting diode (LED) displays, organic LED (OLED) displays, and/or any other suitable type of display screen. AR systems may include a single display screen for both eyes or may provide a display screen for each eye, which may allow for additional flexibility for varifocal adjustments or for correcting a refractive error associated with the user's vision. Some AR systems also include optical subsystems having one or more lenses (e.g., conventional concave or convex lenses, Fresnel lenses, or adjustable liquid lenses) through which a user may view a display screen. In addition to or instead of using display screens, some AR systems include one or more projection systems. For example, display devices in the AR device 1400 and/or the VR device 1410 may include micro-LED projectors that project light (e.g., using a waveguide) into display devices, such as clear combiner lenses that allow ambient light to pass through. The display devices may refract the projected light toward a user's pupil and may enable a user to simultaneously view both AR content and the real world. AR systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1400 and the VR device 1410, either or both of the example head-wearable devices described herein can be configured to present fully immersive VR scenes presented in substantially all of a user's field of view, additionally or alternatively to, subtler augmented-reality scenes that are presented within a portion, less than all, of the user's field of view.

In some embodiments, the AR device 1400 and/or the VR device 1410 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other AR devices, within other AR devices, and/or in conjunction with other AR devices (e.g., wrist-wearable devices that may be incorporated into headwear, gloves, body suits, handheld controllers, environmental devices (e.g., chairs or floormats), and/or any other type of device or system, such as a wrist-wearable device 1300, an HIPD 1500, smart textile-based garment), and/or other devices described herein.

FIG. 14C illustrates a computing system 1420 and an optional housing 1490, each of which shows components that can be included in a head-wearable device (e.g., the AR device 1400 and/or the VR device 1410). In some embodiments, more or fewer components can be included in the optional housing 1490 depending on practical restraints of the respective head-wearable device being described. Additionally or alternatively, the optional housing 1490 can include additional components to expand and/or augment the functionality of a head-wearable device.

In some embodiments, the computing system 1420 and/or the optional housing 1490 can include one or more peripheral interfaces 1422A and 1422B, one or more power systems 1442A and 1442B (including charger input 1443, PMIC 1444, and battery 1445), one or more controllers 1446A and 1446B (including one or more haptic controllers 1447), one or more processors 1448A and 1448B (as defined above, including any of the examples provided), and memory 1450A and 1450B, which can all be in electronic communication with each other. For example, the one or more processors 1448A and/or 1448B can be configured to execute instructions stored in the memory 1450A and/or 1450B, which can cause a controller of the one or more controllers 1446A and/or 1446B to cause operations to be performed at one or more peripheral devices of the peripherals interfaces 1422A and/or 1422B. In some embodiments, each operation described can occur based on electrical power provided by the power system 1442A and/or 1442B.

In some embodiments, the peripherals interface 1422A can include one or more devices configured to be part of the computing system 1420, many of which have been defined above and/or described with respect to wrist-wearable devices shown in FIGS. 13A and 13B. For example, the peripherals interface can include one or more sensors 1423A. Some example sensors include one or more coupling sensors 1424, one or more acoustic sensors 1425, one or more imaging sensors 1426, one or more EMG sensors 1427, one or more capacitive sensors 1428, and/or one or more IMUs 1429. In some embodiments, the sensors 1423A further include depth sensors 1467, light sensors 1468, and/or any other types of sensors defined above or described with respect to any other embodiments discussed herein.

In some embodiments, the peripherals interface can include one or more additional peripheral devices, including one or more NFC devices 1430, one or more GPS devices 1431, one or more LTE devices 1432, one or more Wi-Fi and/or Bluetooth devices 1433, one or more buttons 1434 (e.g., including buttons that are slidable or otherwise adjustable), one or more displays 1435A, one or more speakers 1436A, one or more microphones 1437A, one or more cameras 1438A (e.g., including the first camera 1439-1 through nth camera 1439-n, which are analogous to the left camera 1439A and/or the right camera 1439B), one or more haptic devices 1440, and/or any other types of peripheral devices defined above or described with respect to any other embodiments discussed herein.

The head-wearable devices can include a variety of types of visual feedback mechanisms (e.g., presentation devices). For example, display devices in the AR device 1400 and/or the VR device 1410 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes) and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1435A can be coupled to each of the lenses 1406-1 and 1406-2 of the AR device 1400. The displays 1435A coupled to each of the lenses 1406-1 and 1406-2 can act together or independently to present an image or series of images to a user. In some embodiments, the AR device 1400 and/or the VR device 1410 includes a single display 1435A (e.g., a near-eye display) or more than two displays 1435A.

In some embodiments, a first set of one or more displays 1435A can be used to present an augmented-reality environment, and a second set of one or more display devices 1435A can be used to present a VR environment. In some embodiments, one or more waveguides are used in conjunction with presenting AR content to the user of the AR device 1400 and/or the VR device 1410 (e.g., as a means of delivering light from a display projector assembly and/or one or more displays 1435A to the user's eyes). In some embodiments, one or more waveguides are fully or partially integrated into the AR device 1400 and/or the VR device 1410. Additionally, or alternatively, to display screens, some AR systems include one or more projection systems. For example, display devices in the AR device 1400 and/or the VR device 1410 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. The head-wearable devices can also be configured with any other suitable type or form of image projection system. In some embodiments, one or more waveguides are provided, additionally or alternatively, to the one or more display(s) 1435A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion, less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15%-50% of the ambient light and/or the real-world live view) can be passed through the user interface element, such that the user can distinguish at least a portion of the physical environment over which the user interface element is being displayed.

The head-wearable devices can include one or more external displays 1435A for presenting information to users. For example, an external display 1435A can be used to show a current battery level, network activity (e.g., connected, disconnected), current activity (e.g., playing a game, in a call, in a meeting, or watching a movie), and/or other relevant information. In some embodiments, the external displays 1435A can be used to communicate with others. For example, a user of the head-wearable device can cause the external displays 1435A to present a “do not disturb” notification. The external displays 1435A can also be used by the user to share any information captured by the one or more components of the peripherals interface 1422A and/or generated by the head-wearable device (e.g., during operation and/or performance of one or more applications).

The memory 1450A can include instructions and/or data executable by one or more processors 1448A (and/or processors 1448B of the housing 1490) and/or a memory controller of the one or more controllers 1446A (and/or controller 1446B of the housing 1490). The memory 1450A can include one or more operating systems 1451, one or more applications 1452, one or more communication interface modules 1453A, one or more graphics modules 1454A, one or more AR processing modules 1455A, signal analysis module 1456 (analogous to the signal analysis module 1386A; FIG. 13B) for performing the operations of FIGS. 1-11, and/or any other types of modules or components defined above or described with respect to any other embodiments discussed herein.

The data 1460 stored in memory 1450A can be used in conjunction with one or more of the applications and/or programs discussed above. The data 1460 can include profile data 1461, sensor data 1462, media content data 1463, AR application data 1464, AR processing data 1465 (analogous to the AR processing data 1392A; FIG. 13B) for performing the operations of FIGS. 1-11; and/or any other types of data defined above or described with respect to any other embodiments discussed herein.

In some embodiments, the controller 1446A of the head-wearable devices processes information generated by the sensors 1423A on the head-wearable devices and/or another component of the head-wearable devices and/or communicatively coupled with the head-wearable devices (e.g., components of the housing 1490, such as components of peripherals interface 1422B). For example, the controller 1446A can process information from the acoustic sensors 1425 and/or image sensors 1426. For each detected sound, the controller 1446A can perform a direction of arrival (DOA) estimation to estimate a direction from which the detected sound arrived at a head-wearable device. As one or more of the acoustic sensors 1425 detect sounds, the controller 1446A can populate an audio data set with the information (e.g., represented by sensor data 1462).

In some embodiments, a physical electronic connector can convey information between the head-wearable devices and another electronic device, and/or between one or more processors 1448A of the head-wearable devices and the controller 1446A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1500) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 1400 and/or the VR device 1410 can include one or more optical sensors such as two-dimensional (2D) or three-dimensional (3D) cameras, ToF depth sensors, single-beam or sweeping laser rangefinders, 3D LiDAR sensors, and/or any other suitable type or form of optical sensor. A head-wearable device can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with an AR environment), among a variety of other functions. For example, FIGS. 14B-1 and 14B-2 show the VR device 1410 having cameras 1439A-1439D, which can be used to provide depth information for creating a voxel field and a 2D mesh to provide object information to the user to avoid collisions.

The optional housing 1490 can include analogous components to those describe above with respect to the computing system 1420. For example, the optional housing 1490 can include a respective peripherals interface 1422B, including more or fewer components to those described above with respect to the peripherals interface 1422A. As described above, the components of the optional housing 1490 can be used to augment and/or expand on the functionality of the head-wearable devices. For example, the optional housing 1490 can include respective sensors 1423B, speakers 1436B, displays 1435B, microphones 1437B, cameras 1438B, and/or other components to capture and/or present data. Similarly, the optional housing 1490 can include one or more processors 1448B, controllers 1446B, and/or memory 1450B (including respective communication interface modules 1453B, one or more graphics modules 1454B, one or more AR processing modules 1455B) that can be used individually and/or in conjunction with the components of the computing system 1420.

The techniques described above in FIGS. 14A-14C can be used with different head-wearable devices. In some embodiments, the head-wearable devices (e.g., the AR device 1400 and/or the VR device 1410) can be used in conjunction with one or more wearable devices such as a wrist-wearable device 1300 (or components thereof). Having thus described example the head-wearable devices, attention will now be turned to example handheld intermediary processing devices, such as HIPD 1500.

### Example Handheld Intermediary Processing Devices

FIGS. 15A and 15B illustrate an example handheld intermediary processing device (HIPD) 1500, in accordance with some embodiments. The HIPD 1500 is an instance of the intermediary device described in reference to FIG. 12 herein, such that the HIPD 1500 should be understood to have the features described with respect to any intermediary device defined above or otherwise described herein, and vice versa. The HIPD 1500 can perform various functions and/or operations associated with navigating through user interfaces and selectively opening applications, as well as the functions and/or operations described above with reference to FIGS. 1-11.

FIG. 15A shows a top view 1505 and a side view 1525 of the HIPD 1500. The HIPD 1500 is configured to communicatively couple with one or more wearable devices (or other electronic devices) associated with a user. For example, the HIPD 1500 is configured to communicatively couple with a user's wrist-wearable device 1300 (or components thereof, such as the watch body 1320 and the wearable band 1310), AR device 1400, and/or VR device 1410. The HIPD 1500 can be configured to be held by a user (e.g., as a handheld controller), carried on the user's person (e.g., in their pocket or in their bag), placed in proximity of the user (e.g., placed on their desk while seated at their desk or on a charging dock), and/or placed at or within a predetermined distance from a wearable device or other electronic device (e.g., where, in some embodiments, the predetermined distance is the maximum distance (e.g., 10 meters) at which the HIPD 1500 can successfully be communicatively coupled with an electronic device, such as a wearable device).

The HIPD 1500 can perform various functions independently and/or in conjunction with one or more wearable devices (e.g., wrist-wearable device 1300, AR device 1400, and/or VR device 1410). The HIPD 1500 is configured to increase and/or improve the functionality of communicatively coupled devices, such as the wearable devices. The HIPD 1500 is configured to perform one or more functions or operations associated with interacting with user interfaces and applications of communicatively coupled devices, interacting with an AR environment, interacting with a VR environment, and/or operating as a human-machine interface controller, as well as functions and/or operations described herein. Additionally, as will be described in more detail below, functionality and/or operations of the HIPD 1500 can include, without limitation, task offloading and/or handoffs, thermals offloading and/or handoffs, 6 degrees of freedom (6DoF) raycasting and/or gaming (e.g., using imaging devices or cameras 1514A and 1514B, which can be used for simultaneous localization and mapping (SLAM), and/or with other image processing techniques), portable charging; messaging, image capturing via one or more imaging devices or cameras (e.g., cameras 1522A and 1522B), sensing user input (e.g., sensing a touch on a multitouch input surface 1502), wireless communications and/or interlining (e.g., cellular, near field, Wi-Fi, or personal area network), location determination, financial transactions, providing haptic feedback, alarms, notifications, biometric authentication, health monitoring, sleep monitoring. The above-example functions can be executed independently in the HIPD 1500 and/or in communication between the HIPD 1500 and another wearable device described herein. In some embodiments, functions can be executed on the HIPD 1500 in conjunction with an AR environment. As the skilled artisan will appreciate upon reading the descriptions provided herein, the novel HIPD 1500 described herein can be used with any type of suitable AR environment.

While the HIPD 1500 is communicatively coupled with a wearable device and/or other electronic device, the HIPD 1500 is configured to perform one or more operations initiated at the wearable device and/or the other electronic device. In particular, one or more operations of the wearable device and/or the other electronic device can be offloaded to the HIPD 1500 to be performed. The HIPD 1500 performs one or more operations of the wearable device and/or the other electronic device and provides data corresponding to the completed operations to the wearable device and/or the other electronic device. For example, a user can initiate a video stream using the AR device 1400 and back-end tasks associated with performing the video stream (e.g., video rendering) can be offloaded to the HIPD 1500, which the HIPD 1500 performs and provides corresponding data to the AR device 1400 to perform remaining front-end tasks associated with the video stream (e.g., presenting the rendered video data via a display of the AR device 1400). In this way, the HIPD 1500, which has more computational resources and greater thermal headroom than a wearable device can perform computationally intensive tasks for the wearable device, improving performance of an operation performed by the wearable device.

The HIPD 1500 includes a multi-touch input surface 1502 on a first side (e.g., a front surface) that is configured to detect one or more user inputs. In particular, the multi-touch input surface 1502 can detect single-tap inputs, multi-tap inputs, swipe gestures and/or inputs, force-based and/or pressure-based touch inputs, held taps, and the like. The multi-touch input surface 1502 is configured to detect capacitive touch inputs and/or force (and/or pressure) touch inputs. The multi-touch input surface 1502 includes a first touch-input surface 1504 defined by a surface depression, and a second touch-input surface 1506 defined by a substantially planar portion. The first touch-input surface 1504 can be disposed adjacent to the second touch-input surface 1506. In some embodiments, the first touch-input surface 1504 and the second touch-input surface 1506 can be different dimensions, shapes, and/or cover different portions of the multi-touch input surface 1502. For example, the first touch-input surface 1504 can be substantially circular and the second touch-input surface 1506 is substantially rectangular. In some embodiments, the surface depression of the multi-touch input surface 1502 is configured to guide user handling of the HIPD 1500. In particular, the surface depression is configured such that the user holds the HIPD 1500 upright when held in a single hand (e.g., such that the using imaging devices or cameras 1514A and 1514B are pointed toward a ceiling or the sky). Additionally, the surface depression is configured such that the user's thumb rests within the first touch-input surface 1504.

In some embodiments, the different touch-input surfaces include a plurality of touch-input zones. For example, the second touch-input surface 1506 includes at least a first touch-input zone 1508 within a second touch-input zone 1506 and a third touch-input zone 1510 within the first touch-input zone 1508. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1508 causes the HIPD 1500 to perform a first command and a user input detected within the second touch-input zone 1506 causes the HIPD 1500 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1508 can be configured to detect force touch inputs (e.g., a magnitude at which the user presses down) and capacitive touch inputs, and the second touch-input zone 1506 can be configured to detect capacitive touch inputs.

The HIPD 1500 includes one or more sensors 1551 for sensing data used in the performance of one or more operations and/or functions. For example, the HIPD 1500 can include an IMU that is used in conjunction with cameras 1514 for 3-dimensional object manipulation (e.g., enlarging, moving, destroying, etc. an object) in an AR or VR environment. Non-limiting examples of the sensors 1551 included in the HIPD 1500 include a light sensor, a magnetometer, a depth sensor, a pressure sensor, and a force sensor. Additional examples of the sensors 1551 are provided below in reference to FIG. 15B.

The HIPD 1500 can include one or more light indicators 1512 to provide one or more notifications to the user. In some embodiments, the light indicators are LEDs or other types of illumination devices. The light indicators 1512 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1504. The light indicators can be illuminated in different colors and/or patterns to provide the user with one or more notifications and/or information about the device. For example, a light indicator positioned around the first touch-input surface 1504 can flash when the user receives a notification (e.g., a message), change red when the HIPD 1500 is out of power, operate as a progress bar (e.g., a light ring that is closed when a task is completed (e.g., 0% to 100%)), operates as a volume indicator, etc.).

In some embodiments, the HIPD 1500 includes one or more additional sensors on another surface. For example, as shown FIG. 15A, HIPD 1500 includes a set of one or more sensors (e.g., sensor set 1520) on an edge of the HIPD 1500. The sensor set 1520, when positioned on an edge of the of the HIPD 1500, can be pe positioned at a predetermined tilt angle (e.g., 26 degrees), which allows the sensor set 1520 to be angled toward the user when placed on a desk or other flat surface. Alternatively, in some embodiments, the sensor set 1520 is positioned on a surface opposite the multi-touch input surface 1502 (e.g., a back surface). The one or more sensors of the sensor set 1520 are discussed in detail below.

The side view 1525 of the of the HIPD 1500 shows the sensor set 1520 and camera 1514B. The sensor set 1520 includes one or more cameras 1522A and 1522B, a depth projector 1524, an ambient light sensor 1528, and a depth receiver 1530. In some embodiments, the sensor set 1520 includes a light indicator 1526. The light indicator 1526 can operate as a privacy indicator to let the user and/or those around them know that a camera and/or microphone is active. The sensor set 1520 is configured to capture a user's facial expression such that the user can puppet a custom avatar (e.g., showing emotions, such as smiles, laughter, etc., on the avatar or a digital representation of the user). The sensor set 1520 can be configured as a side stereo red-green-blue (RGB) system, a rear indirect time-of-flight (iToF) system, or a rear stereo RGB system. As the skilled artisan will appreciate upon reading the descriptions provided herein, the novel HIPD 1500 described herein can use different sensor set 1520 configurations and/or sensor set 1520 placement.

In some embodiments, the HIPD 1500 includes one or more haptic devices 1571 (FIG. 15B; e.g., a vibratory haptic actuator) that are configured to provide haptic feedback (e.g., kinesthetic sensation). The sensors 1551, and/or the haptic devices 1571 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1500 is configured to operate without a display. However, in optional embodiments, the HIPD 1500 can include a display 1568 (FIG. 15B). The HIPD 1500 can also income one or more optional peripheral buttons 1567 (FIG. 15B). For example, the peripheral buttons 1567 can be used to turn on or turn off the HIPD 1500. Further, the HIPD 1500 housing can be formed of polymers and/or elastomer elastomers. The HIPD 1500 can be configured to have a non-slip surface to allow the HIPD 1500 to be placed on a surface without requiring a user to watch over the HIPD 1500. In other words, the HIPD 1500 is designed such that it would not easily slide off a surfaces. In some embodiments, the HIPD 1500 include one or magnets to couple the HIPD 1500 to another surface. This allows the user to mount the HIPD 1500 to different surfaces and provide the user with greater flexibility in use of the HIPD 1500.

As described above, the HIPD 1500 can distribute and/or provide instructions for performing the one or more tasks at the HIPD 1500 and/or a communicatively coupled device. For example, the HIPD 1500 can identify one or more back-end tasks to be performed by the HIPD 1500 and one or more front-end tasks to be performed by a communicatively coupled device. While the HIPD 1500 is configured to offload and/or handoff tasks of a communicatively coupled device, the HIPD 1500 can perform both back-end and front-end tasks (e.g., via one or more processors, such as CPU 1577; FIG. 15B). The HIPD 1500 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1500 can perform the above operations alone or in conjunction with a wearable device (or other communicatively coupled electronic device).

FIG. 15B shows block diagrams of a computing system 1540 of the HIPD 1500, in accordance with some embodiments. The HIPD 1500, described in detail above, can include one or more components shown in HIPD computing system 1540. The HIPD 1500 will be understood to include the components shown and described below for the HIPD computing system 1540. In some embodiments, all, or a substantial portion of the components of the HIPD computing system 1540 are included in a single integrated circuit. Alternatively, in some embodiments, components of the HIPD computing system 1540 are included in a plurality of integrated circuits that are communicatively coupled.

The HIPD computing system 1540 can include a processor (e.g., a CPU 1577, a GPU, and/or a CPU with integrated graphics), a controller 1575, a peripherals interface 1550 that includes one or more sensors 1551 and other peripheral devices, a power source (e.g., a power system 1595), and memory (e.g., a memory 1578) that includes an operating system (e.g., an operating system 1579), data (e.g., data 1588), one or more applications (e.g., applications 1580), and one or more modules (e.g., a communications interface module 1581, a graphics module 1582, a task and processing management module 1583, an interoperability module 1584, an AR processing module 1585, a data management module 1586, a signal analysis module 1587, etc.). The HIPD computing system 1540 further includes a power system 1595 that includes a charger input and output 1596, a PMIC 1597, and a battery 1598, all of which are defined above.

In some embodiments, the peripherals interface 1550 can include one or more sensors 1551. The sensors 1551 can include analogous sensors to those described above in reference to FIG. 13B. For example, the sensors 1551 can include imaging sensors 1554, (optional) EMG sensors 1556, IMUs 1558, and capacitive sensors 1560. In some embodiments, the sensors 1551 can include one or more pressure sensor 1552 for sensing pressure data, an altimeter 1553 for sensing an altitude of the HIPD 1500, a magnetometer 1555 for sensing a magnetic field, a depth sensor 1557 (or a time-of flight sensor) for determining a difference between the camera and the subject of an image, a position sensor 1559 (e.g., a flexible position sensor) for sensing a relative displacement or position change of a portion of the HIPD 1500, a force sensor 1561 for sensing a force applied to a portion of the HIPD 1500, and a light sensor 1562 (e.g., an ambient light sensor) for detecting an amount of lighting. The sensors 1551 can include one or more sensors not shown in FIG. 15B.

Analogous to the peripherals described above in reference to FIGS. 13B, the peripherals interface 1550 can also include an NFC component 1563, a GPS component 1564, an LTE component 1565, a Wi-Fi and/or Bluetooth communication component 1566, a speaker 1569, a haptic device 1571, and a microphone 1573. As described above in reference to FIG. 15A, the HIPD 1500 can optionally include a display 1568 and/or one or more buttons 1567. The peripherals interface 1550 can further include one or more cameras 1570, touch surfaces 1572, and/or one or more light emitters 1574. The multi-touch input surface 1502 described above in reference to FIG. 15A is an example of touch surface 1572. The light emitters 1574 can be one or more LEDs, lasers, etc. and can be used to project or present information to a user. For example, the light emitters 1574 can include light indicators 1512 and 1526 described above in reference to FIG. 15A. The cameras 1570 (e.g., cameras 1514A, 1514B, and 1522 described above in FIG. 15A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1570 can be used for SLAM; 6 DoF ray casting, gaming, object manipulation, and/or other rendering; facial recognition and facial expression recognition, etc.

Similar to the watch body computing system 1360 and the watch band computing system 1330 described above in reference to FIG. 13B, the HIPD computing system 1540 can include one or more haptic controllers 1576 and associated componentry (e.g., haptic devices 1571) for providing haptic events at the HIPD 1500.

Memory 1578 can include high-speed random-access memory and/or non-volatile memory, such as one or more magnetic disk storage devices, flash memory devices, or other non-volatile solid-state memory devices. Access to the memory 1578 by other components of the HIPD 1500, such as the one or more processors and the peripherals interface 1550, can be controlled by a memory controller of the controllers 1575.

In some embodiments, software components stored in the memory 1578 include one or more operating systems 1579, one or more applications 1580, one or more communication interface modules 1581, one or more graphics modules 1582, one or more data management modules 1585, which are analogous to the software components described above in reference to FIG. 13B. The software components stored in the memory 1578 can also include a signal analysis module 1586A (analogous to the signal analysis module 1386A; FIG. 13B) for performing the operations of FIGS. 1-11.

In some embodiments, software components stored in the memory 1578 include a task and processing management module 1583 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1583 uses data 1588 (e.g., device data 1590) to distribute the one or more front-end and/or back-end tasks based on communicatively coupled devices' computing resources, available power, thermal headroom, ongoing operations, and/or other factors. For example, the task and processing management module 1583 can cause the performance of one or more back-end tasks (of an operation performed at communicatively coupled AR device 1400) at the HIPD 1500 in accordance with a determination that the operation is utilizing a predetermined amount (e.g., at least 70%) of computing resources available at the AR device 1400.

In some embodiments, software components stored in the memory 1578 include an interoperability module 1584 for exchanging and utilizing information received and/or provided to distinct communicatively coupled devices. The interoperability module 1584 allows for different systems, devices, and/or applications to connect and communicate in a coordinated way without user input. In some embodiments, software components stored in the memory 1578 include an AR module 1585 that is configured to process signals based at least on sensor data for use in an AR and/or VR environment. For example, the AR processing module 1585 can be used for 3D object manipulation, gesture recognition, facial and facial expression, recognition, etc.

The memory 1578 can also include data 1588, including structured data. In some embodiments, the data 1588 can include profile data 1589, device data 1589 (including device data of one or more devices communicatively coupled with the HIPD 1500, such as device type, hardware, software, configurations, etc.), sensor data 1591, media content data 1592, application data 1593, and AR processing data 1594 (analogous to the AR processing data 1392A; FIG. 13B) for performing the operations of FIGS. 1-11.

It should be appreciated that the HIPD computing system 1540 is an example of a computing system within the HIPD 1500, and that the HIPD 1500 can have more or fewer components than shown in the HIPD computing system 1540, combine two or more components, and/or have a different configuration and/or arrangement of the components. The various components shown in HIPD computing system 1540 are implemented in hardware, software, firmware, or a combination thereof, including one or more signal processing and/or application-specific integrated circuits.

The techniques described above in FIG. 15A-15B can be used with any device used as a human-machine interface controller. In some embodiments, an HIPD 1500 can be used in conjunction with one or more wearable device such as a head-wearable device (e.g., AR device 1400 and VR device 1410) and/or a wrist-wearable device 1300 (or components thereof).

Further embodiments also include various subsets of the above embodiments including embodiments described with reference to FIGS. 1-13 combined or otherwise re-arranged.

### Example Aspects

A few example aspects will now be briefly described.

(A1) In accordance with some embodiments, a method for calibrating neuromuscular signals sensed by a plurality of neuromuscular-signal sensors is disclosed. The method includes in response to a triggering event, receiving a pulse sensed by a neuromuscular-signal sensor of a plurality of neuromuscular-signal sensors of a wrist-wearable device. The method further includes, in accordance with a determination that the pulse indicates that at least one neuromuscular-signal sensor of the plurality of neuromuscular-signal sensors of the wrist-wearable device is offset from a respective predetermined default position, determining a worn position of the wrist-wearable device on the user's wrist, and adjusting analysis of neuromuscular signals of the plurality of neuromuscular-signal sensors based on an offset between the worn position of the wrist-wearable device and a predetermined default position of the wrist-wearable device.

(A2) In some embodiments of A1, the respective predetermined default position is associated with a predetermined pulse strength threshold, and the determination that the pulse indicates that the at least one neuromuscular-signal sensor of the plurality of neuromuscular-signal sensors of the wrist-wearable device is offset from the respective predetermined default position is based on a pulse strength of the at least one neuromuscular-signal sensor being below the predetermined pulse strength threshold.

(A3) In some embodiments of A2, determining the worn position of the wrist-wearable device on the user's wrist includes determining, based on a comparison of respective pulse strengths of pulses sensed by neuromuscular-signal sensors of the plurality of neuromuscular-signal sensors, a neuromuscular-signal sensor with a highest pulse strength, and determining a respective offset between the neuromuscular-signal sensor with the highest pulse strength and its respective predetermined default position.

(A4) In some embodiments of A3, the neuromuscular-signal sensor with the highest pulse strength is predicted to be at or near the user's artery.

(A5) In some embodiments of any of A1-A4, the plurality of neuromuscular-signal sensors includes a first neuromuscular-signal sensor and a second neuromuscular-signal sensor. In some embodiments, adjusting the analysis of the neuromuscular signals of the plurality of neuromuscular-signal sensors based on the offset between the worn position of the wrist-wearable device and the predetermined default position includes analyzing neuromuscular signals sensed by the second neuromuscular-signal sensor in place of the neuromuscular signals sensed by the first neuromuscular-signal sensor, and analyzing neuromuscular signals sensed by the first neuromuscular-signal sensor in place of the neuromuscular signals sensed by the second neuromuscular-signal sensor.

(A6) In some embodiments of A5, the first neuromuscular-signal sensor is at a first widthwise portion of the wrist-wearable device and the second neuromuscular-signal sensor is at a second widthwise portion of the wrist-wearable device.

(A7) In some embodiments of any of A5 and A6, the first neuromuscular-signal sensor is at a first longitudinal portion of the wrist-wearable device and the second neuromuscular-signal sensor is at a second longitudinal portion of the wrist-wearable device.

(A8) In some embodiments of any of A1-A7, the plurality of neuromuscular-signal sensors includes a first neuromuscular-signal sensor at a first portion of the wrist-wearable device. In some embodiments, adjusting the analysis of the neuromuscular signals of the plurality of neuromuscular-signal sensors based on the offset between the worn position of the wrist-wearable device and the predetermined default position includes analyzing neuromuscular signals sensed by the first neuromuscular-signal sensor such that the neuromuscular signals sensed by the first neuromuscular-signal sensor are simulated at a second portion of the wrist-wearable device determined by the distance between the first portion of the wrist-wearable device and the offset between the worn position of the wrist-wearable device and the predetermined default position.

(A9) In some embodiments of A8, the first portion of the wrist-wearable device is a first widthwise portion of the wrist-wearable device and the second portion of the wrist-wearable device is a second widthwise portion of the wrist-wearable device.

(A10) In some embodiments of any of A8 and A9, the first portion of the wrist-wearable device is a first longitudinal portion of the wrist-wearable device and the second portion of the wrist-wearable device is a second longitudinal portion of the wrist-wearable device.

(A11) In some embodiments of any of A1-A10, adjusting analysis of the neuromuscular signals of the plurality of neuromuscular-signal sensors includes adjusting signal values of neuromuscular signals sensed by at least one neuromuscular-signal sensor of the plurality of neuromuscular-signal sensors of the wrist-wearable device.

(A12) In some embodiments of A11, the offset from the respective predetermined default position is a rotational offset with the at least one neuromuscular-signal sensor of the plurality of neuromuscular-signal sensors of the wrist-wearable device offset from the respective predetermined default position by a first angle, and adjusting the signal values of neuromuscular signals sensed by the at least one neuromuscular-signal sensor of the plurality of neuromuscular-signal sensors of the wrist-wearable device includes adjusting the signal values based on the first angle.

(A13) In some embodiments of any of A11 and A12, the offset from the respective predetermined default position is a distance offset with the at least one neuromuscular-signal sensor of the plurality of neuromuscular-signal sensors of the wrist-wearable device offset from the respective predetermined default position by a first distance, and adjusting the signal values of neuromuscular signals sensed by the at least one neuromuscular-signal sensor of the plurality of neuromuscular-signal sensors of the wrist-wearable device includes adjusting the signal values based on the first distance.

(A14) In some embodiments of any of A11-A13, the adjusting analysis of the neuromuscular signals of the plurality of neuromuscular-signal sensors includes adjusting signal values of neuromuscular signals sensed by an additional neuromuscular-signal sensor of the plurality of neuromuscular-signal sensors of the wrist-wearable device.

(A15) In some embodiments of any of A11-A14, the offset from the respective predetermined default position is a rotational offset with the additional neuromuscular-signal sensor of the plurality of neuromuscular-signal sensors of the wrist-wearable device offset from the respective predetermined default position by a second angle, and adjusting the signal values of neuromuscular signals sensed by the additional neuromuscular-signal sensor of the plurality of neuromuscular-signal sensors of the wrist-wearable device includes adjusting the signal values based on the second angle.

(A16) In some embodiments of any of A1-A15, the offset from the respective predetermined default position is a distance offset with the additional neuromuscular-signal sensor of the plurality of neuromuscular-signal sensors of the wrist-wearable device offset from the respective predetermined default position by a second distance, and adjusting the signal values of neuromuscular signals sensed by the additional neuromuscular-signal sensor of the plurality of neuromuscular-signal sensors of the wrist-wearable device includes adjusting the signal values based on the second distance.

(A17) In some embodiments of any of A1-A16, the method further includes determining a hand gesture performed by the user based on the adjusted analyzed neuromuscular signals of the plurality of neuromuscular-signal sensors and causing performance of an action at the wrist-wearable device based on the hand gesture.

(A18) In some embodiments of any of A1-A17, adjusting analysis of the neuromuscular signals of the plurality of neuromuscular-signal sensors based on the offset between the worn position of the wrist-wearable device and the predetermined default position of the wrist-wearable device, includes determining whether the adjusted analysis of the neuromuscular signals satisfies predetermined performance criteria and in accordance with a determination that the adjusted analysis of the neuromuscular signals does not satisfy the predetermined performance criteria, causing the wrist-wearable device to present feedback to the user.

(A19) In some embodiments of A18, the predetermined performance criteria include one or more of (i) a determined true positive rate at or above a predetermined true positive rate, (ii) a determined true negative rate at or above a predetermined true negative rate (iii) a detected number of errors at or below a predetermined number of detected errors (iv) the offset between the worn position of the wrist-wearable device and the predetermined default position of the wrist-wearable device is at or below a predetermined wrist-wearable device offset and (v) the offset between the at least one neuromuscular-signal sensor of the plurality of neuromuscular-signal sensors and its respective predetermined default position is at or below a predetermined neuromuscular-signal sensor offset.

(A20) In some embodiments of any of A18 and A19, the method further includes in conjunction with causing the wrist-wearable device to present feedback to the user, forgoing determining a hand gesture performed by the user based on the adjusted analysis of the neuromuscular signals of the plurality of neuromuscular-signal sensors.

(A21) In some embodiments of any of A18-A20, the method further includes in response to a repositioning event, receiving an additional pulse sensed by the neuromuscular-signal sensor of the plurality of neuromuscular-signal sensors of the wrist-wearable device. The method further includes in accordance with a determination that the additional pulse indicates that at least one neuromuscular-signal sensor of the plurality of neuromuscular-signal sensors of the wrist-wearable device is offset from a respective predetermined default position, determining a new worn position of the wrist-wearable device on the user's wrist, and adjusting analysis of additional neuromuscular signals of the plurality of neuromuscular-signal sensors based on an offset between the new worn position of the wrist-wearable device and the predetermined default position of the wrist-wearable device.

(A22) In some embodiments of any of A18-A21, the feedback includes one or more of a visual indicator, an audible indicator, and a haptic indicator.

(A23) In some embodiments of any of A18-A22, the feedback includes instructions for performing user corrective actions that cause the predetermined performance criteria to be satisfied.

(A24) In some embodiments of A23, the user corrective actions described in the instructions include removal and reattachment of the wrist-wearable device, manual adjustment of the wrist-wearable device, clean the neuromuscular-signal sensor, and service the wrist-wearable device.

(A25) In some embodiments of any of A23 and 24, the method further includes in response to a determination that a user corrective action was performed, analyzing additional neuromuscular signals of the plurality of neuromuscular-signal sensors, and determining whether the analysis of the additional neuromuscular signals satisfies the predetermined performance criteria.

(A26) In some embodiments of A25, the method further includes in accordance with a determination that the analysis of the additional neuromuscular signals does not satisfy the predetermined performance criteria, repeating the operations of any of methods A18-A25.

(A27) In some embodiments of A25, the method further includes in accordance with a determination that the analysis of the additional neuromuscular signals does satisfy the predetermined performance criteria, determining a hand gesture performed by the user based on the analyzed additional neuromuscular signals of the plurality of neuromuscular-signal sensors, and causing performance of an action at the wrist-wearable device based on the hand gesture.

(A28) In some embodiments of any of A1-A28, the method further includes in accordance with a determination that the pulse indicates that the neuromuscular-signal sensor of the plurality of neuromuscular-signal sensors of the wrist-wearable device is not offset from the respective predetermined default position, forgoing determining a worn position of the wrist-wearable device on the user's wrist, and forgoing adjusting analysis of neuromuscular signals of the plurality of neuromuscular-signal sensors.

(B1) In accordance with some embodiments, a wrist-wearable device including a plurality of neuromuscular-signal sensors, memory, and one or more processors is disclosed. The one or more processors are configured to, when the wrist-wearable device is worn by a user, in response to a triggering event, receive a pulse sensed by a neuromuscular-signal sensor of a plurality of neuromuscular-signal sensors of the wrist-wearable device. The one or more processors are further configured to, in accordance with a determination that the pulse indicates that at least one neuromuscular-signal sensor of the plurality of neuromuscular-signal sensors of the wrist-wearable device is offset from a respective predetermined default position, determine a worn position of the wrist-wearable device on the user's wrist, and adjust analysis of neuromuscular signals of the plurality of neuromuscular-signal sensors based on an offset between the worn position of the wrist-wearable device and a predetermined default position of the wrist-wearable device.

(B2) In some embodiments of B1, the wrist-wearable device is further configured to perform operations of the wrist-wearable device recited in the method of any of A2-A28.

(C1) In accordance with some embodiments, a capsule housing the display is disclosed. The capsule is configured to couple with a band to form a wrist-wearable device, and the includes one or more processors configured to perform or cause performance of the method of any of A1-A28.

(D1) In accordance with some embodiments, a non-transitory, computer-readable storage medium is disclosed. The non-transitory, computer-readable storage medium includes instructions that, when executed by a wrist-wearable device, cause the wrist-wearable device to perform or cause performance of the method of any of A1-A28.

(E1) In accordance with some embodiments, a wrist-wearable device is provided, the wrist-wearable device including means for causing performance of any of A1-A28.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described to best explain principles of operation and practical applications, to thereby enable others skilled in the art.

What is claimed is:

1. A non-transitory computer readable storage medium including instructions that, when executed by one or more processors of a wrist-wearable device, cause the wrist-wearable device to:
in response to a triggering event, receive a pulse sensed by a neuromuscular-signal sensor of a plurality of neuromuscular-signal sensors of a wrist-wearable device;
in accordance with a determination that the pulse indicates that at least one neuromuscular-signal sensor of the plurality of neuromuscular-signal sensors of the wrist-wearable device is offset from a respective predetermined default position, determine a worn position of the wrist-wearable device on the user's wrist; and
adjust analysis of neuromuscular signals of the plurality of neuromuscular-signal sensors based on an offset between the worn position of the wrist-wearable device and a predetermined default position of the wrist-wearable device.

2. The non-transitory computer readable storage medium of claim 1, wherein:
the respective predetermined default position is associated with a predetermined pulse strength threshold; and
the determination that the pulse indicates that the at least one neuromuscular-signal sensor of the plurality of neuromuscular-signal sensors of the wrist-wearable device is offset from the respective predetermined default position is based on a pulse strength of the at least one neuromuscular-signal sensor being below the predetermined pulse strength threshold.

3. The non-transitory computer readable storage medium of claim 2, wherein determining the worn position of the wrist-wearable device on the user's wrist includes:
determining, based on a comparison of respective pulse strengths of pulses sensed by neuromuscular-signal sensors of the plurality of neuromuscular-signal sensors, a neuromuscular-signal sensor with a highest pulse strength; and
determining a respective offset between the neuromuscular-signal sensor with the highest pulse strength and its respective predetermined default position.

4. The non-transitory computer readable storage medium of claim 3, wherein the neuromuscular-signal sensor with the highest pulse strength is predicted to be at or near the user's artery.

5. The non-transitory computer readable storage medium of claim 1, wherein:
the plurality of neuromuscular-signal sensors includes a first neuromuscular-signal sensor and a second neuromuscular-signal sensor; and
adjusting the analysis of the neuromuscular signals of the plurality of neuromuscular-signal sensors based on the offset between the worn position of the wrist-wearable device and the predetermined default position includes:
analyzing neuromuscular signals sensed by the second neuromuscular-signal sensor in place of the neuromuscular signals sensed by the first neuromuscular-signal sensor, and
analyzing neuromuscular signals sensed by the first neuromuscular-signal sensor in place of the neuromuscular signals sensed by the second neuromuscular-signal sensor.

6. The non-transitory computer readable storage medium of claim 5, wherein the first neuromuscular-signal sensor is at a first widthwise portion of the wrist-wearable device and the second neuromuscular-signal sensor is at a second widthwise portion of the wrist-wearable device.

7. The non-transitory computer readable storage medium of claim 5, wherein the first neuromuscular-signal sensor is at a first longitudinal portion of the wrist-wearable device and the second neuromuscular-signal sensor is at a second longitudinal portion of the wrist-wearable device.

8. The non-transitory computer readable storage medium of claim 1, wherein:
the plurality of neuromuscular-signal sensors includes a first neuromuscular-signal sensor at a first portion of the wrist-wearable device; and
adjusting the analysis of the neuromuscular signals of the plurality of neuromuscular-signal sensors based on the offset between the worn position of the wrist-wearable device and the predetermined default position includes:
analyzing neuromuscular signals sensed by the first neuromuscular-signal sensor such that the neuromuscular signals sensed by the first neuromuscular-signal sensor are simulated at a second portion of the wrist-wearable device determined by the distance between the first portion of the wrist-wearable device and the offset between the worn position of the wrist-wearable device and the predetermined default position.

9. The non-transitory computer readable storage medium of claim 1, wherein adjusting analysis of the neuromuscular signals of the plurality of neuromuscular-signal sensors includes adjusting signal values of neuromuscular signals sensed by at least one neuromuscular-signal sensor of the plurality of neuromuscular-signal sensors of the wrist-wearable device.

10. The non-transitory computer readable storage medium of claim 1, wherein the instructions, when executed by the one or more processors of the wrist-wearable device, further cause the wrist-wearable device to:
in accordance with a determination that the adjusted analysis of the neuromuscular signals satisfies predetermined performance criteria, determine a hand gesture performed by the user based on the adjusted analyzed neuromuscular signals of the plurality of neuromuscular-signal sensors; and
cause performance of an action at the wrist-wearable device based on the hand gesture.

11. The non-transitory computer readable storage medium of claim 1, wherein the instructions, when executed by the one or more processors of the wrist-wearable device, further cause the wrist-wearable device to:
in accordance with a determination that the adjusted analysis of the neuromuscular signals does not satisfy predetermined performance criteria, cause the wrist-wearable device to present feedback to the user.

12. The non-transitory computer readable storage medium of claim 11, wherein the instructions, when executed by the one or more processors of the wrist-wearable device, further cause the wrist-wearable device to:
in conjunction with causing the wrist-wearable device to present feedback to the user, forgo determining a hand gesture performed by the user based on the adjusted analysis of the neuromuscular signals of the plurality of neuromuscular-signal sensors.

13. The non-transitory computer readable storage medium of claim 11, wherein the predetermined performance criteria include one or more of:
a determined true positive rate at or above a predetermined true positive rate;
a determined true negative rate at or above a predetermined true negative rate;
a detected number of errors at or below a predetermined number of detected errors;
the offset between the worn position of the wrist-wearable device and the predetermined default position of the wrist-wearable device being at or below a predetermined wrist-wearable device offset; and
the offset between the at least one neuromuscular-signal sensor of the plurality of neuromuscular-signal sensors and its respective predetermined default position being at or below a predetermined neuromuscular-signal sensor offset.

14. The non-transitory computer readable storage medium of claim 11, wherein the instructions, when executed by the one or more processors of the wrist-wearable device, further cause the wrist-wearable device to:
in response to a repositioning event, receive an additional pulse sensed by the neuromuscular-signal sensor of the plurality of neuromuscular-signal sensors of the wrist-wearable device;
in accordance with a determination that the additional pulse indicates that at least one neuromuscular-signal sensor of the plurality of neuromuscular-signal sensors of the wrist-wearable device is offset from a respective predetermined default position, determine a new worn position of the wrist-wearable device on the user's wrist; and
adjust analysis of additional neuromuscular signals of the plurality of neuromuscular-signal sensors based on an offset between the new worn position of the wrist-wearable device and the predetermined default position of the wrist-wearable device.

15. The non-transitory computer readable storage medium of claim 11, wherein the feedback includes one or more of a visual indicator, an audible indicator, and a haptic indicator.

16. The non-transitory computer readable storage medium of claim 11, wherein the feedback includes instructions for performing user corrective actions that cause the predetermined performance criteria to be satisfied, the corrective actions including instructions to perform one or more of:
remove and reattach of the wrist-wearable device;
manually adjust of the wrist-wearable device;
clean the neuromuscular-signal sensor;
service the wrist-wearable device.

17. The non-transitory computer readable storage medium of claim 16, wherein the instructions, when executed by the one or more processors of the wrist-wearable device, further cause the wrist-wearable device to
in response to a determination that a user corrective action was performed, analyze additional neuromuscular signals of the plurality of neuromuscular-signal sensors; and
determine whether the analysis of the additional neuromuscular signals satisfies the predetermined performance criteria.

18. A wrist-wearable device, comprising:
a plurality of neuromuscular-signal sensors;
one or more programs, wherein the one or more programs are stored in memory and configured to be executed by one or more processors, the one or more programs including instructions for:
in response to a triggering event, receiving a pulse sensed by a neuromuscular-signal sensor of a plurality of neuromuscular-signal sensors of a wrist-wearable device;
in accordance with a determination that the pulse indicates that at least one neuromuscular-signal sensor of the plurality of neuromuscular-signal sensors of the wrist-wearable device is offset from a respective predetermined default position, determining a worn position of the wrist-wearable device on the user's wrist; and
adjusting analysis of neuromuscular signals of the plurality of neuromuscular-signal sensors based on an offset between the worn position of the wrist-wearable device and a predetermined default position of the wrist-wearable device.

19. The wrist-wearable device of claim 18, wherein:
the respective predetermined default position is associated with a predetermined pulse strength threshold; and
the determination that the pulse indicates that the at least one neuromuscular-signal sensor of the plurality of neuromuscular-signal sensors of the wrist-wearable device is offset from the respective predetermined default position is based on a pulse strength of the at least one neuromuscular-signal sensor being below the predetermined pulse strength threshold.

20. A method for calibrating neuromuscular signals sensed by a plurality of neuromuscular-signal sensors, comprising:
in response to a triggering event, receiving a pulse sensed by a neuromuscular-signal sensor of a plurality of neuromuscular-signal sensors of a wrist-wearable device;
in accordance with a determination that the pulse indicates that at least one neuromuscular-signal sensor of the plurality of neuromuscular-signal sensors of the wrist-wearable device is offset from a respective predetermined default position, determining a worn position of the wrist-wearable device on the user's wrist; and
adjusting analysis of neuromuscular signals of the plurality of neuromuscular-signal sensors based on an offset between the worn position of the wrist-wearable device and a predetermined default position of the wrist-wearable device.
